(19) United States
(12) Patent Application Publication
(10) Pub. No.: US 2015/0225271 A1
(43) Pub. Date: Aug. 13, 2015

(54) Amplified Relief From Drought and Famine- A Spin-Off Technology From Fossil-Fueled Climate Restoration

(71) Applicants: Robert C. Fry, Omaha, NE (US); Sambhudas Chaudhuri, Manhattan, KS (US); Barry M. Wroobel, Moorpark, CA (US)

(72) Inventors: Robert C. Fry, Omaha, NE (US); Sambhudas Chaudhuri, Manhattan, KS (US); Barry M. Wroobel, Moorpark, CA (US)

(73) Assignee: Climate Restoration Technologies, Inc, Omaha, NE (US)

(21) Appl. No.: 14/544,753

(22) Filed: Feb. 11, 2015

Related U.S. Application Data
(60) Provisional application No. 61/965,961, filed on Feb. 11, 2014.
(60) Provisional application No. 62/071,049, filed on Sep. 13, 2014.

(51) Int. Cl. C02F 3/32; C02F 3/02; A01G 33/00

(52) U.S. Cl. CPC C02F 3/322; A01G 33/00; C02F 3/02

(57) ABSTRACT

The invention encompasses multi-stage naturally amplified global-scale carbon dioxide capture systems combining basic capture from (CCS—carbon capture and sequestration) clean-coal-fired and CCS gas-fired power plants, CCS natural-gas reformation systems, CCS cement plants, outdoor air, CCS home and building flues, CCS incinerators, CCS crematoriums, CCS blast-furnaces, CCS kilns, CCS refineries, CCS factories, CCS oil gasification systems and CCS coal gasification systems which yield concentrated carbon dioxide, with a collective, globally distributed capture capacity of up to 3 GtC/yr, feeding the captured carbon dioxide into land-based invention stage-1 bioreactors for rapid, selective, high capacity conversion to a high-density, fast-sinking marine algae by means of accelerated photosynthesis and/or coccolithogenesis (calcification) consuming carbon dioxide as the algae bloom, and transporting a primary fraction of the stage-1 bioreactor-produced algae to seaports for seeding the oceans at regular intervals in stage-2 operations-at-sea to produce naturally amplified 14 GtC/yr algal blooms at sea, the stage-2 operations circumventing classic prior-art (and natural) ocean fertilization limits of low bloom rate, grazers eating algae seed before it blooms, interfering buoyant algal species which don't clear the photic zone to allow light penetration for multiple blooms per year, and proximal post-bloom anoxia, and reserving a secondary fraction of the stage-1 bioreactor produced algae for feeding cultures of ocean grazers contained in a second bioreactor, in which the second bioreactor produces dimethylsulfide (DMS), a natural cloud seeding agent as the bioreactor-contained ocean grazer cultures eat the secondary fraction of stage-1 original bioreactor-produced algae. A total invention CO₂ capture and safe storage capacity of 17 GtC/yr (land and sea) is projected during fair-weather, and a 40% foul weather down-time allowance ensures that an average 10 GtC/yr of impact capture would result. If emissions are concurrently capped by at 12 GtC/yr by 2023, with invention-assisted reduction to 6 GtC/yr by 2050, 3 GtC/yr by 2062, and 1 GtC/yr by 2078, atmospheric CO₂ will be reduced to 280 ppm by 2075. The CIP invention production of DMS (both inland invention DMS production and invention ocean-amplified DMS production following ocean-amplified algal blooming and ocean-amplified capture of atmospheric CO₂) may be used to seed rain-clouds over or adjacent to semi-arid lands, enabling drought and famine relief. If the rain clouds are seeded adjacent to semi-arid lands, winds may drive the rain clouds over the drought stressed lands.

A spin-off technology includes use of excess dead bioreactor algae for agricultural soil spreads to enhance soil moisture retention—which is important in maximizing drought relief.

This application claims benefit of provisional application No. 61/965,961 filed on Feb. 11, 2014 and 62/071,049 filed on Sep. 13, 2014. This is also a CIP of Pending Utility application Ser. No. 13/999,195 filed on Jan. 27, 2014.

### FIELD OF THE INVENTION

This invention relates to climate change, weather control, cloud-seeding and drought relief. It specifically relates to cloud-seeding with DMS (dimethylsulfide) and/or its oxidation products. The invention further relates to the release of DMS by marine algae such as Emiliania huxleyi (hereinafter E. huxleyi or EHUX), a species of marine algae which is one of Earth's primary producers of DMS. It further relates to ocean grazers which eat marine algae such as EHUX, and to the sharply increased quantities of DMS which the algae release when they are mechanically stressed or attacked by ocean grazers [Evans, et. al., 2007]. It especially relates to humanity's need to globally amplify DMS release by marine algae such as EHUX in order to seed rain-clouds and effect both targeted and general drought relief in the face of increasingly adverse and accelerating climate change.

### BACKGROUND OF THE INVENTION

Protracted drought, crop failure, famine, and forced animal and livestock herd reduction (or die-off) are among the most devastating impacts of global warming, and they are likely to get worse, becoming increasingly prevalent, and significantly more widespread across the interiors of multiple continents, as warming and climate change progress in the 21^{st} century [Allison, et. al., 2009, and Solomon, et. al., 2007]. Warming raises ocean evaporation rates globally, which adds moisture to the atmosphere. The added water vapor is a potent greenhouse gas (GHG) which further accelerates global warming in a positive feedback loop. However, increased moisture doesn't necessarily lead to increased average rainfall. In fact, with global warming, the opposite can occur. Increased drought may result in many regions, despite increased average global atmospheric humidity. The reason is that one of the primary natural cloud-seeding agents, DMS release from marine algae, may decline faster than atmospheric humidity rises with accelerating climate change.

In addition to increased ocean evaporation, global warming leads to increased stratification of warming ocean waters, producing a more pronounced ocean thermocline which blocks upwelling of nutrients from volcanic rifts in the deep ocean floor. This leads to greater depletion of nutrients in the warmer ocean surface waters and a corresponding decrease of average global algal blooming [Lovelock, 2006], including a decrease in EHUX blooming and a corresponding reduction in DMS release. Since DMS is a primary planetary cloud-seeding agent, its reduction may lead to a decrease in average rainfall in many parts of the world, especially in drought-prone regions, and an increase in global drought and famine, despite higher average atmospheric moisture levels as global warming progresses [Lovelock, 2006].

Drought is regionally spreading in many locations around the world. It is also intensifying, occurring more frequently, and lasting longer. It is expected to get far worse as global warming progresses. A tipping point for upward-spiraling positive feedbacks and setting irreversible, runaway warming in motion, with increasingly punishing drought, including mega-drought, accelerating global crop failure (leading to a rise in global famine), and accelerating forced herd reduction (or die-off) being anticipated as atmospheric carbon dioxide rises above 450 ppm [Lovelock, 2006, and Hansen, et al. 2008, 2009]. As the primary driver of climate change, carbon dioxide (CO₂) emissions are currently about 11 GtC/yr (carbon measure in billion metric tons carbon per year); the accumulation of atmospheric CO₂ has reached 400 ppm (the highest level in 13 million years); and the accumulation is increasing at about 2 ppm/yr while CO₂ emissions continue to rise at about 3.5% annually [Keeling, et. al., 2013, Solomon, et. al., 2007, Allison, et. al., 2009, McGee, 2013, and Rapier, 2012]. In an unchecked scenario, we calculate (and IPCC reports concur) that atmospheric CO₂ accumulation will reach a 450 ppm tipping level by ˜2029 for irreversibly seeding runaway warming and catastrophic climate change.

Intervention is needed to prevent carbon dioxide from reaching the 450 ppm tipping point. Further intervention is needed to increase DMS production to stimulate cloud-seeding and bring rains and drought relief as long as elevated carbon dioxide levels persist. Accelerated global DMS production is anticipated to be necessary for at least the next 60 years.

Our calculations indicate that, if global carbon dioxide emissions are capped at 12 GtC/yr by 2023, and then reduced to 6 GtC/yr by 2050, further reduced to 3 GtC/yr by 2062, and finally stabilized at 1 GtC/yr by 2078 primarily via a combination of nuclear energy and invention-derived clean fossil-fueled energy and transportation alternatives, energy and fuel conservation, and improvements in energy and fuel efficiency, along with sweeping changes in agriculture, while concurrently invention-geoengineering-capturing an average of 10 GtC/yr (global impact basis) carbon dioxide from the atmosphere each year from 2025-2070 (with capture ramp-up from 2019-2025), accumulated carbon dioxide levels in the atmosphere will be capped at ≦425 ppm by 2023, the 450 ppm tipping point may be (narrowly) averted, and atmospheric carbon dioxide may be restored to the (pre-industrial) level of 280 ppm by 2075. That will solve the carbon dioxide problem and substantially reduce drought in the long term, but extra drought relief will still be needed during the interim correction period (2019-2075), and possibly for some time afterward (owing to thermally-lagged equilibration delay). Invention-enhanced global DMS production will be needed to seed clouds, bring rain, and provide drought relief to semi-arid lands through at least 2075, and possibly longer. Invention-enhanced soil moisture retention will also be needed to maximize the effectiveness of rain and prevent rapid soil moisture loss by unimpeded runoff of rain water before it appreciably benefits crops.

### DISCLOSURE OF THE INVENTION

The invention includes a fossil-fueled system and process for stimulating, and massively amplifying, heavier-than-water marine algae blooming such as EHUX blooms (hereinafter EHUX) in the oceans, yielding correspondingly amplified capture of atmospheric carbon dioxide (CO₂) at sea, and simultaneously triggering elevated DMS release by also invention-inciting ocean grazer attacks on the ocean-amplified EHUX blooms, at their bloom peak. It also includes means of targeting amplified DMS release from offshore EHUX blooms, or inland release of remotely produced DMS, to specific drought-stressed regions of the world and timing the amplified DMS release to coincide with on-shore (or inland) moisture-bearing winds to effect cloud seeding (and rain-making) over the drought-stressed regions during agricultural growing seasons. The invention involves large-scale, fossil-fuel combustion-CO₂ fed, land-based, salt-water bioreactor production of EHUX plus auxiliary inland salt-water bioreactor production of ocean grazers such as zooplankton or krill. A minority fraction of the bioreactor EHUX will be fed to ocean grazers in auxiliary inland salt-water bioreactors to stimulate grazer production and also stimulate inland release of DMS in drought-stressed regions, or to stimulate inland production of DMS for collection, concentration, and transport to remote drought-stressed regions. A majority fraction of the bioreactor EHUX will be shipped to seaports for distribution and ocean seeding (with optimal nutrient) across ˜70% of the oceans to stimulate much larger secondary EHUX blooming and correspondingly amplified capture of atmospheric carbon dioxide at sea. Amplified secondary EHUX blooming will yield extra DMS release at sea and, as nature's primary cloud-seeding agent, the extra DMS should induce extra ocean cloud cover to be driven inland by onshore winds. This will help precipitate inland rain and alleviate drought. If desired, extra EHUX blooming and DMS release may be concentrated along the windward coastlines of drought-stressed and famine-prone countries with the extra DMS release being synchronized with developing weather patterns, the appearance of onshore winds, and the agricultural growing season.

Each ton of carbon in fossil-fuel combustion-CO₂ fed invention bioreactor EHUX seed blooms will seed ˜14 more tons of atmospheric carbon capture (51 tons, CO₂ measure) at sea, effecting an approximate 15× ocean amplification factor and massive invention-induced CO₂ capture from the atmosphere. That is the means by which 10 GtC/yr (carbon measure) of atmospheric CO₂ capture may be sustained from 2025-2070, enabling a return to 280 ppm atmospheric CO₂ by 2075 (substantially reducing planetary greenhouse warming and associated drought in the long term) if emissions are also capped at 12 GtC/yr by 2023 and then reduced to 1 GtC/yr by 2078.

A fraction of that ocean-amplified 10 GtC/yr of EHUX blooming may be seeded along the windward coastlines of drought-stressed countries. Invention inland-bioreactor-produced ocean grazers may also be introduced in elevated numbers offshore—along the same coastlines in order to incite focused, directed, well-timed, and massively amplified grazer attacks at the peak of ocean-amplified EHUX blooming, thereby stimulating maximal secondary DMS release. If ocean-amplified DMS release is induced by well-timed invention-orchestrated grazer attacks on invention-amplified EHUX blooms concentrated along the windward coastlines of drought-stressed countries, rain should develop—sweeping inland to provide much-needed drought relief. Famine may be reduced or even eradicated by this means.

Release of DMS from well-placed land-based invention bioreactors should also help to bring rain to drought-stressed regions that are further inland, if it is properly timed with developing moisture fronts or periods of increased humidity in developing weather patterns. Invention bioreactors may finally produce DMS remotely, where it may be collected, concentrated, and transported for release in distant drought-stressed lands.

Fossil-fueled two-stage, 15× ocean-amplified EHUX blooming, correspondingly elevated DMS release at sea, capture of 10 GtC/yr of atmospheric carbon dioxide, fossil-fueled inland DMS production and release, and fossil-fueled inland DMS production with collection, concentration, transport, and remote release are all envisioned by the invention. These are key ingredients for interim drought relief and long term drought eradication. Another key ingredient will be invention-induced enhancement of soil moisture retention.

### Key Summary Points of the Invention Systems and Processes

Invention bioreactors can convert power-plant and transportation CO₂ to marine algae.
Seeding oceans with invention bioreactor algae and optimal nutrient can amplify land-based CO₂ capture 15× at sea.
Invention-amplified CO₂ capture can restore 280 ppm CO₂ by 2075 and revitalize oceans by restoring ideal alkaline ocean pH and supplying billions of tons of “fish food” annually.
Invention-induced DMS release by amplified offshore. EHUX blooms can seed rain clouds and enable drought relief as the rain clouds are driven inland by onshore winds.
DMS can be invention-produced on an alternate inland basis in EHUX-fed zooplankton bioreactors, collected, concentrated, and transported for release in remote drought-stressed lands.
Dead EHUX and dead ocean grazers comprising a fraction of inland invention bioreactor harvests can serve as organic fertilizer and agricultural spreads for beneficially raising soil pH and enhancing soil moisture retention in semi-arid lands.

The first three points above pertain to (pending) U.S. patent application Ser. No. 13/999,195 (hereinafter “Ser. No. 13/999,195”). The latter three points summarize the current invention, which is a CIP of Ser. No. 13/999,195 that builds on the technology and processes established by the first invention (Ser. No. 13/999,195). The fossil-fueled invention combination has several stages. The first stage (Ser. No. 13/999,195) encompasses means for globally restoring 280 ppm atmospheric CO₂ two centuries earlier than best-effort emissions-control-only, for re-establishing ideal ocean pH, and for creating global drought relief by reducing global CO₂ emissions, and by concurrently capturing atmospheric CO₂ at an unprecedented rate. The second stage (the current application—a CIP of Ser. No. 13/999,195) simultaneously orchestrates elevated release of DMS (nature's own cloud-seeding agent). Fossil-fueled two-stage amplified ocean algal blooming (Ser. No. 13/999,195) is the critical element required to deliver necessary CO₂ capture capacity. Concentrated land-based-source CO₂ would be captured and bioreactor-converted to marine algae such as Emiliania huxleyi (EHUX) for elevated ocean seeding (along with optimal nutrient) and accelerated secondary EHUX blooming, enabling massively ocean-amplified CO₂ capture (Ser. No. 13/999,195) and increased DMS production at sea. Carbon-free energy and reduced transportation emissions alone, without simultaneous aggressive atmospheric CO₂ capture, are insufficient to avoid impending 450 ppm CO₂ tipping point crossings by about 2034. Fossil-fueled, invention-orchestrated, ocean-amplified CO₂ capture, however, has the potential capacity and would impart a large negative carbon footprint to energy and transportation (Ser. No. 13/999,195), while also imparting a substantial DMS release profile (current CIP application). High-carbon fuel precursors and energy sources burning fossil fuels would supply concentrated CO₂ to invention bioreactors, yielding large harvests of high-density marine algae (e.g., EHUX) needed to seed secondary ocean blooming on a much larger scale and corresponding maximally amplified capture of atmospheric CO₂ at sea. Each ton of CO₂ from concentrated, fossil-fueled, land-based sources such as CCS (carbon capture and sequestration) coal-fired and CCS gas-fired power plants, CCS cement production, and CCS building heating, plus CO₂ from hydrogen production by CCS natural-gas reformation and by CCS oil and coal-gasification syngas reactors, would drive amplified capture of up to 14 tons of CO₂ at sea (Ser. No. 13/999,195). Invention-produced two-stage amplification would impart a large negative carbon footprint (Ser. No. 13/999,195) and a substantial DMS release profile (current CIP application) to the largest traditional CO₂ sources, spectacularly transforming them from CO₂ emitters and drought instigators into primary engines for global warming reversal (Ser. No. 13/999,195) and drought/famine eradication (current application). Beneficial invention utilization of CO₂ byproduct from hydrogen production would promote environmental viability and could vault H₂ to a front-runner position in alternative fuels development. Invention-amplified secondary ocean blooming of E. huxleyi can also amplify DMS release at sea—the highest DMS levels occurring during invention-orchestrated attacks by ocean grazers. Timely introduction of extra grazers at the peak of amplified E. huxleyi (EHUX) blooming would maximize DMS release (nature's primary rainmaker). Concentrating this along the windward coastlines of drought-stressed continents and synchronizing it with developing weather patterns during agricultural growing seasons could bring much-needed rain and early drought relief. Inland DMS production by feeding a fraction of invention bioreactor-produced EHUX to ocean grazers, contained by adjacent inland secondary invention bioreactor stages, may be collected, concentrated, and transported for release over remote drought-stressed regions. That is another invention means of producing much-needed rain and drought relief in many parts of the world.

Soil moisture retention may be improved by spreading organic matter (including highly porous calcified components) on agricultural soils, in the form of excess (dead) invention bioreactor EHUX and (dead) zooplankton grazers from secondary-stage invention bioreactors. Live inland-grown cultures would be transported for use at sea to seed secondary ocean blooms and ocean-amplified capture of atmospheric CO₂, plus DMS release at sea, but the dead fraction may be invention-utilized inland as organic fertilizer and as spreads for soil moisture retention enhancement, which is almost as important (for drought and famine relief) as rain itself.

A series of one hundred and twelve specific invention inclusions are listed below as Ser. No. 13/999,1965 spin-off basis elements for CIP spin-off invention involving DMS production, rain-cloud seeding, enhanced soil moisture retention, drought-relief, and famine relief, with an appended list of CIP inclusions following thereafter in this section.

1. The invention specifically includes a system for production of algae, the system comprising a CO₂ source and a bioreactor supplied with concentrated CO₂ from the CO₂ source, the bioreactor configured to encourage accelerated growth and reproduction of algae as well as to enable development of a more concentrated final algal bloom; in which optical opacity limits on seed level and bloom concentration are circumvented by an optical thinning effect which enables greater light penetration into more concentrated algae suspensions; wherein the greater light penetration enables higher level initial seeding or inoculation of the bioreactor bloom space; wherein the higher level of initial seed accelerates blooming as a result of starting higher on a nonlinear algal growth curve; and in which a normally inaccessible upper section of the nonlinear algal growth curve is conventionally inaccessible owing to optical opacity of concentrated algal suspensions; and in which the normally inaccessible upper section of the nonlinear growth curve is rendered accessible by the optical thinning effect which enables light penetration into optically thinned suspensions of concentrated algae.
2. The invention further includes the system of preceding section 1, wherein the optical thinning effect is produced by slinging an algae suspension as thin watery sheets off the perimeter edges of a rotating auger blade which lifts algae suspension out of a pool, elevates the suspension, and slings it outward by centrifugal force to form optically thin watery sheets, and wherein optical thinness of the slinging sheets enables improved optical penetration by rays from a light source shining through the slinging sheets.
3. The invention further includes the system of preceding section 1, wherein the optical thinning effect is produced by spraying, misting, or aerosolizing an algae suspension as droplets and particles to form optically thin sprays, mists, or aerosols, wherein optical thinness of the algal sprays, mists, or aerosols enables improved optical penetration by rays from a light source shining through the sprays, mists, or aerosols.
4. The invention further includes the system of preceding section 1, wherein the optical thinning effect is produced by directing a flow of an algae suspension through an annular space occurring between two axially concentric tubes, and wherein the annular space occurs between the outside diameter wall of the innermost tube of the two axially concentric tubes and the inside diameter wall of the outermost tube of the two axially concentric tubes, wherein the annular space is less than 50 mm thick, and wherein the optical thinness of the flow of algae suspension within the annular space enables improved optical penetration by rays from a light source shining through the flow of algae suspension contained within the optically thin annular space.
5. The invention further includes the system of preceding section 1, in which the algae suspension from the bioreactor proceeds to a flow-through separation tank after blooming, wherein the flow velocity of algae suspension through the separation tank is reduced, at constant flow rate, by means of enlarged tank diameter, and wherein the reduced flow velocity is low enough to permit algae that have flagella or other motility means to swim effectively against the flow current when presented with an upstream or side-stream attractant, and wherein the direction of algal swimming is toward the attractant, and wherein algal swimming toward the attractant produces a concentrating effect on the algal suspension, and wherein the concentration of algae proximal to the attractant is made higher by the concentrating effect than the concentration of algae at points located progressively downstream from the attractant and still within the main flow of the flow-through separation tank.
6. The invention further includes the system of preceding section 5, wherein the separation tank contains a main flow exit port and a secondary exit port which is designated as a harvest exit tee, and wherein the attractant is located at a position proximal to the mouth of the harvest exit tee, and wherein the mouth of the harvest exit tee is sufficiently narrow to raise the harvest exit flow velocity to exceed the capacity for algae to swim against the harvest exit current, wherein algae swimming toward the attractant from the main separation tank are sucked into the harvest exit tee upon reaching the attractant, and wherein the harvest exit tee outflow leads to an algal harvest output port, wherein the concentration of algae harvested at the harvest output port is higher than the concentration of algae entering the separation tank, and wherein the main flow of the flow through exit tank at points downstream of the attractant and having bypassed the harvest exit tee contains a reduced concentration of algae, relative to the concentration of algae entering the separation tank, and wherein the main flow of the flow through exit tank having bypassed the harvest exit tee exits the separation tank through the main flow exit port, and wherein flow exiting the main flow exit port is recirculated to the original bioreactor.
7. The invention further includes the system of preceding section 6, in which the attractant is one or more attractants selected from among a group of attractants consisting of a light source, a nutrient source, a nutrient source, a carbon dioxide source, an attractive water temperature, and an attractive water pH, and wherein the rest of the separation tank is dark and relatively devoid of the chosen attractant or combination of attractants.
8. The invention further includes the system of preceding section 1, wherein the CO₂ source is a methane (or natural gas) reformation reactor.
9. The invention further includes the system of preceding section 8, wherein the methane (or natural gas) reformation reactor is a steam cracker with stages of the steam reactor operating at two different temperatures that are optimized for hydrogen production from natural gas.
10. The invention further includes the system of preceding section 1, wherein the CO₂ source provides a concentrated flow of CO₂ gas.
11. The invention further includes the system of preceding section 10 which further comprises a CO₂ storage module.
12. The invention further includes the system of preceding section 11, wherein the CO₂ storage module includes a CO₂ liquefier.
13. The invention further includes the system of preceding section 1, wherein the bioreactor comprises an artificial light source.
14. The invention further includes the system of preceding section 4, wherein the light source is axially positioned proximal to the axial center-line of the innermost tube of the two axially concentric tubes, and wherein rays of light from the light source shine radially outward through the annular space and the flow of algae contained within the annular space.
15. The invention further includes the system of preceding section 1, wherein the bioreactor comprises a CO₂ inlet for the introduction of concentrated CO₂ gas.
16. The invention further includes the system of preceding section 1, wherein the heavier-than-water algae comprise an exoskeleton or protective coccolith plates.
17. The invention further includes the system of preceding section 16, wherein the heavier-than-water algae comprise at least one of a coccolithophore or a siliceous diatom algae.
18. The invention further includes the system of preceding section 1, wherein the CO₂ source and the bioreactor are in fluid communication.
19. The invention further includes a system for production of algae, the system comprising a hydrocarbon cracking reactor configured to generate a stream of concentrated CO₂ byproduct; and a bioreactor configured to produce heavier than water algae, the bioreactor supplied, at least in part, with CO₂ from the stream of concentrated CO₂ byproduct; and wherein the hydrocarbon cracking reactor produces H₂ as its main product.
20. The invention further includes the system of preceding section 19, wherein the hydrocarbon cracking reactor is a methane cracking reactor.
21. The invention further includes the system of preceding section 20, wherein the methane cracking reactor is a steam cracker with stages of the steam reactor operating at two different temperatures that are optimized for hydrogen production from natural gas.
22. The invention further includes the system of preceding section 19, wherein the hydrocarbon cracking reactor is a coal-gasification reactor in which partial oxidation (with O₂) converts coal to syngas—a mixture of CO and H₂; wherein the CO is further converted to CO₂ byproduct in a water-gas shift reaction with low temperature steam, and wherein the coal-gasification reactor produces H₂ as its main product.
23. The invention further includes the system of preceding section 19, wherein the hydrocarbon cracking reactor is an oil-gasification reactor in which partial oxidation (with O₂) converts oil to syngas—a mixture of CO and H₂; wherein the CO is further converted to CO₂ in a water-gas shift reaction with low temperature steam, and wherein the oil-gasification reactor produces H₂.
24. The invention further includes the system of preceding section 19, which further comprises a CO₂ storage module.
25. The invention further includes the system of preceding section 24, wherein the CO₂ storage module includes a CO₂ liquefier.
26. The invention further includes the system of preceding section 19, wherein the bioreactor comprises an artificial light source.
27. The invention further includes the system of preceding section 19, wherein the bioreactor comprises a CO₂ inlet for the introduction of concentrated CO₂ gas.
28. The invention further includes the system of preceding section 19, wherein the heavier-than-water algae comprise an exoskeleton or protective coccolith plates.
29. The invention further includes the system of preceding section 28, wherein the heavier-than-water algae comprise at least one of a coccolithophore or a siliceous diatom algae.
30. The invention further includes the system of preceding section 19, wherein the CO₂ source and the bioreactor are in fluid communication.
31. The invention further includes the system of preceding section 1, wherein the CO₂ source is a CC (carbon-capture) clean-coal-fired power plant, the power plant producing electricity as a public utility and concentrated CO₂ byproduct as a supercritical fluid (SCF-CO₂).
32. The invention further includes the system of preceding section 31, wherein the SCF-CO₂ is decompressed to concentrated CO₂ gas and introduced into the bioreactor.
33. The invention further includes the system of preceding section 1, wherein the CO₂ source is a CC (carbon-capture) gas-fired power plant, the CC power plant producing electricity as public utility and concentrated CO₂ byproduct as a supercritical fluid (SCF-CO₂).
34. The invention further includes the system of preceding section 33, wherein the SCF-CO₂ is decompressed to concentrated CO₂ gas and introduced into the bioreactor.
35. The invention further includes the system of preceding section 1, wherein the CO₂ source is a combination (CC or standard) gas-fired and CC (carbon-capture) clean-coal-fired power plant, the power plant producing electricity as a public utility and concentrated CO₂ byproduct as a supercritical fluid (SCF-CO₂).
36. The invention further includes the system of preceding section 35, wherein the SCF-CO₂ is decompressed to concentrated CO₂ gas and introduced into the bioreactor.
37. The invention further includes the system of preceding section 1, wherein the CO₂ source is a CC (carbon-capture) cement plant, the CC cement plant producing cement and concentrated CO₂ byproduct.
38. The invention further includes the system of preceding section 37, wherein the CO₂ is captured as a supercritical fluid (SCF-CO₂).
39. The invention further includes the system of preceding section 38, wherein the SCF-CO₂ is decompressed to concentrated CO₂ gas and introduced into the bioreactor.
40. The invention further includes a system for production of algae, the system comprising a CO₂ source; and a means of concentrating CO₂ from the CO₂ source; and a bioreactor supplied with concentrated CO₂ gas from the concentrating means; wherein the bioreactor is configured to encourage the rapid growth and reproduction of a heavier-than-water species of algae.
41. The invention further includes the system of preceding section 40, wherein the concentrating means produces supercritical fluid CO₂ (SCF-CO₂).
42. The invention further includes the system of preceding section 41, wherein the SCF-CO₂ is decompressed to create the concentrated CO₂ gas and introduce it into the bioreactor.
43. The invention further includes the system of preceding section 40, wherein the means of concentrating CO₂ from the source is absorbing CO₂ from the source by exposure of the CO₂ to a solution of alkali metal hydroxide (e.g. sodium hydroxide) or alkaline-earth hydroxide (e.g. calcium hydroxide) to form a CO₂ absorption product solution of alkali bicarbonate or alkaline-earth carbonate; wherein the alkali bicarbonate or alkaline-earth carbonate solution is subsequently (or downstream) acidified to re-release the captured CO₂ as concentrated CO₂ into an enclosure which is common to the bioreactor or in fluid communication with the bioreactor.
44. The invention further includes the system of preceding section 43, wherein the CO₂ source is selected from among a group of CO₂ sources consisting of a methane reformation cracker, an oil gasification syngas reactor, a coal gasification syngas reactor, a furnace flue, a water heater flue, an incinerator flue, a crematorium flue, a blast-furnace flue, a gas stove flue, a cement plant exhaust flue, a power plant exhaust flue, a refinery exhaust flue, a factory exhaust flue, and a system designed for CO₂ capture from outdoor air.
45. The invention further includes a process of ocean-amplified CO₂ capture, wherein algae plus nutrient are seeded into the ocean instead of nutrient-alone; the process comprising land-based capture of concentrated CO₂ from a land-based CO₂ source; land-based conversion of captured CO₂ to heavier-than-water marine algae in at least one bioreactor configured to encourage the rapid growth and reproduction of the heavier-than-water marine algae as ocean seed; transport of the heavier-than-water marine algae as ocean seed to seaports for ocean distribution and dispersal with added micro-nutrients in order to seed ocean-amplified blooming (further growth and rapid reproduction at sea—essentially secondary blooming on a vast ocean scale); wherein the ocean-amplified blooming occurs essentially selectively for the heavier-than-water species of marine algae by virtue of the heavier-than-water marine algae being distributed, dispersed, and seeded into the ocean water at higher levels than existing natural buoyant ocean algal strains, the higher levels selectively accelerating ocean blooming rates of the heavier-than-water marine algae by virtue of seeding the ocean higher than normal on an upward-bending nonlinear algal growth curve and producing a species-selective dominance of the ocean-amplified bloom, and wherein the higher that the ocean blooming starts on the growth curve, the faster it proceeds, if sufficient nutrient is present or provided.
46. The invention further includes the system of preceding section 45 in which the species-selective bloom dominance is further enhanced by nutrient selection.
47. The invention further includes the process of preceding section 46 in which nutrient selection for E. huxleyi coccolithophore marine algae includes nutrients which are deficient in phosphate, wherein phosphate deficiency, while also concurrently providing other nutrients in abundance, promotes prodigious E. huxleyi growth at sea, to the exclusion of blooming by other species of marine algae.
48. The invention further includes the process of preceding section 45, wherein transport to seaport of the heavier-than-water marine algae seed occurs by flat-bed truck, flat rail car, or barge; and wherein the flat-bed truck, flat rail car, or barge carry the marine algae seed in stasis-supporting cargo containers which are transferrable by crane or other lifting means from one flat-bed transportation means to another, and wherein the cargo containers are designed to maintain conditions in support of a healthy stasis condition for the heavier-than-water marine algae seed.
49. The invention further includes the process of preceding section 48, wherein the stasis-supporting cargo containers may be loaded onto ocean freighters (ships) docked at seaports, the ocean freighters then distributing the stasis-supporting cargo containers to floating seed repositories at sea; wherefrom the stasis-supporting cargo containers may be transferred to seed dispersal boats which fan out from the floating seed repositories to disperse and dispense the heavier-than-water marine algae seed (plus micronutrients) into the ocean for ocean-amplified blooming to proceed, along with ocean-amplified CO₂ capture as the heavier-than-water marine algae bloom prodigiously at sea.
50. The invention further includes the process of preceding section 49, wherein the micro-nutrient doses are metered to support heavier-than-water ocean-amplified algal blooming up to the light penetration (algal bloom opacity) limit and then run out.
51. The invention further includes the process of preceding section 50, wherein the ocean amplified bloom dies after the metered micro-nutrient doses run out; wherein the dead heavier-than-water amplified bloom sinks rapidly, clearing the ocean photic zone before the end of each month and enabling restored light penetration into the photic zone to support another amplified bloom following the next month's seeding.
52. The invention further includes the process of preceding section 51 in which 12 blooms/year may be seeded and achieved, with each ocean-amplified bloom reaching the light penetration (algal bloom opacity) limit before it dies and sinks.
53. The invention further includes the process of preceding section 52 in which accumulated amplified ocean blooming yields 14 GtC/yr of heavier-than-water algae (correspondingly capturing 14 GtC/yr of atmospheric CO₂) globally for each 1-3 GtC/yr of seeding with land-based heavier-than-water algae seed produced by the land-based bioreactors.
54. The invention further includes the process of preceding section 51, wherein local forced re-aeration of previously seeded areas to an appropriate depth prevents post-bloom anoxia from secondary bacterial blooming.
55. The invention further includes the process of preceding section 51, wherein the seeding of amplified ocean blooming is restricted to the vast open ocean that is further out from shore, well beyond the realm of coastal waters and beyond the shallow coastal-shelf sea floor, out in the open seas where much deeper water prevails, wherein species-selective bloom dominance and rapid sinking quickly carry the dead algae below the ocean thermocline of the open seas and all the way to the deep-sea floor, wherein deep ocean temperatures at the deep-sea floor are quite low—near to zero degrees centigrade, and wherein low deep-sea temperatures preserve the dead algae and slow and/or suppress the onset of secondary bacterial action, algal decay, eutrophication, and post-bloom anoxia which would otherwise deplete ocean-dissolved oxygen, and wherein the slowing or suppression of bacterial action at low temperature at the deep-sea floor delays the onset of eutrophication and post bloom anoxia to an extent enabling ocean sedimentation, often referred to as marine “snow”, to essentially bury the dead algae before post-bloom anoxia or eutrophication can develop.
56. The invention further includes the process of preceding section 55 wherein the onset of post bloom anoxia is further delayed by calcareous exoskeletal armor plates of E. huxleyi, a preferred heavier-than-water algae for ocean amplification; and wherein delay by calcareous exoskeletal armor plating dominates dead algal blooms, owing to the species-selective bloom dominance of E. huxleyi enabled by high seed levels from land-based bioreactor seed sources, and further enabled by phosphate-depleted nutrients supplied during ocean seeding with E. huxleyi seed grown in land-based bioreactors.
57. The invention further includes the process of preceding section 53 wherein approximately 1 GtC/yr of seed triggers amplified ocean blooming of up to 14 GtC/yr of heavier-than-water algae; wherein another approximately 2 GtC/yr of seed are needed (and are provided from land-based bioreactor-produced seed) to satiate marine grazer appetites so that they leave the approximately 1 GtC/yr of seed uneaten so that it remains to trigger the amplified ocean blooming of the up to 14 GtC/yr of heavier-than-water algae and corresponding photosynthetic and/or coccolithogenic (calcification) capture of up to 14 GtC/yr of atmospheric CO₂.
58. The invention further includes the system of preceding section 1, wherein the bioreactor comprises a shallow pool of seed algae; an enclosed headspace above the shallow pool; a vertical rotating auger; and overhead artificial lighting; wherein the concentrated CO₂ is injected into the bioreactor headspace; wherein the lower blade extent of the rotating auger is immersed in the pool; wherein the rotating auger lifts algae suspension up out of the pool; and wherein the rotating auger slings algae suspension off the perimeter edges of the auger blades creating a helical fountain comprising thin watery sheets of suspended algae slinging within the bioreactor headspace; and wherein the artificial lighting shines down through the thin watery sheets; wherein an optical thinning effect of the thin watery sheets allows greater light penetration through the sheets than would otherwise be possible in the pool, owing to optical opacity limits of suspended algae in the pool; and wherein the greater light penetration enables bioreactor operation at higher algae seed levels and bloom levels than would otherwise be possible without encroaching on opacity limits in the pool; and wherein the higher seed levels accelerate algal bloom rates; and wherein the concentrated CO₂ further accelerates algal bloom rates; and wherein the increased surface area of the thin watery sheets enhances algal exposure to CO₂; and wherein the increased algal exposure to CO₂ further accelerates algal bloom rates; and wherein optical thinning enables more concentrated algal blooms to develop—beyond normal opacity limits.
59. The invention further includes the system of preceding section 46, in which the rotating auger is downward tapered from top to bottom.
60. The invention further includes the system of preceding section 58, in which the bioreactor algae pool floor is funnel-shaped.
61. The invention further includes the system of preceding section 58, in which perimeter edges of the auger blade are up-angled, rather than flat.
62. The invention further includes the system of preceding section 61, in which the extent of up-angling diminishes with vertical height on the ascending auger blade.
63. The invention further includes the system of preceding section 58, in which the rotating auger is encased in a pipe, and in which section 58 slinging action is blocked by the pipe wall; and wherein auger action is limited to lifting algae suspension to the upper extent of the bioreactor, and wherein the lifted algae suspension spills out the top of the pipe-encased auger onto the apex of a dome-topped-but-otherwise-tiered-wedding-cake-shaped nebulizer; and wherein the algae suspension spreads out into a downward flowing film over the dome-topped-but-otherwise-tiered-wedding-cake-shaped nebulizer; wherein the dome-topped-but-otherwise-tiered-wedding-cake-shaped nebulizer converts the downward flowing film of suspended algae into an aerosol or mist, or spray, and wherein the misted algae particles are exposed to CO₂ of the bioreactor headspace and to light from the bioreactor artificial lighting; and wherein the mist is optically thin and presents high surface area exposure to CO₂; and wherein optical thinness and high surface area exposure accelerate algal blooming and yield a more concentrated final algal bloom.
64. The invention further includes the system of preceding section 63, in which the dome-topped-but-otherwise-tiered-wedding-cake-shaped nebulizer is hollow and internally pressurized in the range of 5-200 psi with CO₂ from the CO₂ source, introduced from the source inlet; and wherein the outward-facing essentially vertical tiered facets of the dome-topped-but-otherwise-tiered-wedding-cake-shaped nebulizer are perforated with a multiplicity of CO₂-escape orifices; wherein pressurized CO₂ escapes through the CO₂ escape orifices to the bioreactor headspace; wherein the escaping CO₂ interrupts the downward-flowing film of algae suspension covering the dome-topped-but-otherwise-tiered-wedding-cake-shaped nebulizer; and wherein the film-interruption is of sufficient velocity and turbulence to convert suspended algae to a spray, mist, or aerosol within the bioreactor headspace, and wherein the spray, mist, or aerosol is exposed to headspace CO₂ and light from the artificial illumination.
65. The invention further includes the system of preceding section 64, in which the tiered wedding-cake structure of the nebulizer allows an unmisted fraction of the algae suspension, which missed (bypassed) each CO₂ escape orifice, to continue in a downward flowing film on a first tier essentially vertical facet until it reaches the unperforated essentially horizontal upper facet of at least a second tier; where it can repool on the essentially horizontal at least a second tier upper facet; and wherein the repooled algae suspension subsequently overflows the essentially horizontal at least a second tier upper facet and spills down as a flowing film over the perforated side of the at least a second tier of the nebulizer.
66. The invention further includes the system of preceding section 60, wherein algae is removed from the bottom of the funnel shaped pool floor essentially as fast as it blooms, wherein removal is to an adjacent separation tank; and wherein the separation tank is a flow-through tank; and wherein the flow velocity of algae suspension through the separation tank is reduced, at constant flow rate, by means of enlarged tank diameter, wherein the reduced flow velocity is low enough to permit algae that have flagella or other motility means to swim effectively against the flow current when presented with an upstream or side-stream attractant, wherein the direction of algal swimming is toward the attractant, and wherein algal swimming toward the attractant produces a concentrating effect on the algal suspension, and wherein the concentration of algae proximal to the attractant is made higher by the concentrating effect than the concentration of algae at points located progressively downstream from the attractant and still within the main flow of the flow-through separation tank.
67. The invention further includes the system of preceding section 66, wherein the separation tank contains a main flow exit port and a secondary exit port which is designated as a harvest exit tee, wherein the attractant is located at a position proximal to the mouth of the harvest exit tee, and wherein the mouth of the harvest exit tee is sufficiently narrow to raise the harvest exit flow velocity to exceed the capacity for algae to swim against the harvest exit current, and wherein algae swimming toward the attractant from the main separation tank are sucked into the harvest exit tee upon reaching the attractant, and wherein the harvest exit tee outflow leads to an algal harvest output port, and wherein the concentration of algae harvested at the harvest output port is higher than the concentration of algae entering the separation tank, and wherein the main flow of the flow through exit tank at points downstream of the attractant and having bypassed the harvest exit tee contains a reduced concentration of algae, relative to the concentration of algae entering the separation tank, and wherein the main flow of the flow-through exit tank having bypassed the harvest exit tee exits the separation tank through the main flow exit port, and wherein flow exiting the main flow exit port is recirculated to the original bioreactor.
68. The invention further includes the system of preceding section 67, in which the attractant is one or more attractants selected from among a group of attractants consisting of a light source, a nutrient source, a nutrient source, a carbon dioxide source, an attractive water temperature, and an attractive water pH, and wherein the rest of the separation tank is dark and relatively devoid of the chosen attractant or combination of attractants.
69. The invention further includes the system of preceding section 67, wherein liquid replenishment is joined to the recirculation flow leading into the original bioreactor to maintain a constant liquid level in the bioreactor pool; and wherein replenishment micronutrients are added to the pool at the same rate as they are consumed by continuous blooming of the heavier-than-water algae; and wherein replenishment CO₂ from the CO₂ source is provided to the bioreactor as fast as CO₂ is consumed in photosynthesis and/or coccolithogenesis (calcification) during algal blooming.
70. The invention further includes the system of preceding section 63, wherein algae is removed from the bottom of the bioreactor essentially as fast as it blooms, wherein removal is to an adjacent separation tank; and wherein the separation tank is a flow-through tank; and wherein the flow velocity of algae suspension through the separation tank is reduced, at constant flow rate, by means of enlarged tank diameter, wherein the reduced flow velocity is low enough to permit algae that have flagella or other motility means to swim effectively against the flow current when presented with an upstream or side-stream attractant, wherein the direction of algal swimming is toward the attractant, and wherein algal swimming toward the attractant produces a concentrating effect on the algal suspension, and wherein the concentration of algae proximal to the attractant is made higher by the concentrating effect than the concentration of algae at points located progressively downstream from the attractant and still within the main flow of the flow-through separation tank.
71. The invention further includes the system of preceding section 70, wherein the separation tank contains a main flow exit port and a secondary exit port which is designated as a harvest exit tee, wherein the attractant is located at a position proximal to the mouth of the harvest exit tee, wherein the mouth of the harvest exit tee is sufficiently narrow to raise the harvest exit flow velocity to exceed the capacity for algae to swim against the harvest exit current, wherein algae swimming toward the attractant from the main separation tank are sucked into the harvest exit tee upon reaching the attractant, wherein the harvest exit tee outflow leads to an algal harvest output port, wherein the concentration of algae harvested at the harvest output port is higher than the concentration of algae entering the separation tank, and wherein the main flow of the flow through exit tank at points downstream of the attractant and having bypassed the harvest exit tee contains a reduced concentration of algae, relative to the concentration of algae entering the separation tank, and wherein the main flow of the flow through exit tank having bypassed the harvest exit tee exits the separation tank through the main flow exit port, and wherein flow exiting the main flow exit port is recirculated to the original bioreactor.
72. The invention further includes the system of preceding section 71, in which the attractant is one or more attractants selected from among a group of attractants consisting of a light source, a nutrient source, a nutrient source, a carbon dioxide source, an attractive water temperature, and an attractive water pH, and wherein the rest of the separation tank is dark and relatively devoid of the chosen attractant or combination of attractants.
73. The invention further includes the system of preceding section 71, wherein liquid replenishment is joined to the recirculation flow leading into the original bioreactor to maintain a constant liquid level in the bioreactor pool; and wherein replenishment micronutrients are added to the pool at the same rate as they are consumed by continuous blooming of the heavier-than-water algae; and wherein replenishment CO₂ from the CO₂ source is provided to the bioreactor as fast as CO₂ is consumed in photosynthesis and/or coccolithogenesis during algal blooming.
74. The invention further includes the system of preceding section 4, wherein algae is removed from the bottom of the bioreactor essentially as fast as it blooms, and wherein removal is to an adjacent separation tank; and wherein the separation tank is a flow-through tank; and wherein the flow velocity of algae suspension through the separation tank is reduced, at constant flow rate, by means of enlarged tank diameter, wherein the reduced flow velocity is low enough to permit algae that have flagella or other motility means to swim effectively against the flow current when presented with an upstream or side-stream attractant, and wherein the direction of algal swimming is toward the attractant, and wherein algal swimming toward the attractant produces a concentrating effect on the algal suspension, and wherein the concentration of algae proximal to the attractant is made higher by the concentrating effect than the concentration of algae at points located progressively downstream from the attractant and still within the main flow of the flow-through separation tank.
75. The invention further includes the system of preceding section 74, wherein the separation tank contains a main flow exit port and a secondary exit port which is designated as a harvest exit tee, wherein the attractant is located at a position proximal to the mouth of the harvest exit tee, and wherein the mouth of the harvest exit tee is sufficiently narrow to raise the harvest exit flow velocity to exceed the capacity for algae to swim against the harvest exit current, wherein algae swimming toward the attractant from the main separation tank are sucked into the harvest exit tee upon reaching the attractant, and wherein the harvest exit tee outflow leads to an algal harvest output port, wherein the concentration of algae harvested at the harvest output port is higher than the concentration of algae entering the separation tank, and wherein the main flow of the flow through exit tank at points downstream of the attractant and having bypassed the harvest exit tee contains a reduced concentration of algae, relative to the concentration of algae entering the separation tank, and wherein the main flow of the flow through exit tank having bypassed the harvest exit tee exits the separation tank through the main flow exit port, and wherein flow exiting the main flow exit port is recirculated to the original bioreactor.
76. The invention further includes the system of preceding section 75, in which the attractant is one or more attractants selected from among a group of attractants consisting of a light source, a nutrient source, a nutrient source, a carbon dioxide source, an attractive water temperature, and an attractive water pH, and wherein the rest of the separation tank is dark and relatively devoid of the chosen attractant or combination of attractants.
77. The invention further includes the system of preceding section 76, wherein liquid replenishment is joined to the recirculation flow leading into the original bioreactor to maintain a constant liquid level in the bioreactor pool; and wherein replenishment micronutrients are added to the pool at the same rate as they are consumed by continuous blooming of the heavier-than-water algae; and wherein replenishment CO₂ from the CO₂ source is provided to the bioreactor as fast as CO₂ is consumed in photosynthesis and/or coccolithogenesis (calcification) during algal blooming.
78. The invention further includes the system of preceding section 58, wherein a headspace oxygen removal system removes headspace oxygen as fast as it is produced by bioreactor photosynthesis during algal blooming; and wherein the oxygen removal system maintains pseudo-anaerobic blooming conditions in the bioreactor; and wherein the pseudo-anaerobic blooming conditions further accelerate bloom rates.
79. The invention further includes the system of preceding section 63, wherein a headspace oxygen removal system removes headspace oxygen as fast as it is produced by bioreactor photosynthesis during algal blooming; and wherein the oxygen removal system maintains pseudo-anaerobic blooming conditions in the bioreactor; and wherein the pseudo-anaerobic blooming conditions further accelerate bloom rates.
80. The invention further includes the system of preceding section 4, wherein a headspace oxygen removal system removes headspace oxygen as fast as it is produced by bioreactor photosynthesis during algal blooming; and wherein the oxygen removal system maintains pseudo-anaerobic blooming conditions in the bioreactor; and wherein the pseudo-anaerobic blooming conditions further accelerate bloom rates.
81. The invention further includes the system of preceding section 78, wherein the headspace oxygen removal system comprises an oxygen permeable membrane; wherein a non-oxygenated gas flows across a far side of the oxygen permeable membrane producing an oxygen deficit on the far side; wherein the oxygen deficit is the driving force for oxygen produced within the bioreactor headspace on a near side of the oxygen permeable membrane to exit the headspace by permeating the oxygen permeable membrane from the near side of the oxygen permeable membrane through the oxygen permeable membrane to the far side of the oxygen permeable membrane; and wherein the oxygen permeable membrane blocks the exit of CO₂ from the bioreactor headspace.
82. The invention further includes the system of preceding section 79, wherein the headspace oxygen removal system comprises an oxygen permeable membrane; wherein a non-oxygenated gas flows across a far side of the oxygen permeable membrane producing an oxygen deficit on the far side; wherein the oxygen deficit is the driving force for oxygen produced within the bioreactor headspace on a near side of the oxygen permeable membrane to exit the headspace by permeating the oxygen permeable membrane from the near side of the oxygen permeable membrane through the oxygen permeable membrane to the far side of the oxygen permeable membrane; and wherein the oxygen permeable membrane blocks the exit of CO₂ from the bioreactor headspace.
83. The invention further includes the system of preceding section 80, wherein the headspace oxygen removal system comprises an oxygen permeable membrane; wherein a non-oxygenated gas flows across a far side of the oxygen permeable membrane producing an oxygen deficit on the far side; wherein the oxygen deficit is the driving force for oxygen produced within the bioreactor headspace on a near side of the oxygen permeable membrane to exit the headspace by permeating the oxygen permeable membrane from the near side of the oxygen permeable membrane through the oxygen permeable membrane to the far side of the oxygen permeable membrane; and wherein the oxygen permeable membrane blocks the exit of CO₂ from the bioreactor headspace.
84. The invention further includes the system of preceding section 58, wherein the artificial lighting is intermittent, turning on and off on a schedule favoring maximal blooming rate for the heavier-than-water algae at the existing bioreactor temperature.
85. The invention further includes the system of preceding section 63, wherein the artificial lighting is intermittent, turning on and off on a schedule favoring maximal blooming rate for the heavier-than-water algae at the existing bioreactor temperature.
86. The invention further includes the system of preceding section 4, wherein the artificial lighting is intermittent, turning on and off on a schedule favoring maximal blooming rate for the heavier-than-water algae at the existing bioreactor temperature.
87. The invention further includes the system of preceding section 84, wherein the bioreactor temperature is controlled to maintain a value favoring maximal blooming rate for the heavier-than-water algae.
88. The invention further includes the system of preceding section 85, wherein the bioreactor temperature is controlled to maintain a value favoring maximal blooming rate for the heavier-than-water algae.
89. The invention further includes the system of preceding section 86, wherein the bioreactor temperature is controlled to maintain a value favoring maximal blooming rate for the heavier-than-water algae.
90. The invention further includes the system of preceding section 58, wherein the wavelength of artificial lighting emissions is selected to favor maximal blooming rate for the heavier-than-water algae.
91. The invention further includes the system of preceding section 63, wherein the wavelength of artificial lighting emissions is selected to favor maximal blooming rate for the heavier-than-water algae.
92. The invention further includes the system of preceding section 4, wherein the wavelength of artificial lighting emissions is selected to favor maximal blooming rate for the heavier-than-water algae.
93. The invention further includes the system of preceding section 90, wherein the spectrum of artificial lighting is selected to include at least two wavelengths with emission intensities at those at least two wavelengths balanced to favor maximal blooming rate for the heavier-than-water algae.
94. The invention further includes the system, of preceding section 91, wherein the spectrum of artificial lighting is selected to include at least two wavelengths with emission intensities at those at least two wavelengths balanced to favor maximal blooming rate for the heavier-than-water algae.
95. The invention further includes the system of preceding section 92, wherein the spectrum of artificial lighting is selected to include at least two wavelengths with emission intensities at those at least two wavelengths balanced to favor maximal blooming rate for the heavier-than-water algae.
96. The invention further includes the system of preceding section 58, wherein the pH of the heavier-than-water algae pool is buffered at approximately 8.32.
97. The invention further includes the system of preceding section 63, wherein the pH of the heavier-than-water algae pool is buffered at approximately 8.32.
98. The invention further includes the system of preceding section 4, wherein the pH of the heavier-than-water algae pool is buffered at approximately 8.32.
99. The invention further includes the system of preceding section 96, wherein buffering at pH 8.32 is achieved by dosing the algae pool with disodium phosphate and monosodium phosphate in a mole ratio of approximately thirteen-to-one.
100. The invention further includes the system of preceding section 97, wherein buffering at pH 8.32 is achieved by dosing the algae pool with disodium phosphate and monosodium phosphate in a mole ratio of approximately thirteen-to-one.
101. The invention further includes the system of preceding section 98, wherein buffering at pH 8.32 is achieved by dosing the algae pool with disodium phosphate and monosodium phosphate in a mole ratio of approximately thirteen-to-one.
102. The invention further includes the system of preceding section 99, wherein the mole ratio is other than thirteen-to-one and the pH is other than 8.32 during initial preparation; wherein other acids, bases, or amphoteric salts are added to readjust the actual solution concentrations of disodium phosphate and monosodium phosphate to a mole ratio of approximately thirteen-to-one via acid-base reaction; wherein the pH is thereby adjusted to approximately 8.32.
103. The invention further includes the system of preceding section 100, wherein the mole ratio is other than thirteen-to-one and the pH is other than 8.32 during initial preparation; wherein other acids, bases, or amphoteric salts are added to readjust the actual solution concentrations of disodium phosphate and monosodium phosphate to a mole ratio of approximately thirteen-to-one via acid-base reaction; wherein the pH is thereby adjusted to approximately 8.32.
104. The invention further includes the system of preceding section 101, wherein the mole ratio is other than thirteen-to-one and the pH is other than 8.32 during initial preparation; wherein other acids, bases, or amphoteric salts are added to readjust the actual solution concentrations of disodium phosphate and monosodium phosphate to a mole ratio of approximately thirteen-to-one via acid-base reaction; wherein the pH is thereby adjusted to approximately 8.32.
105. The invention further includes the system of preceding section 43, wherein the alkali metal hydroxide and/or the alkaline-earth hydroxide solution(s) are spread into an essentially downward continuous flowing film of exposed surface area, and wherein the source of CO₂ is a continuous gaseous counter-flow (essentially an upward flow) exposed to the solution film.
106. The invention further includes the system of preceding section 105, wherein the essentially downward continuous flowing solution film flows spirally downward, covering and flowing down the blade or blades of a slowly rotating vertical auger, wherein the auger is housed within a silo or bin which is marginally larger in diameter than the auger diameter, and wherein the CO₂ source is CO₂-laden outdoor air, and wherein the silo or bin has outdoor air intake ports around the base of its perimeter proximal to the lower extent of the auger blades, and wherein rotation of the auger draws outdoor air into the bin or silo at its base and lifts it spirally upward through the bin or silo, ejecting it near the top, and wherein the spirally upward moving air moves in an upward spiral counter-flow to the downward-spiraling flowing solution film, and wherein the downward-spiraling flowing solution film absorbs CO₂ from the upward-spiraling counter-flow of air, and wherein the downward-flowing film solution is converted to alkali bicarbonate or alkaline-earth carbonate solution by absorbing the CO₂, and wherein the bicarbonate or carbonate solution spills off the bottom of the auger blades onto a surface which drains to an exit drain from the silo or bin.
107. The invention further includes the system of preceding section 105, wherein the essentially downward continuous flowing film is formed by a rising flow of alkali hydroxide or alkaline-earth hydroxide solution being directed upward through a vertical standpipe housed within a cylindrical chamber, and wherein the rising flow of solution continuously overflows the top of the vertical standpipe and spills down the exterior wall of the standpipe forming a downward-flowing film of solution on the exterior surface of the standpipe, flowing off the bottom of the standpipe exterior onto a chamber floor surface which is continuous with the exterior of the standpipe, and wherein the floor surface drains into an exit drain from the chamber, and wherein the CO₂ source is a gaseous upward counter-flow of CO₂-laden gas which enters the chamber tangentially at a point higher than the exit drain, and wherein the upward counter-flow of CO₂-laden gas is a laminar counter-flow, a turbulent counter-flow, or a vortex counter-flow encircling the standpipe and rising concentrically around it in the annular space between the standpipe and the chamber wall, and wherein the upward counter-flow of CO₂-laden gas exits the chamber near its upper extent, and wherein the upward laminar counter-flow, turbulent counter-flow, or vortex counter-flow of CO₂-laden gas is exposed to the downward-flowing film of alkali hydroxide or alkaline-earth hydroxide solution, and wherein CO₂ in the upward laminar counter-flow, turbulent counter-flow, or vortex counter-flow of gas is absorbed by the downward-flowing solution film, and wherein absorbing CO₂ causes the downward-flowing solution film to be converted to alkali bicarbonate or alkaline-earth carbonate solution by the time it reaches the lower extent of the standpipe exterior, and wherein the alkali bicarbonate or alkaline-earth carbonate solution exits the exit drain.
108. The invention further includes the system of preceding section 1, in which heavier-than-water algae from the bioreactor proceed to an adjacent settling tank after blooming, and in which settling tank conditions are maintained that do not encourage algae to swim against a current, and in which the heavier-than-water algae instead sink toward a funnel shaped harvest exit port at the bottom of the settling tank, and in which optional recirculation of clarified liquid near the top of the settling tank is provided back to the main bioreactor, with top-water clarification occurring as the algae sink to the funnel shaped bottom, and in which a concentrating effect is achieved via sedimentation of the sinking algae prior to their exit at the harvest exit port.
109. The invention further includes the system of preceding section 60, in which heavier-than-water algae from the bioreactor proceed to an adjacent settling tank after blooming, and in which settling tank conditions are maintained that do not encourage algae to swim against a current, and in which the heavier-than-water algae instead sink toward a funnel shaped harvest exit port at the bottom of the settling tank, and in which optional recirculation of clarified liquid near the top of the settling tank is provided back to the main bioreactor, with top-water clarification occurring as the algae sink to the funnel shaped bottom, and in which a concentrating effect is achieved via sedimentation of the sinking algae prior to their exit at the harvest exit port.
110. The invention further includes the system of preceding section 63, in which heavier-than-water algae from the bioreactor proceed to an adjacent settling tank after blooming, and in which settling tank conditions are maintained that do not encourage algae to swim against a current, and in which the heavier-than-water algae instead sink toward a funnel shaped harvest exit port at the bottom of the settling tank, and in which optional recirculation of clarified liquid near the top of the settling tank is provided back to the main bioreactor, with top-water clarification occurring as the algae sink to the funnel shaped bottom, and in which a concentrating effect is achieved via sedimentation of the sinking algae prior to their exit at the harvest exit port.
111. The invention further includes the system of preceding section 4, in which heavier-than-water algae from the bioreactor proceed to an adjacent settling tank after blooming, and in which settling tank conditions are maintained that do not encourage algae to swim against a current, and in which the heavier-than-water algae instead sink toward a funnel shaped harvest exit port at the bottom of the settling tank, and in which optional recirculation of clarified liquid near the top of the settling tank is provided back to the main bioreactor, with top-water clarification occurring as the algae sink to the funnel shaped bottom, and in which a concentrating effect is achieved via sedimentation of the sinking algae prior to their exit at the harvest exit port.
112. The invention further includes the system of preceding section 2, wherein a motorized roller brush cleaning assembly, a squeegee cleaning assembly, or a combination motorized-roller-brush-and-squeegee cleaning assembly is parked above the rotating auger blade assembly during a bloom cycle, and wherein during periodic cleaning cycle, the bioreactor is drained of algae suspension and filled with cleaning solution which temporarily replaces the algae pool, and in which cleaning cycle, the auger rotation direction is reversed and the rotation speed is slowed to a low rotation speed, and in which the cleaning assembly is lowered to synchronously mesh with the auger blades, wherein the auger blade rotation draws the cleaning assembly down through the turns of the auger blade, and wherein the motorized roller brushes and/or squeegee elements of the cleaning assembly clean the auger blades over the entire length of the auger, and in which the auger stops when the cleaning assembly reaches the bottom of the auger and reverses direction, drawing the cleaning assembly back to the top along a vertical guide track, and in which the cleaning assembly disengages from the auger blades at the top and is reparked above the auger blades, and in which the bioreactor is rinsed of cleaning solution and refilled with seed algae suspension in preparation for the next bloom cycle.

This ends the listing of one hundred and twelve specific Ser. No. 13/999,1965 spin-off basis elements. Now continues (below) a list of CIP spin-off invention inclusions (variously spun-off in combination from the 112 basis elements and/or listed as stand-alone inclusions), involving DMS production, rain-cloud seeding, enhanced soil moisture retention, drought-relief, and famine relief, with an appended list of CIP inclusions following thereafter in this section.

113. A bioreactor containing a culture of ocean grazers selected from among a group of algae-consuming ocean grazers consisting of zooplankton, krill, small fish, mollusks, and crustaceans, in which the culture of ocean grazers is fed marine algae, and in which the ocean grazers eat the marine algae—causing it to release dimethylsulfide (DMS), a natural cloud seeding agent.
114. The bioreactor of inclusion 113, in which the bioreactor is the ocean and the marine algae is ocean-amplified stage-2 blooming from pertinent basis-elements of Ser. No. 13/999,195 inventions from the foregoing list of 112 basis elements.
115. The bioreactor of inclusion 113, in which the bioreactor is an inland bioreactor and the marine algae are harvested from inland algae bioreactors (e.g. silos) selected from pertinent basis-elements of Ser. No. 13/999,195 inventions from the foregoing list of 112 basis elements.
116. The inland bioreactor of inclusion 115, in which the bioreactor is located in proximity to a drought-stressed region and DMS is released directly to atmosphere, in order to locally seed rain-clouds.
117. The inland bioreactor of inclusion 115, in which the bioreactor is fed by marine algae from an algae bioreactor that is originally fed CO₂ captured from a CCS source of concentrated CO₂ selected from among a group of CO₂ (CCS) sources consisting of CCS power plants, CCS home & building heating, CCS natural gas reformation, CCS coal gasification, CCS oil gasification, CCS fossil hydrogen production, CCS cement production, CCS blast furnaces, CCS kilns, CCS crematoriums, CCS factories, CCS refineries, CCS outdoor air capture, and any other CCS source of concentrated CO₂.
118. The inland bioreactor of inclusions 113 and 115-116, in which a harvest outlet is provided for obtaining excess live ocean grazers for purposes of transporting the grazers to sea and releasing them in the midst of stage-2 Ser. No. 13/999,195 ocean-amplified algal blooms from pertinent basis-elements of Ser. No. 13/999,195 inventions from the foregoing list of 112 basis elements—at or approaching the peak of stage-2 ocean blooming, so that grazer feeding on the substantially peaked blooms triggers DMS release, and seeding of ocean cloud-cover.
119. The inland bioreactors of inclusions 113, 115, and/or 117, in which DMS is collected, and condensed for future use, or for transport to remote locations within, adjacent to or off-shore from distant drought-stressed lands for remote release in order to seed rain-clouds that will relieve drought and/or result in famine relief.
120. DMS-induced cloud-seeding offshore of drought-stressed lands, in which seeded clouds are driven inland by prevailing onshore winds.
121. DMS-induced cloud-seeding of inclusion 120 in which the DMS is released from a ship located along the wind-ward shores of drought-stressed lands.
122. DMS-induced cloud-seeding in which the DMS is released inland—from a station, vehicle, or moving vehicle inland, within or proximal to drought-stressed lands.
123. A combination system for production of algae and secondary production of dimethylsulfide (DMS), a natural cloud-seeding agent, the system comprising: a CO₂ source; and a first algae-producing bioreactor supplied with concentrated CO₂ from the CO₂ source; and a second DMS-producing bioreactor supplied with algae produced by the first bioreactor; in which the first bioreactor is configured to encourage accelerated growth and reproduction of algae as well as to enable development of a more concentrated final algal bloom; in which optical opacity limits on seed level and bloom concentration are circumvented by an optical thinning effect which enables greater light penetration into more concentrated algae suspensions; wherein the greater light penetration enables higher level initial seeding or inoculation of the bioreactor bloom space; wherein the higher level of initial seed accelerates blooming as a result of starting higher on an upward-bending nonlinear algal growth curve; and in which a normally inaccessible upper section of the nonlinear algal growth curve is conventionally inaccessible owing to optical opacity of concentrated algal suspensions; and in which the normally inaccessible upper section of the nonlinear growth curve is rendered accessible by the optical thinning effect which enables light penetration into optically thinned suspensions of concentrated algae; and in which the second bioreactor contains a culture of grazers that eat the algae supplied by the first bioreactor; in which grazer feeding on the algae causes the algae to release DMS.
124. The system of inclusion 123, wherein the optical thinning effect in the first bioreactor is produced by slinging an algae suspension as thin watery sheets off the perimeter edges of a rotating auger blade which lifts algae suspension out of a pool, elevates the lifted suspension, and slings it outward by centrifugal force to form optically thin watery sheets, and wherein optical thinness of the slinging sheets enables improved optical penetration by rays from a light source shining through the slinging sheets.
125. The system of inclusion 123, in which the algae suspension from the first bioreactor proceeds to a flow-through separation tank after blooming, wherein the flow velocity of algae suspension through the separation tank is reduced, at constant flow rate, by means of enlarged tank diameter, and wherein the reduced flow velocity is low enough to permit algae that have flagella or other motility means to swim effectively against the flow current when presented with an upstream or side-stream attractant, and wherein the direction of algal swimming is toward the attractant, and wherein algal swimming toward the attractant produces a concentrating effect on the algal suspension, and wherein the concentration of algae proximal to the attractant is made higher by the concentrating effect than the concentration of algae at points located progressively downstream from the attractant and still within the main flow of the flow-through separation tank.
126. The system of inclusion 125, wherein the separation tank contains a main flow exit port and a secondary exit port which is designated as a harvest exit tee, wherein the attractant is located at a position proximal to the mouth of the harvest exit tee, and wherein the mouth of the harvest exit tee is sufficiently narrow to raise the harvest exit flow velocity to exceed the capacity for algae to swim against the harvest exit current, wherein algae swimming toward the attractant from the main separation tank are sucked into the harvest exit tee upon reaching the attractant, wherein the harvest exit tee outflow leads to an algal harvest output port of the first bioreactor, wherein the concentration of algae harvested at the harvest output port is higher than the concentration of algae entering the separation tank, and wherein the main flow of the flow through exit tank at points downstream of the attractant and having bypassed the harvest exit tee contains a reduced concentration of algae, relative to the concentration of algae entering the separation tank, and wherein the main flow of the flow through exit tank having bypassed the harvest exit tee exits the separation tank through the main flow exit port, and wherein flow exiting the main flow exit port is recirculated to the original bioreactor, and wherein algae produced at the algal harvest output port of the first bioreactor are introduced into the second bioreactor.
127. The system of inclusion 126, in which the attractant within the first bioreactor is one or more attractants selected from among a group of attractants consisting of a light source, a nutrient source, a carbon dioxide source, an attractive water temperature, and an attractive water pH, and wherein the rest of the separation tank is dark and relatively devoid of the chosen attractant or combination of attractants.
128. A system for production of algae and secondary production of dimethylsulfide (DMS), a natural cloud-seeding agent, the system comprising: a hydrocarbon cracking reactor configured to generate a stream of concentrated CO₂ byproduct; and a first bioreactor configured to produce heavier-than-water algae, the first bioreactor supplied, at least in part, with CO₂ from the stream of concentrated CO₂ byproduct; and a second DMS-producing bioreactor supplied with algae produced by the first bioreactor; in which the hydrocarbon cracking reactor produces H₂ as its main product; and in which the second bioreactor contains a culture of grazers that eat the algae supplied by the first bioreactor; in which grazer feeding on the algae causes the algae to release DMS.
129. The system of inclusion 128, wherein the hydrocarbon cracking reactor is a two-stage steam reactor operating with steam stages at two different temperatures, optimized for cracking methane as the principal component of natural-gas.
130. The system of inclusion 123 wherein the CO₂ source is a CC (carbon-capture) clean-coal-fired power plant, the CC power plant producing electricity as a public utility and concentrated CO₂ byproduct as the CO₂ source in the form of a supercritical fluid (SCF-CO₂).
131. The system of inclusion 130, wherein the SCF-CO₂ is decompressed to concentrated CO₂ gas and introduced into the first bioreactor.
132. The system of inclusion 123 wherein the CO₂ source is a CC (carbon-capture) gas-fired power plant, the CC power plant producing electricity as public utility and concentrated CO₂ byproduct as the CO₂ source in the form of a supercritical fluid (SCF-CO₂).
133. The system of inclusion 132, wherein the SCF-CO₂ is decompressed to concentrated CO₂ gas and introduced into the first bioreactor.
134. A process of ocean-amplified CO₂ capture and amplified release of dimethylsulfide (DMS, a natural cloud seeding agent) at sea, wherein algae plus nutrient are seeded into the ocean instead of nutrient-alone; the process comprising: land-based capture of concentrated CO₂ from a land-based CO₂ source; land-based conversion of captured CO₂ to heavier-than-water marine algae in at least one bioreactor configured to encourage the rapid growth and reproduction of the heavier-than-water marine algae as ocean seed; transport of the heavier-than-water marine algae as ocean seed to seaports for ocean distribution and dispersal with added nutrients in order to seed ocean-amplified blooming (further growth and rapid reproduction at sea—essentially secondary blooming on a vast ocean scale); attack on the secondary ocean algal blooms by ocean grazers such as zooplankton and krill (as nonlimiting examples) who eat the secondarily bloomed algae—causing the algae to release DMS at sea; wherein the ocean-amplified algal blooming occurs essentially selectively for the heavier-than-water species of marine algae by virtue of the heavier-than-water marine algae being distributed, dispersed, and seeded into the ocean water at higher levels than existing natural buoyant ocean algae, the higher levels selectively accelerating ocean blooming rates of the heavier-than-water marine algae by virtue of seeding the ocean with marine algae seed harvested from the at least one land-based bioreactor, wherein ocean seeding occurs higher than normal on a nonlinear algal growth curve and produces a species-selective dominance of the ocean algal bloom, wherein the higher that the ocean blooming starts on the growth curve, the faster it proceeds, if sufficient nutrient is present or provided, and wherein the ocean grazers are selected from among a group of ocean grazers consisting of ocean grazers naturally occurring in the ocean and a culture of ocean grazers produced by inland bioreactors, in which the ocean grazers produced by the inland bioreactors are transported for release at the ocean algal bloom site.
135. The process of inclusion 134 in which the species-selective ocean algal bloom dominance is further enhanced by nutrient selection, and in which nutrient selection for E. huxleyi coccolithophorid marine algae blooming includes nutrients which are deficient in phosphate, wherein phosphate deficiency, while other nutrients are concurrently provided in abundance, promotes prodigious E. huxleyi growth at sea, essentially to the exclusion of blooming by other species of marine algae, including buoyant algae, in the seeded ocean area.
136. The process of inclusion 134, wherein transport to seaport of the heavier-than-water marine algae seed, and/or transport to seaport of the ocean grazer culture produced by inland bioreactors, occurs by flat-bed truck, flat rail car, or barge; wherein the flat-bed truck, flat rail car, or barge carry the marine algae seed, and/or the ocean grazer culture produced by inland bioreactors, in stasis-supporting cargo containers which are transferrable by crane or other lifting means from one flat-bed transportation means to another, and wherein the cargo containers are designed to maintain conditions in support of a healthy stasis condition for the heavier-than-water marine algae seed and/or the ocean grazer culture produced by inland bioreactors.
137. The process of inclusion 136, wherein the stasis-supporting cargo containers may be loaded onto ocean freighters docked at seaports, the ocean freighters then distributing the stasis-supporting cargo containers to floating seed and/or ocean grazer culture repositories at sea; wherefrom the stasis-supporting cargo containers may be transferred to dispersal boats which fan out from the floating seed and/or ocean grazer culture repositories to disperse and dispense the heavier-than-water marine algae seed (plus nutrients) and/or ocean grazer cultures produced by the inland bioreactors into the ocean for ocean-amplified algal blooming to proceed, along with ocean-amplified atmospheric CO₂ capture as the heavier-than-water marine algae bloom prodigiously at sea, and for a fraction of the ocean-amplified marine algae bloom to release large amounts of DMS as the algae are eaten by the ocean grazers, and wherein a preferred embodiment of the invention involves delaying ocean-introduction of the ocean grazer cultures produced by the inland bioreactors until the ocean-amplified marine algal bloom has appreciably matured and already captured substantial amounts of atmospheric CO₂ in the process of blooming.
138. The process of inclusion 137, wherein the nutrient doses are metered to support heavier-than-water ocean-amplified algal blooming up to the light penetration (algal opacity) limit and then run out.
139. The process of inclusion 138, wherein the ocean-amplified bloom dies a death selected from among a group of death categories consisting of death by starvation after the metered micro-nutrient doses run out or death by being eaten by ocean grazers; wherein death by being eaten by ocean grazers causes algal release of DMS, and wherein the dead heavier-than-water amplified bloom loses motility and residual (uneaten) dead algae sink rapidly, clearing the ocean photic zone before the end of each month and enabling restored light penetration into the photic zone to support another amplified bloom following a next month's seeding.
140. The process of inclusion 139 in which algal blooming and DMS release proceed with up to 12 batch algal blooms/year being seeded and achieved, with each ocean-amplified batch algal bloom approaching the light penetration (algal opacity) limit before it is eaten by grazers or dies of starvation and sinks, and in which accumulated amplified ocean blooming yields up to 14 GtC/yr of heavier-than-water algae (correspondingly capturing 14 GtC/yr of atmospheric CO₂) globally for each 1-3 GtC/yr of seeding with land-based heavier-than-water algae seed produced by the land-based bioreactors, wherein the predominant heavier-than-water ocean algal bloom species are determined by the species of land-based bioreactor seed algae harvested from the bioreactor, and wherein the bioreactor seed algae are dominated by initially preseeding the bioreactor with a purified culture of the desired marine algae species, and wherein the desired marine algae species are selected from a group consisting of coccolithophore (e.g., E. huxleyi) and siliceous diatoms.
141. The process of inclusion 139, wherein the seeding of amplified ocean blooming and DMS release are restricted to the vast open ocean that is further out from shore, well beyond the realm of coastal waters and beyond the shallow coastal-shelf sea floor, out in the open seas where much deeper water prevails, wherein species-selective bloom dominance and rapid sinking quickly carries the uneaten fraction of dead heavier-than-water algae below the ocean thermocline of the open seas and all the way to the deep-sea floor, wherein deep ocean temperatures at the deep-sea floor are quite low—near to zero degrees centigrade, and wherein low deep-sea temperatures preserve the uneaten fraction of dead algae and slow and/or suppress the onset of secondary bacterial action, algal decay, eutrophication, and post-bloom anoxia which would otherwise deplete ocean-dissolved oxygen, and wherein the slowing or suppression of bacterial action at low temperature at the deep-sea floor delays the onset of eutrophication and post bloom anoxia to an extent enabling ocean sedimentation, often referred to as marine “snow”, to essentially bury the dead algae before significant post-bloom anoxia or eutrophication can develop.
142. The process of inclusion 140, wherein approximately 1 GtC/yr of seed algae triggers amplified ocean blooming of up to 14 GtC/yr of heavier-than-water algae and correspondingly elevated DMS release; but wherein approximately another 2 GtC/yr of seed algae are needed to satiate marine grazer appetites (among naturally occurring grazers), producing early DMS release, so that the satiated naturally occurring grazers leave the approximately 1 GtC/yr of seed uneaten so that it remains to trigger the amplified ocean blooming of the up to 14 GtC/yr of heavier-than-water algae and corresponding photosynthetic and/or coccolithogenic (calcification) capture of up to 14 GtC/yr of atmospheric CO₂, and in which ocean seeding with approximately 3 GtC/yr of algal seed produced by land-based bioreactors provides both the 2 GtC/yr of algae to satiate the grazer appetites, producing an early DMS release, and the remaining 1 GtC/yr of uneaten seed that remain to trigger the amplified ocean blooming of the up to 14 GtC/yr of heavier-than-water algae, optionally followed by later DMS release upon delayed introduction of the bioreactor-produced grazer cultures.
143. A process in which algae is fed to fish farms, brine shrimp tanks, or tanks of other small marine life to raise schools of the small fish, brine shrimp, or other marine life comprising predators which prey on ocean grazers, and the small fish, brine shrimp, or other marine life are transported and released to control grazer populations at sea.
144. The fish farms, shrimp tanks, or other small marine life tanks of inclusion 143 in which the small fish, shrimp, or small marine life are fed to farms that raise larger fish.
145. An algal bioreactor in which liquid shearing forces are applied to bloomed algae, the mechanical stress of the shearing force causing bloomed algae to release DMS without being attacked by grazers.
146. An algal bioreactor in which sonication stresses bloomed algae, the sonication stress causing bloomed algae to release DMS without being attacked by grazers.
147. An algal bioreactor in which a combination of sonication and liquid shearing forces (e.g., as applied by a Polytron-type or Tekmar-type homogenizer) stress bloomed algae, the combination sonication and liquid shearing force stress causing bloomed algae to release DMS without being attacked by grazers.
148. An algal bioreactor in which microwaves stress bloomed algae, the microwave-induced stress causing bloomed algae to release DMS without being attacked by grazers.
149. An algal bioreactor in which blender blades stress bloomed algae, the blender-blade stress causing bloomed algae to release DMS without being attacked by grazers.
150. An auger-based, slinging sheet fountain algal bioreactor from Ser. No. 13/999,195 in which the bioreactor auger speed is increased to stress bloomed algae, the auger-speed stress causing bloomed algae to release DMS without being attacked by grazers.
151. An auger-based, slinging sheet fountain algal bioreactor from Ser. No. 13/999,195 in which the auger rotation is halted and grazers are added to the bioreactor after the algal bloom has reached maturity, the grazers then eating the algae, resulting in DMS release.

### BRIEF DESCRIPTION OF THE DRAWINGS

FIG. 1 is a system diagram of an invention comprising a coal-fired, gas-fired, or oil-fired CCS power-plant (10), captured CO₂ (11, 13), decompression chamber (16), algae silo (18), and grazer tank (2) for dimethylsulfide (DMS) production (3) and DMS-induced cloud-seeding (4).

FIG. 2 is the same as FIG. 1 with a natural gas (CH₄) reformation system (30-40) for hydrogen production (37) replacing the CCS power plant and fueling a hydrogen-powered vehicle (38).

FIG. 3 is a system diagram combining captured CO₂ (51, 53, 59, 58) from CCS power plants, CH₄ reformation systems, and other inland CO₂ sources (57) into an algae silo array (63-65) or a FIG. 1 algae silo, grazer tank, DMS production, and DMS-induced cloud-seeding system.

FIG. 4 is a process diagram of how invention system stage-1 (70) couples to invention system stage-2 (71), the final ocean-amplified CO₂ capture process.

FIG. 5 is a graphical projection of results expected from two-stage Ser. No. 13/999,165 invention system amplification. It is a graph of anticipated invention seed & capture rates showing amplification.

FIG. 6 is the same as FIG. 4 with addition of live grazers from harvest port 5 on tank (2) into ocean (9, 76), at the peak of EHUX blooming produced by seeding (8) with algae and nutrient.

FIG. 7 is invention cloud-seeding that bypasses ocean algal blooming. DMS is condensed (6) and transported to a ship along windward (225) shores (226) of drought-stressed lands.

FIG. 8 illustrates FIG. 7 cloud-seeding with raincloud (212) pushed on shore (226) by winds (225). Drought-relieving rains (227) result for the otherwise semi-arid, drought-prone land (226).

FIG. 9 is the same as FIGS. 7, 8, except DMS is released from a tanker truck (216) to alleviate inland drought farther from sea-shore by directly seeding (217, 214) inland rain clouds (212).

FIG. 10 is a cross-sectional view diagram of internal workings of FIGS. 1-4, 6, 7, 9, 11, 12, 14, and 15 invention stage-1 algae conversion silo (18, 65, 90).

FIG. 11 is a diagram of Type #2 (NaOH starter path) of a stage-1 invention configuration involving algal conversion of CO₂ from a generic CO₂-laden gas mixture source (120).

FIG. 12 is the same as FIG. 11, except that the CO₂-laden gas mixture source is a CCS natural gas (methane, CH₄) reformation system for making hydrogen (H₂) as a transportation fuel.

FIG. 13 diagrams yet another Type #2 stage-1 lye capture path Ser. No. 13/999,165 invention embodiment involving a lye scrubber for home and building flues.

FIG. 14 diagrams an outdoor air, Type #2 stage-1 CO₂ land-capture (180-191), algal conversion (141), DMS production (1-7), with NaOH (180) producing NaHCO₃ (190).

FIG. 15 is the same as FIG. 14 with a generic source of NaHCO₃ replacing the outdoor air type #2 stage-1 CO₂ land capture system.

### DETAILED DESCRIPTION OF THE INVENTION

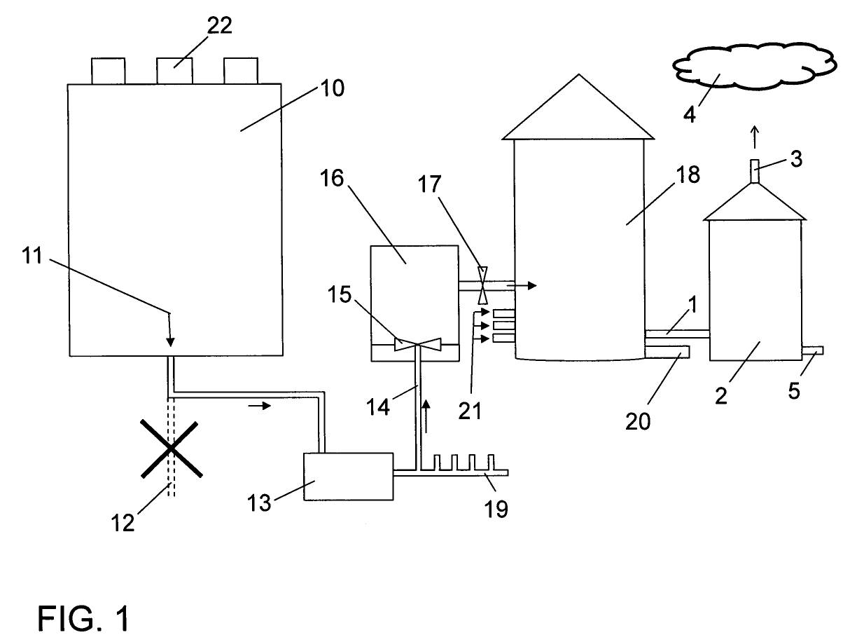

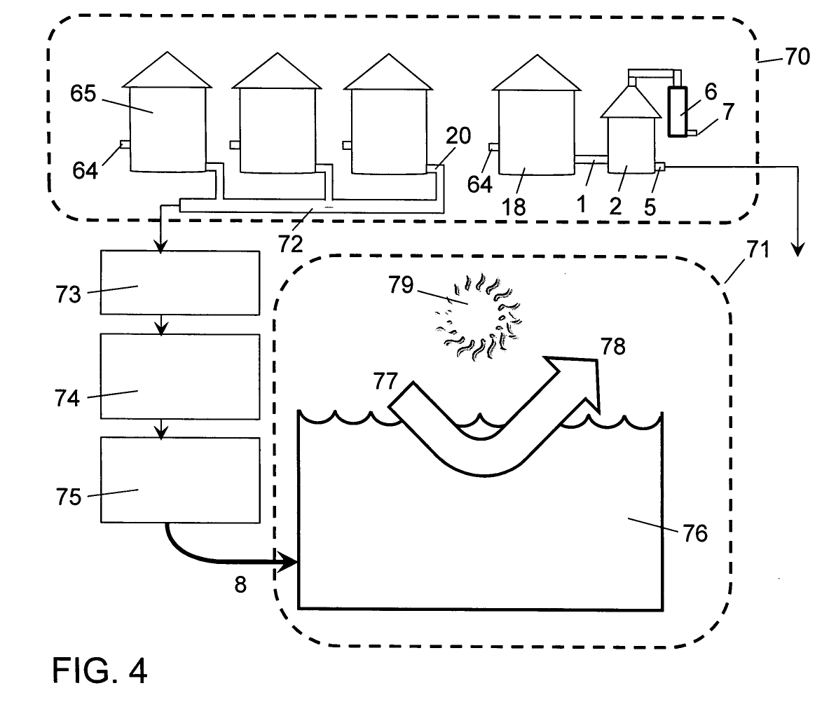

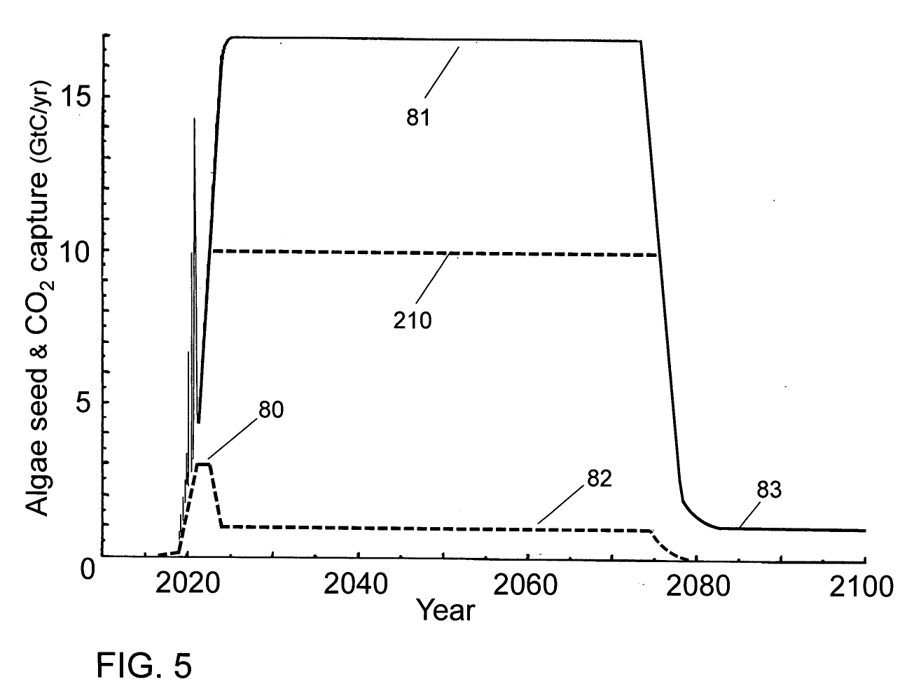

FIG. 1 is a diagram of a Type #1, supercritical fluid carbon dioxide (SCF-CO₂) path, stage-1 invention configuration initially involving a prior-art CCS (carbon capture and sequestration) coal-fired or gas-fired electric power plant (10). FIG. 1 is a diagram of a Type #1 stage-1 invention system used as a prelude to the invention stage-2, 15× amplified ocean capture of FIGS. 4, 5. Using whole-earth carbon accounting, the two stage invention (FIGS. 1, 4) can impart a substantial (700%) negative carbon footprint to coal-fired or gas-fired CCS electric power plants. The figure includes a collection of prior-art, recent invention (U.S. application Ser. No. 13/999,195 (hereinafter just: “Ser. No. 13/999,195)), and current CIP invention elements. Items 10, 11, 12, and 22 comprise a modern prior-art CCS coal-fired or CCS gas-fired electric power plant which is capable of capturing at least 50% (and as much as 90%) of its carbon dioxide emissions as supercritical fluid carbon dioxide, SCF-CO₂ (11). The other 50% to 10% still escapes (22) to atmosphere, but in prior-art pilot systems, the captured SCF-CO₂ is normally intended to be pumped underground (12) into subterranean porous rock structures for storage. The FIG. 1, Ser. No. 13/999,195-invention segment (13-20) eliminates the prior-art burial pipe (12) and redirects the SCF-CO₂ to an invention system holding tank (13). From there, SCF-CO₂ is invention-decompressed (14-16) from high supercritical fluid pressure, into an invention system medium-pressure gas holding chamber (16). From there, stage-1 of the invention system involves the medium pressure CO₂ being further decompressed (17) and injected into an invention algae conversion silo (18). The invention stage-1 silo has been pre-seeded with high-density (heavier than water) marine algae seed suspended in salt water or sea water. Nutrient and pH buffer are also provided (21). As the algae seed blooms further, injected CO₂ is consumed by photosynthesis and/or coccolithogenesis (calcification), thereby producing additional algae of the same type at the harvest output (20). An invention harvest auger (20) removes excess algae from the silo as fast as it blooms for FIG. 4 transport to seaports where FIGS. 4, 5 stage-2 invention ocean amplification begins. In stage-2 (see FIGS. 4, 5), the harvest silo seed (20) may bloom another factor of 15× at sea. With nominally 10-50% CO₂ lost (to atmosphere) via FIG. 1 exhaust stacks (22), the overall 2-stage Ser. No. 13/999,195 invention segment (FIGS. 1, 4, 5) amplification factor is reduced to about 8×-13×, but this still means that, for every 1 ton of CO₂ produced in prior-art CCS coal or CCS gas combustion, nominally 7-12 more tons of CO₂ will be captured at sea. This imparts nominally a 700%-1300% net negative carbon footprint to electric power production by CCS coal-fired or CCS gas-fired power plants, using whole-earth carbon accounting. By this means the Ser. No. 13/999,195-invention system enables CCS clean-coal and CCS gas-fired electric power plants to become primary engines for global atmospheric CO₂ reduction. Invention-enhanced CCS clean-coal and CCS gas-fired power plants will become drivers of (net) carbon sinking instead of carbon sourcing and contribute substantially to a 17 GtC/yr amplified contingency capture requirement (see Ser. No. 13/999,195) and also a 10 GtC/yr impact capture requirement (Ser. No. 13/999,195).

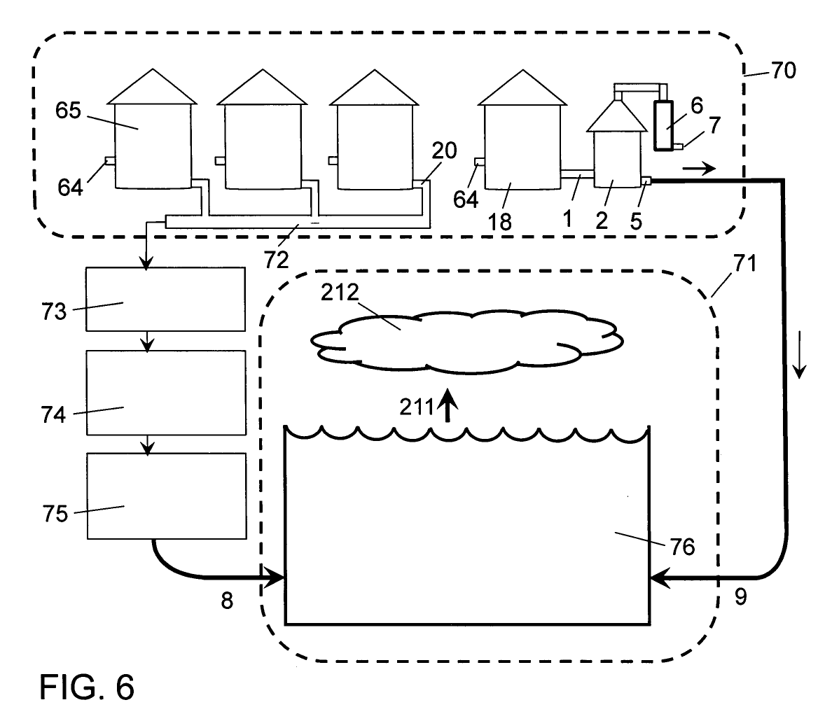

The remainder of FIG. 1 (labeled items 1-5) comprise the current invention, which is a C.I.P. of Ser. No. 13/999,195 (hereinafter “CIP—Ser. No. 13/999195”). CIP—Ser. No. 13/999195 elements 1-5 comprise an auxiliary “grazer tank” in which marine algae from invention silo 18 is fed (1) to ocean grazers (e.g. zooplankton, krill, etc.) contained in auxiliary tank 2, in order to stimulate release of dimethylsulfide (hereinafter “DMS”) which is volatile and may exit tank 2 at port 3. Being lighter-than-air, DMS rises high in the atmosphere, photo-oxidizes to dimethylsulfoxide (hereinafter, “DMSO”) which is a natural cloud seeding agent, finally causing the formation of rain-clouds (4). That is one means of invention-induced drought and famine relief. Note that algae bioreactor (silo) 18 may either yield algae at port 20 for seeding ocean-amplified blooming in FIGS. 4, 5, or it may feed grazer tank (2) in order to yield DMS production at outlet 3 for seeding rain-clouds (4). Only one algae bioreactor (18) is depicted, but in reality a large number of bioreactors 18 would be associated with each CCS power plant (10), with the majority of bioreactors (18) supplying seed algae at port 20 for seeding amplified secondary ocean blooming and correspondingly amplified capture of atmospheric CO₂ at sea. The remainder of bioreactors (18) would then feed (1) grazer tank (2) to stimulate DMS production (3) and rain-cloud seeding (4). Item 5 is an outlet port at which live grazer harvest may be obtained for subsequent use in FIG. 6.

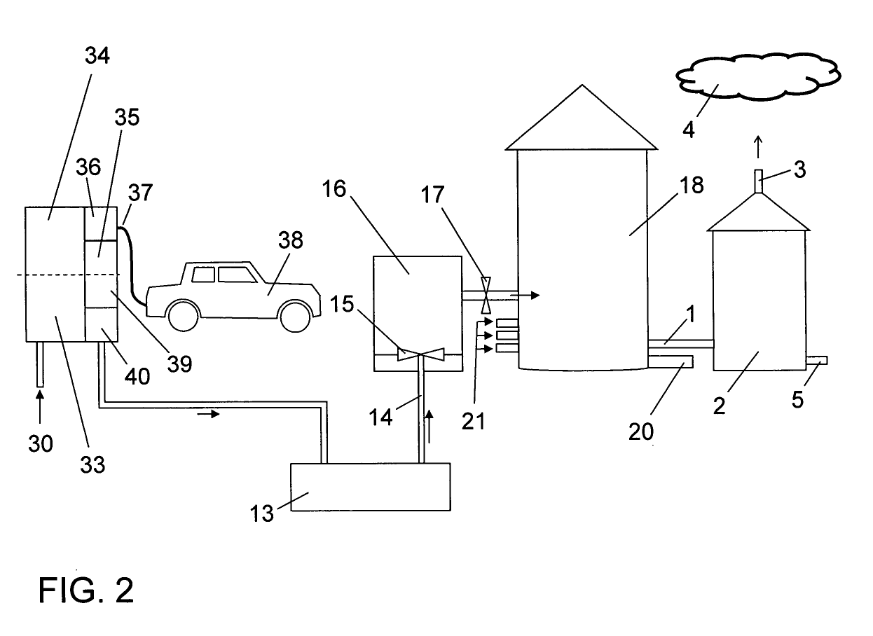

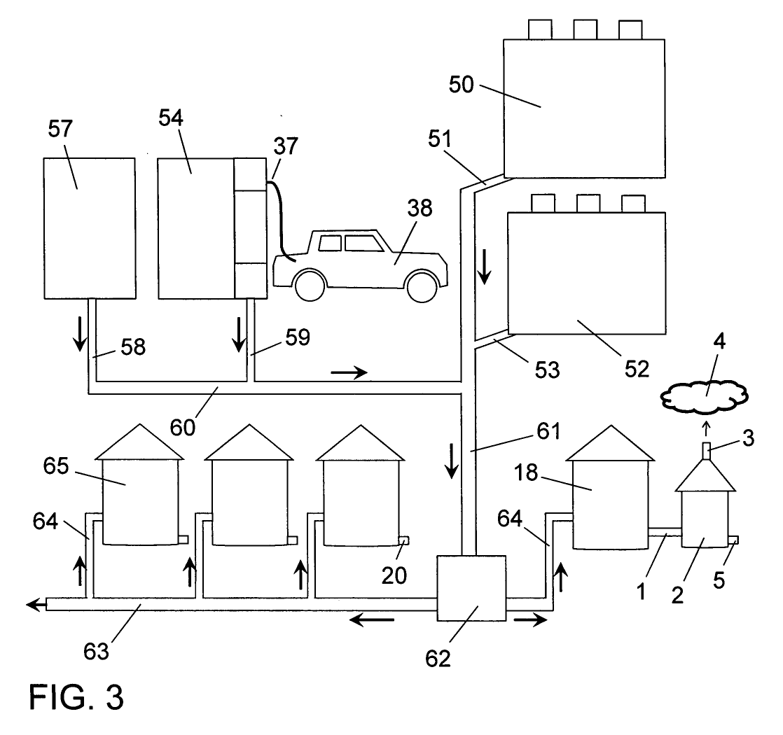

FIG. 2 diagrams an invention system for imparting a substantial negative carbon footprint and an amplified global DMS release (rain-cloud-seeding) profile to transportation. It's the same as FIG. 1, except the concentrated CO₂ source in FIG. 3 is an invention-CCS version of a prior-art natural gas (methane, CH₄) reformation system for making hydrogen (H₂) as a transportation fuel, instead of a CCS gas- or CCS coal-fired electric power plant. FIG. 2 essentially diagrams a second embodiment of Type #1 stage-1 (Ser. No. 13/999,195) invention system used as a prelude to the Ser. No. 13/999,195 invention stage-2 15× amplified ocean capture of FIGS. 4, 5. Using whole-earth carbon accounting, the 2^{nd} two-stage Ser. No. 13/999,195 invention embodiment (FIGS. 2, 4) is capable of imparting a substantial (1400%) negative carbon footprint to transportation.

The figure includes prior-art, Ser. No. 13/999,195 invention, and current CIP invention elements. Items 30-37 comprise a prior art methane reformation system in which natural gas (methane—30) is injected into steam (33, 34) which (in two stages) cracks off the carbon in the prior-art reformation process, leaving a 2^{nd} stage prior-art mixture of CO₂ and H₂. Separation stages (35) isolate the hydrogen for compression (36) and use as a transportation fuel (37) for hydrogen powered vehicles (38) which are illustrated as an automobile in this nonlimiting example. At this point, prior art ends. The Ser. No. 13/999,195 invention segment begins with isolating CO₂ as a compressed gas, liquid, or super-critical fluid (SCF-CO₂, 40).

Ser. No. 13/999,195 invention stage (39) isolates CO₂ as a byproduct of methane reformation, and removes it (40) in the form of compressed CO₂ (not illustrated), liquid CO₂, or supercritical fluid (SCF-CO₂, illustrated—40) in an invention separation stage (39) into purified components H₂ (37) and CO₂ (40). The hydrogen (H₂) may be used to fuel transportation (37, 38) and the CO₂ may be compressed and/or liquefied as super critical fluid (40, SCF-CO₂). The SCF-CO₂ may be stored (13), decompressed (14-17), and converted to salt water algae (18), and continuously harvested (20) for distribution to the next stage (stage-2, operations at sea), exactly as in FIGS. 1, 4, and 5. In stage-2, (FIGS. 4, 5) the harvested silo seed may bloom another factor of 15× at sea. This means that for every 1 ton of CO₂ produced in stage-1 natural gas reformation (to make hydrogen), about 14 more tons of atmospheric CO₂ will be captured by stage-2 at sea. This imparts nominally a 1400% net negative carbon footprint to hydrogen-fueled transportation, using whole-earth carbon accounting. That's important, because hydrogen-fueled transportation would otherwise have a positive carbon footprint (from the CO₂ released by natural gas reformation to initially produce the hydrogen). The dual-stage Ser. No. 13/999,195 invention will enable transportation to become a primary engine for global atmospheric CO₂ reduction. Transportation will thereby become a driver of net carbon sinking instead of carbon sourcing and contribute substantially to the 17 GtC/yr amplified fair-weather contingency capture requirement (see Ser. No. 13/999,195), as well as the 10 GtC/yr impact capture requirement.

The remainder of FIG. 2 (labeled items 1-5) comprise the current invention, which is a C.I.P. of Ser. No. 13/999,195 (hereinafter “CIP—Ser. No. 13/999195”). CIP—Ser. No. 13/999195 elements 1-5 comprise an auxiliary “grazer tank” for rain-cloud seeding, same as FIG. 1.

FIG. 3 is a diagram of stage-1 land-based invention systems including coal-fired CCS power plants (50), gas-fired CCS power plants (52), CCS hydrogen production systems (54, 37) including CCS natural gas reformation, CCS oil gasification, and CCS coal gasification, plus a variety of other anthropogenic, CCS land-based CO₂ sources (57) including CCS cement plants, CCS kilns, CCS blast-furnaces, CCS refineries, CCS factories, CCS incinerators, CCS crematoriums, CCS home and building heating flues, and other CCS sources can all converge their concentrated captured CO₂ (51, 53, 58, 59, 60, 61) into holding reservoirs and/or decompression systems (62) that supply (63, 64) arrays of algae conversion silos (65). That much is invention Ser. No. 13/999,165. The remainder of the drawing (items 1-5 and 18) represent the current CIP invention and comprise an auxiliary “grazer tank” for rain-cloud seeding, same as FIG. 1. It should be noted that algal bioreactors 65 are a large array of bioreactors for algal production only, yielding seed algae to stimulate massively amplified secondary ocean blooming and correspondingly amplified atmospheric CO₂ in FIGS. 4, 5). Algal bioreactor 18 is a single reactor or a smaller number of reactors dedicated to feeding DMS production (3) and rain-cloud formation (4) induced by grazer tanks (2). Live grazer harvest (5) may also be used in FIG. 6.

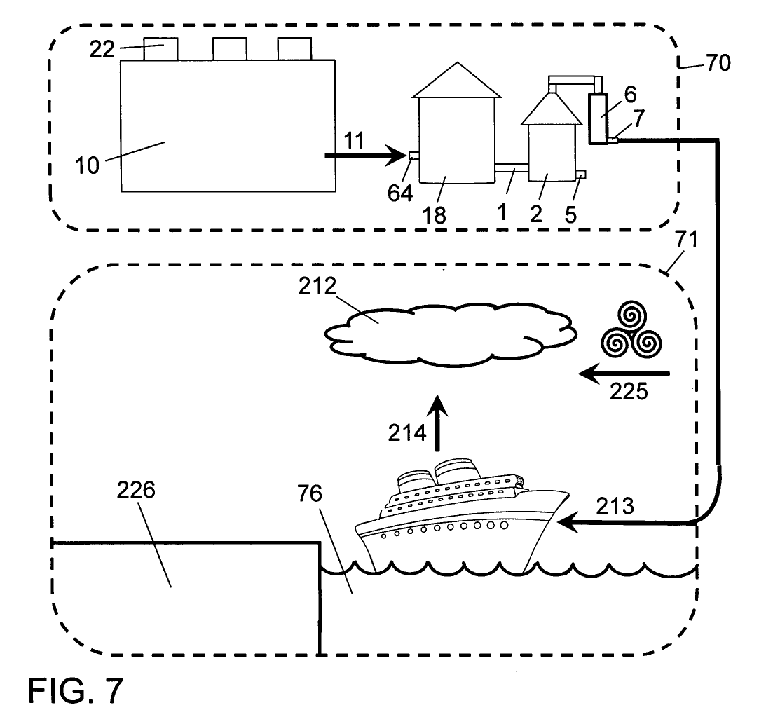

FIG. 4 is a diagram of how invention system stage-1 (70) couples to invention system stage-2 (71), the final ocean-amplified CO₂ capture process. In this two-stage process, fast-sinking (heavier-than-water) marine algae harvested from FIGS. 1-3, 10-12, 14, and 15 land-based algae conversion silos (18, 65, 90) will be put into FIG. 4 stage-2 invention stasis-supporting cargo containers which will be transported to seaports (73), where they'll be loaded onto cargo ships for distributing to floating seed repositories (74) on the open seas. From there, the invention stasis-supporting cargo containers will be transferred to seed boats (75) which fan out to seed 1-3 GtC/yr of algae+nutrient into (8) 70% of Earth's ocean surfaces (76) under exceptional invention system conditions which favor prodigious ocean blooming (and corresponding capture of carbon dioxide (77) from the atmosphere) to the light penetration (opacity) limit within approximately two weeks. This is selective invention-induced stage-2 ocean blooming (71) which is dominated by the invention high-density fast-sinking algae seeded from the invention stasis-supporting cargo containers (73) filled from invention land-based invention stage-1 algae silos (65). Stage-2 ocean starter seed levels (75, 8) will be so high (3 GtC/yr at first, with frequent reseeding) that ocean grazers will only consume a maximum of ⅔ of the invention-produced starter seed (2 GtC/yr estimated global grazer appetites) before it has a chance to bloom. At least ⅓ of the starter seed (˜1 GtC/yr) will remain un-eaten and will be available to seed stage-2 amplified ocean blooming to the opacity limit within two weeks. At this point the invention-supplied nutrient doses are calculated to run out, and the algae bloom will die and rapidly sink (owing to its heavy calcium carbonate exoskeleton). The fast-sinking property will enable the dead algae bloom to clear the photic zone by the end of each month. This key invention-enabled feature will prepare the photic zone for reseeding at the beginning of the next month and it will uniquely enable twelve large blooms per year, instead of just one. By this means, stage-2 invention-amplified ocean algal blooming (71) can capture up to 14 GtC/yr of carbon dioxide which combines with the stage-1 invention land capture rate of up to 3 GtC/yr to create the 17 GtC/yr total invention-enabled carbon capture capacity required (see Ser. No. 13/999,195). At the end of each bloom cycle in FIG. 4, stage-2 invention aerator boats may fan out from the seed repositories, to bubble compressed air or oxygen to within 5 meters of the sea floor in shallow coastal waters. This will prevent post-bloom anoxia from secondary bacterial blooming in coastal waters. In the open seas, rapid sinking should carry the dead algae quickly to the deep sea floor, where frigid water temperatures (between zero and 4 degrees C.) will likely preserve them until they get buried by sedimentation at the rate of about 1 mm/year of marine “snow”. This should prevent post-bloom anoxia from developing. This much is invention Ser. No. 13/999,165. The remainder of the drawing (items 1-7 and 18) represent the current CIP invention and comprise an auxiliary “grazer tank” for rain-cloud seeding, same as FIG. 1, except that, in this embodiment of the CIP invention, condenser (6) has been added to collect and concentrate the DMS at outlet 7 for transport to (and release in) remote drought-stressed regions as in FIGS. 7-9. Live grazers may be harvested at port 5 for transport to sea as in FIG. 6 where grazer introduction (9) in the midst of a seeded (mature) secondary algal bloom produces maximal DMS release (211) to stimulate ocean cloud seeding (212).

FIG. 5 is a graphical projection of results expected from two-stage Ser. No. 13/999,165 invention system amplification. It is a graph of anticipated invention seed & capture rates in GtC/yr (giga-tonnes carbon per year, or billion metric tons carbon per year, as CO₂ (carbon measure)) versus time. Dashed curve (80, 82) is the anticipated ocean seeding rate, in terms of high-density, fast-sinking starter algae seed, which the Ser. No. 13/999,165 invention system will selectively enable. This is nominally 1 GtC/yr (82) from 2023-2075. A front end seeding “bump” (80) of nominally 3 GtC/yr is recommended from 2020-2023, in order to offset ocean grazer feeding appetites. Grazers are anticipated to (globally) eat approximately 2 GtC/yr of the seed, before it has a chance to bloom. Seeding 3 GtC/yr (80) will satiate grazer appetites and leave 1 GtC/yr uneaten to serve as the net amount of available starter seed. By 2023, sufficient ocean blooming is anticipated to allow seed levels to diminish to 1 GtC/yr (82), and by then grazers should be feeding from the amplified bloom (81), rather than the starter seed. (Note: At that time, the extra 2 GtC/yr of available land-harvested seed production capacity may be diverted to other algae applications such as silage, animal feed, fish farming feed, fertilizer, biofuels, and/or inland lake/river revitalization (algal cleansing of agricultural runoff).) Such high level ocean seeding will be invention-system enabled by the land-based algae bioreactors which produce up to 3 GtC/yr of seed from concentrated land-sources.

Curve (81) is the anticipated stage-2 15×-amplified ocean CO₂ capture response enabled by 1 GtC/yr invention ocean seeding (82). Essentially, 14 GtC/yr of amplified natural ocean capture (CO₂) is expected from 1 GtC/yr of invention seeding. Additional accounting for anticipated land-based capture of 3 GtC/yr raises the curve (81) total land-and-sea fair-weather, contingency capture rate to 17 GtC/yr, as required earlier by FIG. 1. This represents the awakening of nature's “green giant” with oceans doing the “heavy lifting” (81) in response to a relatively small invention-enabled seed level (82). A series of sharp spikes on the rising edge of the capture curve (81) represents anticipated transient fluctuations in the amplified capture rate as overpopulated zooplankton grazers devour invention starter seed early in the seed program, and as decimated populations of predators return (re-proliferate) to eat the grazers. As grazer and predator population ratios fluctuate in response to the seeding curve, a series of spikes are expected until the natural balance of grazer and predator is finally restored. (The situation is currently unbalanced with over-populated grazers (copepods, krill, etc.), due to commercial overfishing of their predators.) Once natural balance has been restored (reproliferating decimated and endangered species of marine life and restoring their numbers to burgeoning populations last seen in the 18^{th} and mid-19^{th} centuries), then the capture curve (81) can finally rise to its 17 GtC/yr (land and sea) maximum and be sustained at that level, as long as the seeding program (82) continues. Restoration of marine life populations to mid-19^{th} century levels (or earlier) will be an eventual side-benefit of this invention. The indicated 10 GtC/yr dashed line (210) is the required net annual impact capture, whereas curve 81 is the fair-weather capture rate (17 GtC/yr) which provides a 40% contingency (safety margin to allow for delays, problems, down-time, etc.). A net impact (210) of 10 GtC/yr ocean-amplified CO₂ capture will meet Ser. No. 13/999,195 requirements if combined with best-effort emissions control. It will also provide a significantly amplified DMS release profile that can relieve drought.

FIG. 6 is the same as FIG. 4 with addition of live grazers from harvest port 5 on grazer tank (2) into ocean (9, 76), at the peak of EHUX blooming produced by seeding (8) with algae and nutrient. In FIG. 6, seed and nutrient are initially dispersed (8), and then once the bloom is mature and CO₂ capture is complete (as in FIG. 5), only then are the live grazers added (9). Witholding grazers at first, while seeding (8) allows the bloom to develop fully and capture all of its CO₂ before adding the grazers (9). Grazer attack (9) at the bloom peak yields maximal DMS release (211) which maximally seeds rain-clouds (212) which can be wind-carried on-shore to drought-stressed lands.

FIG. 7 is a variation of the cloud-seeding invention which bypasses ocean algal blooming. In this embodiment, DMS produced on land in grazer tank (2) is condensed (6) and transported as a concentrate to a ship which sails along the windward (225) shores (226) of drought-stressed lands. In this embodiment the only algal bloom occurs in land-based bioreactor 18, which is fed (CO₂) from CCS power plant 10. There is no algal blooming at sea in this embodiment. There is only DMS (concentrate) release (214) directly from the moving ship 313. The DMS (214) rises, photooxidizes to DMSO and that seeds rainclouds 212 at sea.

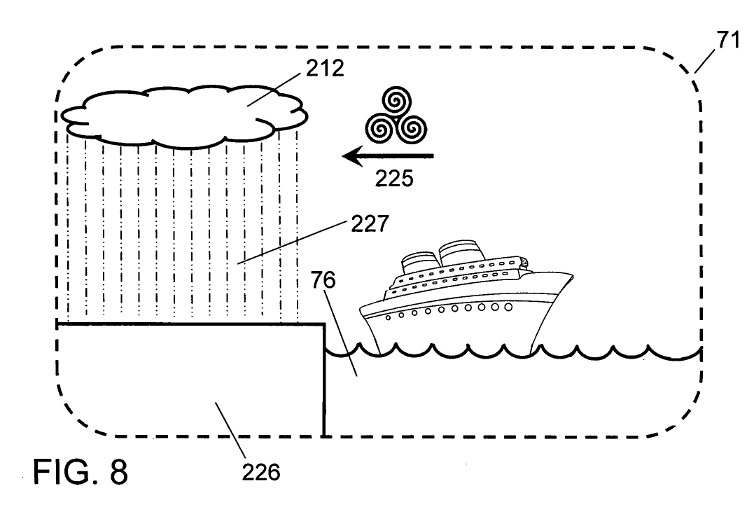

FIG. 8 illustrates the result of FIG. 7 cloud-seeding in which raincloud 212 is pushed on shore (226) by winds 225, and drought-relieving rains (227) result for the otherwise semi-arid, drought-prone land (226).

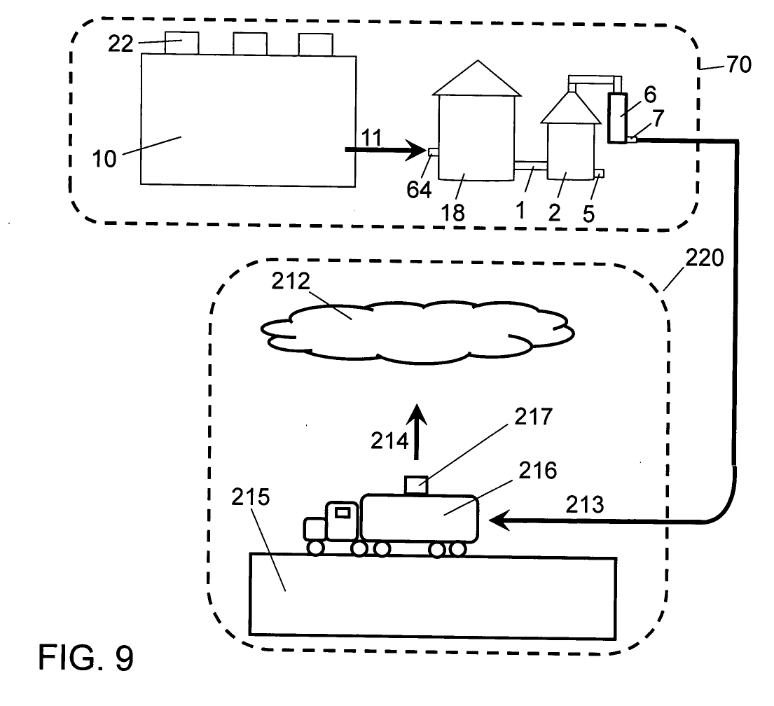

FIG. 9 is the same as FIG. 7, except that, in this embodiment of the invention DMS concentrated at port 7 is transported (213) for remote release (217, 214) further inland from a moving tanker truck (216), to alleviate inland drought considerably further from any sea-shore by directly seeding (217, 214) inland rain clouds (212).

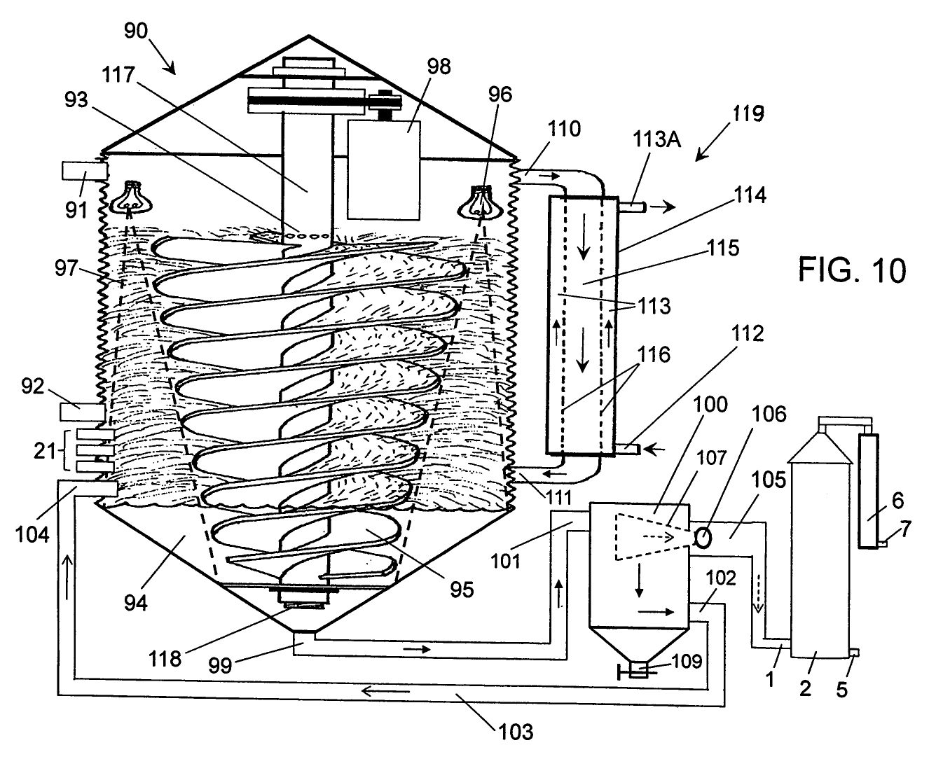

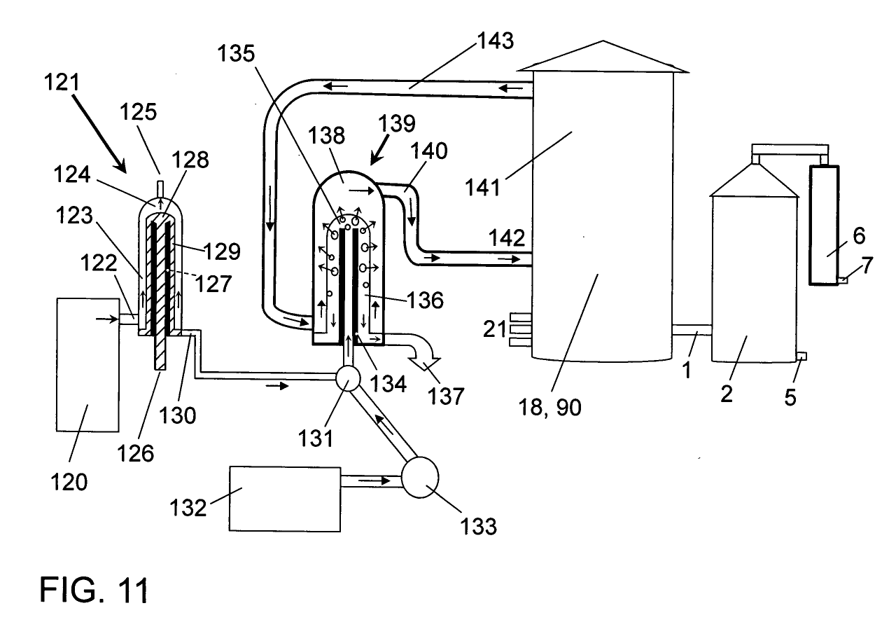

FIG. 10 is a diagram of internal workings of FIGS. 1-4, 6, 7, 9, 11, 12, 14, and 15 invention stage-1 algae conversion silo (18, 65, 90). Concentrated CO₂ enters the silo headspace at inlet 91 or 92 of FIG. 10. For the invention Type #2 (NaOH starter path) and Type #3 (NaHCO₃ starter path) stage-1 embodiments of FIGS. 11-15, port (91) of FIG. 10 is a recirculation port from which silo headspace gases are withdrawn (out-flow) by fan (not shown), cycled through the gas-liquid separators (139) of FIGS. 11, 12, 14, and 15 where they pick up released CO₂ (138) and then the gases (with added CO₂) are returned to the silo headspace at port (92) in FIG. 10. The algae silo headspace is thus “common” to the gas-liquid separator headspaces (138) of FIGS. 11, 12, 14, and 15.

Referring to FIG. 10, the lower extent of rotating auger (95) is immersed in a high-density marine algae suspension (94) which is continuously lifted from the suspension pool (94) by auger (95) which (at 50 rpm in a non-limiting example) slings suspended algae off the edges of the auger blade in thin watery helical fountain sheets throughout most of the silo. Illuminators (96) shining down through the thin helical fountain sheets expose algae to light energy for driving photosynthesis. Light-activated algae seed blooms on exposure to headspace CO₂ which is consumed in the blooming process. The activated helical fountain sheets fall back into pool 94, either falling directly or running down the sides of the silo. Auger 95 then recirculates the suspended algae back through the helical fountain, over and over again, enabling repeated exposure to headspace CO₂. The resulting algal blooming is continuous, occurring at an exceptionally high rate. A smaller auger (not shown) transfers algae out of pool 94 via port 99 as fast as it blooms and injects (101) it into an adjacent separation tank (100).

The separation tank (100) is relatively large diameter to cause a significant reduction in flow velocity at the same flow rate as 101. This velocity reduction is important, because it suddenly offers the tiny algae (e.g. 2 μm in diameter and having flagella for motility in a nonlimiting E. huxleyi example) an opportunity to swim against the current, if they so desire. What is needed next is a reason for the algae to swim against the current so that they will concentrate in the upper end of the separation tank. That impetus is provided by tank (100) and its main downward flow path being dark and essentially devoid of both CO₂ and nutrient, whereas an attractant light beam (beacon 106, 107) is positioned within the mouth of a harvest exit tee (105) located near the upper extent of tank (100). With the main separation tank volume (100) and path (101→102) being essentially devoid of light, and with the flow velocity significantly reduced at large tank diameter, the algae may swim against downward current (101→102)—swimming upward instead toward the attractant beacon (107) and illuminator globe (106) supplied at the mouth of the harvest exit tee (105). The exit tee and harvest exit path (105) are smaller in diameter again and, even though the exit path (105) flow rate is low, this diameter reduction raises flow velocity (relative to path 101→102) enough that any algae which appear at the mouth of the exit tee (106, 105) will be sucked into harvest exit flow path (105). Marine algae may be continuously harvested as ocean seed at the harvest output of the silo. The harvest port (1) of FIG. 10 happens to feed CIP invention elements 2-7 which are the same as FIGS. 4, 6, 7, 11, 12, 14, and 15, in which the algae harvest is fed to grazers in tank 2 in order to produce live grazer harvest at 5 and DMS concentrate at 7). Although not illustrated, it is to be understood that algal harvest port 1 could also be devoted solely to producing seed algae. In that case it would be (or is) labeled port 20 of Ser. No. 13/999,195 on reactors 18 of FIGS. 1, 2 and on reactors 65 of FIGS. 3, 4, & 6. It is to be understood that all bioreactors 18, 90 in FIGS. 10-12 and 14, 15 which only depict a port (1) connection to grazer tank (2) could also have an algal harvest port (20) as illustrated in FIGS. 1, 2 and still be within the scope of invention.

The FIG. 10 bioreactor is continuous, self-concentrating, and will promote prodigious algal blooming at output (port 20 in Ser. No. 13/999,165 and port 1 in CIP embodiments of the invention). About 85% of the algal bloom will continuously exit via the harvest path (105) in a nonlimiting example, with about 15% recirculating via path (102-104). Any dead algae will sink and may be periodically removed at (109). It is to be understood that every bioreactor 18, 90, and 65 in every figure will have a 109 output port for removal of dead algae as illustrated in FIG. 10. The 109 output is only depicted in FIG. 10, but all bioreactors would have such an output port.

A pH buffer (e.g., phosphate buffer, in a nonlimiting example) added (21) to the FIG. 10 algae pool (94), buffers the pool against acidification (carbonation) from high level headspace CO₂. Buffering the pH at nominally 8.32 will maximize coccolithophore algae blooming and prevent softening or acidic dissolution of the coccolithophore exoskeleton (CaCO₃). As algae is continuously harvested (105, 20, 1) as a concentrated suspension, replenishment sea water or salt water, nutrient, and pH buffer are provided at the replenishment inputs (21) to the silo algae pool (94).

Oxygen produced during photosynthesis is continuously removed by an oxygen removal system (119, 110-116) based on at least one oxygen-permeable membrane (116), which is tubular in the nonlimiting FIG. 10 embodiment, and a far-side exhaust sweep gas (113), such as nitrogen (112) in a non-limiting example. A tubular membrane (116) and far-side annular sweep gas space (113) are depicted in this non-limiting example. Only one oxygen removal system (119) is depicted, but multiple units (of 119) mounted on the same silo would also be within the scope of the invention. In this oxygen removal system (119), a fraction of the silo headspace gas would be drawn by fan (not shown) into the removal system at 110 and down through the removal system center (115). Oxygen in the mixture would selectively permeate membranes (116) into a nitrogen sweep gas (113) introduced at 112. The nitrogen sweep gas (113) would remove all of the permeating oxygen and exhaust it at 113A. CO₂ in the mixture would continue down the center (115) and wouldn't permeate the tubular membrane. It would simply rejoin the silo headspace at 111, just above pool 94.

This stage-1 invention bioreactor system (90) may be considered a pseudo-anaerobic bioreactor since oxygen is removed (119) as fast as it is produced by photosynthesis. Algal blooming will therefore proceed under pseudo-anaerobic conditions which will enhance bloom rates, because oxygen otherwise acts as a photosynthetic inhibitor (above a certain point), and its continuous removal (119) will accelerate blooming.

Items 90-119 and 21 are the same as invention Ser. No. 13/999,195 used to produce algal seed at ports (20) of reactors (65) in FIGS. 3, 4, and 6 to seed ocean-amplified secondary blooming and correspondingly amplified capture of atmospheric CO₂. Items 1-7 are the CIP invention add-on to silos 18, to yield DMS production at outputs 3 or 7 and live grazer harvest at output 5, for use in FIGS. 1-3, 6-9, and a CIP add-on to silos 90 in FIGS. 11, 12, 14, and 15.

FIG. 11 is a diagram of Type #2 (NaOH starter path) of a stage-1 Ser. No. 13/999,195 invention configuration involving land-based invention continuous algal conversion of CO₂ from a generic (either invention or prior art) CO₂-laden gas mixture source (120) to high density marine algae as a prelude to the stage-2 15× Ser. No. 13/999,195 invention-amplified ocean capture of FIG. 4. In FIG. 11, Type #2 includes a CO₂-laden gas mixture (120), lye capture path (122-130) with a thin film reactor (121, lye scrubber), sodium bicarbonate as a capture product (130), acidification (131-133), re-release of CO₂ from a bubbling film of salt water (136) as it overflows (135) a standpipe (134) within a gas-liquid separator (139) in which released CO₂ in the separator headspace (135) is swept away to inject a high-efficiency, high-capacity Ser. No. 13/999,195 stage-1 bioreactor (algae conversion silo (18, 90)) with elevated CO₂ levels. Algae harvested at stage-1 bioreactor output (FIG. 4, port 20) may then seed the stage-2 15× amplified ocean capture of additional CO₂ in FIGS. 4, 5. Drawing items 120-143 and 18, 90, and 21 are the same as invention Ser. No. 13/999,165. Items 1-7 are the CIP invention add-on to silos 18, 90, to yield DMS production at outputs 3 or 7 and live grazer harvest at output 5, for use in FIGS. 1-3, 6-9, and a CIP add-on to silos 90 in FIGS. 11, 12, 14, and 15.

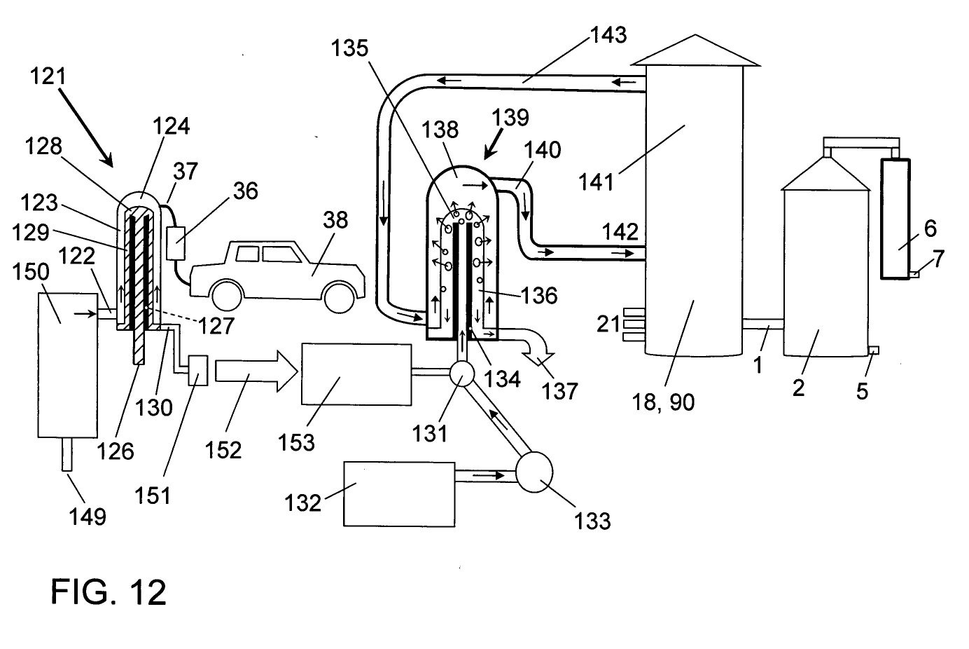

FIG. 12 is a diagram of a Type #2 invention system for imparting a substantial negative carbon footprint to transportation. It is the same as FIG. 11, except that the CO₂-laden gas mixture source in FIG. 12 is a prior-art natural gas (methane, CH₄) reformation system for making hydrogen (H₂) as a transportation fuel. FIG. 12 is diagram of a Type #2 stage-1 Ser. No. 13/999,195 invention system to be used as a prelude to the Ser. No. 13/999,195 invention stage-2 15× amplified ocean capture of FIG. 4. Using whole-earth carbon accounting, the two-stage invention (FIGS. 12, 4) is capable of imparting a substantial (1400%) negative carbon footprint to transportation, with refueling at a home hydrogen production station or a public hydrogen filling station, both of which employ lye capture of reformation process CO₂. FIG. 12 includes prior-art, Ser. No. 13/99,195 invention elements, and the current CIP invention elements. Item 150 comprises a prior art methane reformation system in which natural gas (methane (149)) is injected into steam (150) which cracks off the carbon in a two-stage prior-art reformation process, leaving a final mixture of CO₂ and H₂. At this point (122), prior art ends and the Ser. No. 13/999,165 invention begins with a thin film lye reactor (121, 122-130) for isolating hydrogen (H₂) (37) and compressing it (36) for use as an ultra-clean transportation fuel for hydrogen-powered vehicles (38). A hydrogen powered car is depicted, but that could equally be a van, truck, bus, train, boat, or even an aircraft. FIG. 12 isolates CO₂ as a sodium bicarbonate (NaHCO₃) drain solution (130) collecting in a local pickup vessel (151). The pickup vessel (151) may be periodically transported (152) and emptied into a regional or district NaHCO₃ receiving station (153) where the NaHCO₃ is acidified (131-133) to re-release CO₂ from a bubbling film of salt water (136) as it overflows (135) a standpipe (134) within a gas-liquid separator (139) in which released CO₂ in the separator headspace (138) is swept away for injection into an adjacent Ser. No. 13/999,195 invention high-efficiency, high-capacity stage-1 bioreactor (algae conversion silo (18, 90)) with elevated CO₂ levels with the CO₂ being converted to marine algae, and continuously harvested (port 20 on bioreactors 65, FIG. 4) for distribution to the next stage (stage-2, operations at sea), exactly as in FIG. 4. In stage-2, (FIGS. 4, 5) the harvest silo seed may bloom another factor of 15× at sea. This means that for every 1 ton of CO₂ produced in FIG. 12 stage-1 natural gas reformation (to make hydrogen), about 14 more tons of CO₂ will be captured by stage-2 at sea. This imparts nominally a 1400% net negative carbon footprint to hydrogen-fueled transportation, using whole-earth carbon accounting. That's significant, because hydrogen-fueled transportation would otherwise have a positive carbon footprint (from the CO₂ released by natural gas reformation to initially produce the hydrogen). The two-stage Ser. No. 13/999,195 invention system will enable transportation to become a primary engine for global atmospheric CO₂ reduction. Transportation will thereby become a driver of net carbon sinking instead of carbon sourcing and contribute substantially to the 17 GtC/yr amplified contingency capture requirement of Ser. No. 13/999,165, as well as the 10 GtC/yr impact capture requirement). Drawing items 121-0.143, 150-153, and 18, 90, and 21 are the same as invention Ser. No. 13/999,165. Items 1-7 are the CIP invention add-on to silos 18, to yield DMS production at outputs 3 or 7 and live grazer harvest at output 5, for use in FIGS. 1-3, 6-9, and a CIP add-on to silos 90 in FIGS. 11, 12, 14, and 15.

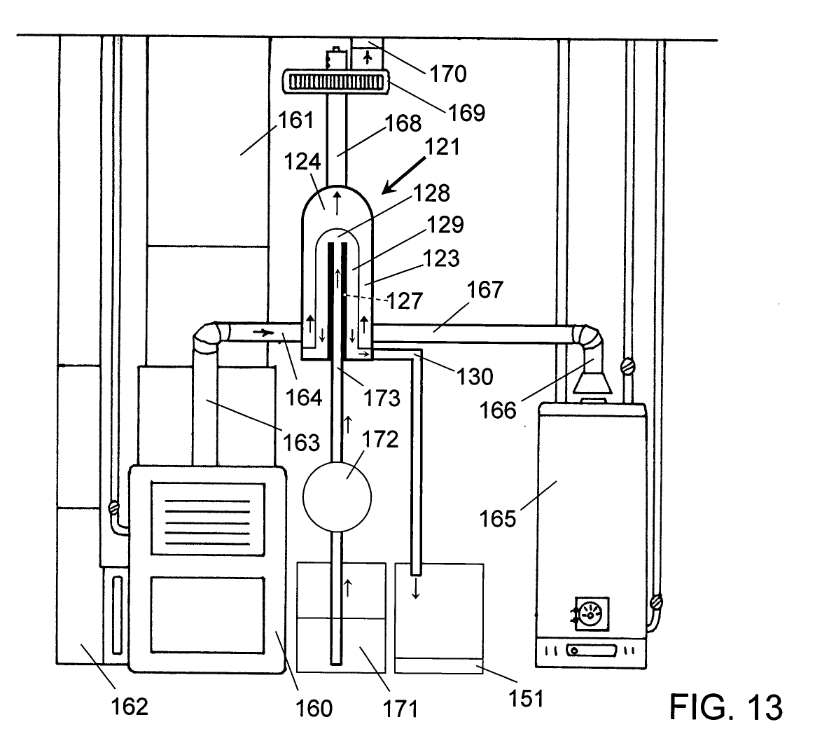

FIG. 13 diagrams another Type #2 stage-1 lye capture path Ser. No. 13/999,165 invention embodiment involving a lye scrubber for home and building flues. Hot exhaust flue gases (163, 166) may optionally be cooled by adding auxiliary cooling air (not shown) prior to tangentially entering (164, 167) a thin film reactor (121) which functions as a lye scrubber. Lye solution (171, 173) is pumped (172) to overflow (128) a standpipe (127) within the reactor (121) so it flows continuously down the outside of the standpipe as a thin film of lye (129) which readily absorbs CO₂ from a rising vortex counter-flow (123) of flue gases encircling the standpipe in the annular space (123) of the reactor (121). The lye film (129) is thereby converted to sodium bicarbonate (NaHCO₃) solution before it reaches the bottom of the reactor and exits via the NaHCO₃ solution drain (130) to collect in pickup vessel 151. Upon filling, this vessel may be transported (152) to the district NaHCO₃ receiving station (153) of FIG. 12 for subsequent algae conversion (20) and FIGS. 4, 5 stage-2 Ser. No. 13/999,195 invention amplified ocean capture of 15× more CO₂ than the original FIG. 13 home and building flues produced. By this means home and building furnaces (160), water heaters (165), etc. may gain a 1400% net negative carbon footprint (whole-earth carbon accounting) and contribute substantially to the 17 GtC/yr amplified contingency capture requirement of Ser. No. 13/999,195 as well as the 10 GtC/yr impact capture requirement. Crematorium and incinerators (not shown) may also use a FIGS. 12, 13 lye scrubber for CO₂ capture, and transport (152) of the NaHCO₃ pickup vessel (151) to the district NaHCO₃ receiving station (153) of FIG. 12, stage-1 algae conversion (18, 90), and FIGS. 4, 5 stage-2 15× amplified ocean capture of additional CO₂. That much is the same as Ser. No. 13/999,195. The CIP invention involves coupling the FIG. 13 CCS home and building heating CO₂ capture system to the FIG. 12 Ser. No. 13/999,195 invention and to the FIG. 12 CIP system (items 1-7) add-ons to silos 18, to yield DMS production at outputs 3 or 7 and live grazer harvest at output 5, for use in FIGS. 1-3, 6-9, and a CIP add-on to silos 90 in FIGS. 11, 12, 14, and 15.

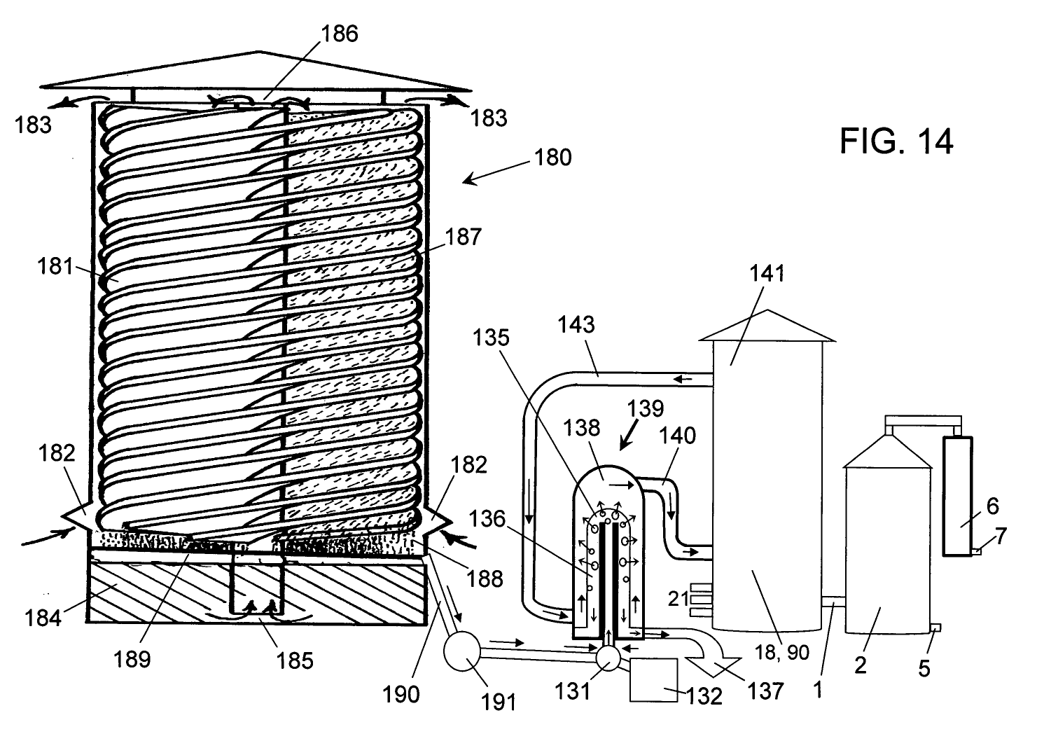

FIG. 14 diagrams an outdoor air embodiment for Type #2 stage-1 CO₂ land-capture capture (180-191) same as Ser. No. 13/999,195, algal conversion (131-141, 21, and 18, 90) same as Ser. No. 13/999,195, and CIP invention DMS production and collection (1-7), and live grazer production (5) with a large lye (NaOH) fountain bin (180) producing NaHCO₃ (190) as the initial CO₂ land-capture product. The Ser. No. 13/999,195 sections of the drawing (180-191, 131-141, 21, and 18, 90) are once again a prelude to the 15× invention-amplified stage-2 Ser. No. 13/999,195 ocean capture of FIGS. 4, 5. In FIG. 14 (Type #2 stage-1 invention Outdoor Air Embodiment) and algae conversion silo (18, 90), the lye fountain bin (180) houses a large, slow-rotating (e.g., 9 rpm in a non-limiting example) air auger (181) which produces a CO₂-laden air-draw at base perimeter inlets (182) and pushes stripped air out via exits (183). The air auger has a hollow drive shaft with its lower extent (185) protruding through a sealed false bottom (189) and immersing in a lye solution (sodium hydroxide, NaOH solution reservoir (184)). The hollow auger driveshaft houses a smaller, higher speed auger (not shown) which uptakes lye (185) and lifts it up through the hollow main air auger shaft, spilling lye out at an outflow (186) at the top of the air auger, spilling over the air auger blades, wetting them and causing a falling film of lye (187) to run continuously, spiraling down the large auger blades. The downward flowing lye film absorbs (scrubs) CO₂ from the rising air column and the resulting NaHCO₃ capture solution spills off the bottom (188) of the auger blades onto the sloping false bottom (189) where it enters the NaHCO₃ drain (190) and proceeds to acidification (131, 132) for re-releasing its CO₂ (138) with subsequent injection (140) into the algae conversion silo (18, 90) as before, for conversion to marine algae for seeding stage-2 ocean amplified capture (FIGS. 4, 5), substituting a FIG. 4, port 20 output with FIG. 4 silos 65 replacing silo 18, 90 and FIG. 4, port 20 replacing FIG. 14, port 1. That much is the same as Ser. No. 13/999,195. The CIP invention involves coupling the FIG. 14 Outdoor ambient air CO₂ capture system to the FIG. 14 CIP system (items 1-7) add-ons to silos 18, to yield DMS production at outputs 3 or 7 and live grazer harvest at output 5, for use in FIGS. 1-3, 6-9.

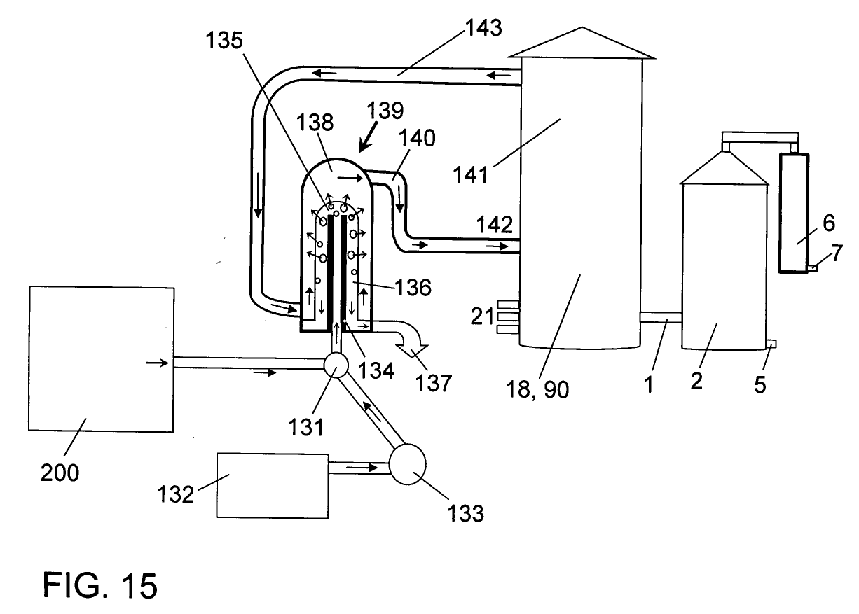

FIG. 15 is a diagram of Type #3 (NaHCO₃ starter path) of a stage-1 Ser. No. 13/999,195 invention configuration involving land-based invention continuous algal conversion of carbonate or bicarbonate solution from a generic (either Ser. No. 13/999,195 invention or prior art) source (200) of bicarbonate or carbonate solution (or a mixture of bicarbonate and carbonate) to high density marine algae as a prelude to the stage-2 15× invention-amplified ocean capture of FIG. 4. FIG. 15 is the same as the 2^{nd} and 3^{rd} sections of FIG. 14 beginning with acidification (131-133) of the NaHCO₃ solution to re-release CO₂ from a bubbling film of salt water as it overflows a standpipe within a gas-liquid separator in which released CO₂ in the separator headspace is swept away to inject an adjacent high-efficiency, high-capacity stage-1 bioreactor (algae conversion silo) with elevated CO₂ levels, to photosynthetically produce an algae harvest output, as before. Algae harvested at the stage-1 bioreactor output (port 20 of FIG. 4 replacing port 1 of FIG. 15) may then seed the stage-2 15× amplified ocean capture of additional CO₂ in FIG. 4. That much is the same as Ser. No. 13/999,195. The CIP invention involves coupling the FIG. 15 generic source CO₂ capture system to the FIG. 15 CIP system (items 1-7) add-ons to silos 18, to yield DMS production at outputs 3 or 7 and live grazer harvest at output 5, for use in FIGS. 1-3, 6-9.

This is a multi-stage invention system comprising a multiplicity of individual stage-1 inventions or an initial prior-art concentrated carbon dioxide source combined with at least one of the individual stage-1 land-based invention capture and algae conversion systems and stage-2 invention process-enhanced ocean-amplified capture, in which all stages (and the FIGS. 3-13 multiple embodiments) comprise multiple, globally-distributed copies of the invention systems to collectively achieve a capture capacity of 17 GtC/yr, accumulating to ˜0.45 tera-ton ((carbon measure) or ˜1.65 tera-tons actual CO₂) of total CO₂ capture and safe storage from 2025-2070, restoring atmospheric CO₂ to its pre-industrial level (280 ppm) by 2075—comprising a fossil-fueled climate restoration invention of U.S. application Ser. No. 13/999,165; and to additionally relieve global drought and famine as a CIP invention of the fossil-fueled climaterestoration (Ser. No. 13/999,165), in which soil moisture retention is enhanced and CIP-invention-induced DMS (dimethylsulfide) cloud-seeding brings rain to semi-arid, drought-stressed lands in the interim period 2025-2070. The multi-stage Ser. No. 13/995,195 fossil-fueled climate restoration systems and CIP drought and famine relief invention systems are presented here in a single patent specification in order to demonstrate how a total capture and storage capacity of 17 GtC/yr (contingency) or 10 GtC/yr (impact), a high DMS release profile, rain-cloud seeding, and soil moisture enhancement may be collectively achieved by a combination of multiple Ser. No. 3/999,195 and CIP invention systems to gradually reverse that portion of global warming which is attributable to CO₂ and to simultaneously eliminate drought and famine. Multiple individual inventions within the multi-stage system are described in individual claims, which are in addition to the multi-stage combination systems and process claims.

Note: In order for multiple, globally-distributed copies of the multi-stage CO₂ capture and storage system to restore the atmosphere to 280 ppm CO₂ by 2075, global emissions need to be capped at 12 GtC/yr by 2023 (Ser. No. 13/999,195) and gradually reduced to 6 GtC/yr by 2050, 3 GtC/yr by 2062, and 1 GtC/yr by 2078, in addition to multi-stage Ser. No. 13/000,195 system contingency capture of 17 GtC/yr CO₂ and 10 GtC/yr impact capture continuously each year from 2025-2070 (or within about 2 years of that interval), and permanent safe storage of the accumulated capture form (˜0.45 tera-tons, carbon measure which is ˜1.65 tera-tons CO₂—converted to marine algae which gets eaten and/or sinks to the bottom of the ocean and gets buried by ocean sedimentation). This global emissions cap and reduction schedule will be achieved, in part, from more diligent and widespread application of certain prior-art technologies and practices such as clean-coal (CCS) and nuclear energy, with smaller contributions from wind and solar energy, energy efficiency and conservation, and in part from re-forestation and sweeping changes in agriculture (especially 3^{rd} world agriculture), agricultural product usage, and the western diet, transportation (e.g. fuel efficient and/or electric cars), travel (increased teleconferencing and reduced business air travel), and commuting practices (living closer to work, increased carpooling, and greater use of mass transit). Items listed in the preceding sentence are all prior-art, with more diligent and widespread application required to contribute substantially to the Ser. No. 13/999,195 global emissions cap and reduction schedule. Ser. No. 13/995,195 targets will also be achieved, in substantial part, by converting a major fraction of transportation to hydrogen (H₂) fueling by about 2050. Hydrogen-powered vehicles already exist in prior-art, such as the Honda FCX-Clarity (a fuel-cell car operating on hydrogen). What doesn't exist in prior art is a significant source of hydrogen fuel (or means of making it), enough to fuel a substantial fraction of all transportation by 2050 without releasing CO₂ in hydrogen production. Prior-art solar energy systems may be used to generate hydrogen by electrolyzing water, but solar energy is only viable where abundant sunshine exists and that excludes most of the industrial world. Prior-art natural-gas (methane) reformation is the primary means of today's hydrogen production, but methane reformation releases CO₂ as a major prior-art byproduct.

In our multi-stage invention, the concentrated CO₂ byproduct of hydrogen production by natural-gas reformation, oil gasification, and/or coal gasification will be converted to high density marine algae in stage-1 invention silos (FIGS. 2 and 12) and that will seed the stage-2 invention system ocean capture and storage (FIGS. 4, 5) of much larger (15× amplified) amounts of atmospheric CO₂—as that is also consumed by prodigious ocean algal blooming stimulated by the invention systems. Hydrogen production which is upstream-enabled by invention systems (FIGS. 2, 12, and 4) will therefore serve triple duty in 1.) contributing significantly to required amplified multi-stage CO₂ ocean capture and storage, plus 2.) reducing CO₂ emissions on the required schedule (as invention system enabled hydrogen production makes it possible for hydrogen to replace fossil-fuel burning in transportation), plus 3.) contributing significantly to DMS production, targeted rain-cloud seeding, soil moisture retention enhancement, and relief of drought and famine.

Note: In some embodiments, portions of the multi-stage invention system may be borrowed from prior-art and from Ser. No. 13/999,195 and then incorporated into a new larger CIP invention system for relieving drought and famine. Prior-art items and Ser. No. 13/999,195 items are not separately claimed in this CIP, and CIP invention claims only involve them as components of a larger invention system and/or of a globally-distributed multi-stage CIP invention combination system, which larger CIP invention system and/or multi-stage CIP combination system is (at once) novel, non-obvious, and desperately needed for simultaneously avoiding impending near term 450 ppm CO₂ tipping points, for restoring 280 ppm CO₂ by 2075, setting the stage for subsequent global warming reversal and the elimination of ocean acidification, and ultimately for eliminating drought and famine. In addition, some portions of the larger CIP invention and/or the multi-stage CIP combination involve device claims and other portions involve process claims. This mixture of device and process claims is required in a single CIP patent application in order to present the case and demonstrate the potential for an overall 17 GtC/yr CO₂ contingency capture and 10 GtC/yr impact capture (Ser. No. 13/999,195), which are both required to offset global emissions anticipated to reach 12 GtC/yr by 2023, thereby enabling the stage to be set for gradual reversal of global warming, and for ocean-amplified DMS production, inland DMS production and release, seeding of ocean cloud-cover to cool and shade oceans, seeding of polar cloud cover to shade and cool polar ice sheets in summer, seeding of rain-clouds in semi-arid drought-stressed lands, and for soil moisture retention enhancement in semi-arid lands.

Stage-1 is land-based capture of 1-3 GtC/yr CO₂ (FIGS. 1-3, and 9-15), its Ser. No. 13/999,195 conversion to high density marine algae—a primary portion of which to be utilized later in stage 2 amplified ocean seeding, a secondary portion of which to be utilized (post-mortem) as organic fertilizer and soil spreads for CIP-enhancing of soil moisture retention, and a tertiary portion of which to undergo further CIP conversion to inland DMS production while simultaneously feeding live ocean grazer cultures in land-based grazer tanks (2), with the live grazer cultures being introduced at the peak of stage 2 amplified ocean blooming to stimulate amplified DMS release at sea. If global warming is to be reversed before 450 ppm CO₂ tipping points are reached, it must be recognized that it won't be possible to capture 1-3 GtC/yr of inland CO₂ by any single means. And yet 3 GtC/yr is the initial inland capture rate required to effectively begin the meeting climate restoration stage-1. The multi-stage invention therefore encompasses a multiplicity of CO₂ initial capture systems in stage-1, including both prior-art and invention stage-1 inland capture systems (FIGS. 1-3 and 9-15), in which captured and concentrated CO₂ from the multiplicity of CO₂ stage-1 inland capture systems is combined (e.g., as in FIG. 3), and the combined total of captured, concentrated CO₂ adds up to the required 3 GtC/yr initial land-based capture to seed the stage-2 ocean amplification that will be required to enable warming reversal. We estimate that 3 GtC/yr also represents the maximum stage-1 CO₂ (land-based) capture which realistically can be mustered from combined global sources and globally scaled and deployed invention CO₂ capture and algal conversion systems prior to ocean amplification.

These multi-stage invention systems relate to global climate change, ocean acidification geo-engineering, more specifically to global climate restoration, ocean revitalization, and fueling ultra-clean transportation with hydrogen (H₂), more specifically yet to drought and famine relief, and finally to primary and secondary global cooling and polar ice stabilization. Climate restoration would be achieved by capturing (Ser. No. 13/999,165) the greenhouse gas carbon dioxide (CO₂) from Earth's atmosphere significantly faster than it is produced, and doing that over an extended period, e.g. from 2025-2075. The recommended collective capture rate by globally distributed copies of our multi-stage invention is 17 GtC of CO₂ per year contingency (fair-weather capture rate) and 10 GtC/yr net impact rate each year from 2025-2070, in order to reduce Earth's atmospheric accumulation of CO₂ to the ideal (pre-industrial) level of 280 ppm (parts-per-million) by 2075.

(Note: The Ser. No. 13/999,195 system 17 GtC/yr contingency capture target, 10 GtC/yr net impact target and Ser. No. 13/999,195 accumulation impact assume global CO₂ emissions would be capped at 12 GtC/yr by 2023 and then reduced to 6 GtC/yr by 2050, 3 GtC/yr by 2062, and 1 GtC/yr by 2075.)

Total multi-stage capture of CO₂ for the period 202-2070 would amount to approximately 0.45 tera-tonnes (450 billion metric tons, carbon measure), which is 1.65 tera-tonnes (actual CO₂ measure), and permanent safe storage for that much captured CO₂ is a further requirement for safely reducing Earth's atmospheric accumulation to 280 ppm CO₂ in the 21^{st} century.

The multi-stage Ser. No. 13/999,165 invention systems relate more specifically yet to selectively amplified ocean algal blooming for large scale (14 GtC/yr) photosynthetic and/or coccolithophore calcification capture of CO₂ by accelerated ocean algal blooming (FIGS. 4, 5), and they relate even more specifically yet to circumventing barriers which otherwise block prior-art systems from successful global acceleration of ocean algal blooming and would prevent ocean capture of more than 1-4 GtC/yr of CO₂. Only the oceans are large enough and powerful enough to capture CO₂ on a scale matching or exceeding current and 2023-projected CO₂ emissions rates (10 GtC/yr and 12 GtC/yr, respectively). It is clear that having ocean algal blooming stalled-out at only 1-4 GtC/yr (or less) won't be a satisfactory capture rate. If climate stabilization and ocean revitalization are to be successful, capture must substantially exceed emissions. There remains a need for circumventing the existing barriers to accelerated ocean algal blooming, thereby allowing stage-2 ocean blooming to capture approximately 14 GtC/yr of CO₂ in addition to stage-1 initial land-based capture of 3 GtC/yr of CO₂, such that the total (land and sea) capture rate can reach 17 GtC/yr of CO₂ (fair-weather contingency basis) or 10 GtC/yr (average net global impact basis). A secondary benefit of Ser. No. 13/999,195 invention-induced stage-2 ocean blooming of the algae species emiliania huxleyi (EHUX) is the brilliant white color of EHUX blooms which is highly reflective to sunlight and can reflect significant fractions of that sunlight back into outer space, thereby yielding an albedo cooling impact to the oceans, which oceans would otherwise absorb that sunlight along with more than 90% of the heat from global warming. The bloom albedo cooling offset of amplified EHUX blooming will provide a significant global cooling impact (which can help promote polar ice stabilization), going well beyond the impact of CO₂ reduction alone. Ser. No. 13/999,195 therefore provides a double benefit in terms of climate restoration. There is a further global economic benefit via Ser. No. 13/999,165 invention-forestalling of impending polar ice collapse that could otherwise raise sea levels by up to 50 feet, submerge coastal cities of the world, and do more than $400 trillion in cumulative climate-induced global economic damage in the 21^{st} century.

The CIP invention systems relate even more specifically to spin-off technology from Ser. No. 13/999,165 which allow spin-off benefits in the realm of amplified DMS release, seeding of ocean cloud cover to shade and cool the oceans (providing yet another secondary cooling benefit to both planetary climate and polar ice stabilization) via cloud albedo cooling, seeding of rain-clouds at sea which are driven inland by onshore winds, and direct seeding of inland rain-clouds for drought and famine relief in semi-arid lands. The CIP invention systems also relate specifically to the production of organic fertilizer and agricultural soil spreads that enhance soil moisture retention in semi-arid lands. The CIP invention improvement of soil moisture retention is almost as important as invention rain-making in semi-arid lands. The overall benefits in meeting U.N.-projected need for a 60% increase in food production by 2050, world-wide famine relief, and significantly boosting the global agricultural economy are expected to be enormous.

Turning now to the drawings, FIG. 1 illustrates a Type #1 CIP invention stage-1, based on an initial supercritical fluid carbon dioxide (SCF-CO₂) capture path and continuous, land-based algae silo conversion of captured SCF-CO₂ to high density, fast sinking marine algae as a prelude to FIG. 4 invention stage-2 15× amplified ocean capture of 1400% more CO₂ (at sea) than was originally input to stage-1. In a preferred embodiment of the FIG. 1 Type #1 invention stage-1 system relating to prior-art clean-coal-fired (CCS, or carbon capture and sequestration) electric power-plants (10) that already capture a significant or majority fraction of their CO₂ emissions as super-critical-fluid (SCF) carbon dioxide (SCF-CO₂, 11) which is prior-art-piped underground (12) into porous rock structures for prior-art storage. The FIG. 1 Type #1, stage-1 system also relates to prior-art CCS gas-fired or combination (CCS coal-and-gas-fired) power plants (10) which capture a significant or majority fraction of their CO₂ emissions as SCF-CO₂ (11) which is piped underground (12) into porous rock structures for prior-art storage. Our FIG. 1 invention stage-1 will consider the prior-art-captured power-plant SCF-CO₂ (or liquid CO₂) as a major Type #1 prior-art contributor to stage-1 of an invention multi-stage system, in which the SCF-CO₂ (11) or the liquid CO₂ captured from the CCS coal-fired and/or CCS gas-fired electric power plants (10) is diverted from prior-art underground porous rock storage (12) to an above-ground invention stage-1 series (19) of multiple invention bioreactors (18), where the SCF-CO₂ or the liquid CO₂ is decompressed (14-17) and rapidly converted by invention-accelerated photosynthesis in bioreactors (18) to a particular form of high-density, heavier-than-water, fast-sinking marine seed algae at the collective (globally distributed) invention stage-1 rate of up to 3 GtC/yr of land-harvested salt-water algae (20). Details of one nonlimiting embodiment of the bioreactor which is an algae conversion silo (18) are given in FIG. 10. Examples of the high-density, fast-sinking marine seed algae produced (20) by the stage-1 invention bioreactors (18) would be coccolithophore (e.g., Emiliania huxleyi) or siliceous diatoms which are types of marine algae that are heavier-than-water, owing to a calcium carbonate or siliceous exoskeleton imparting specific gravity exceeding that of water to the algae. FIG. 4 illustrates that the up to 3 GtC/yr of stage-1 invention bioreactor seed algae (land harvest (FIGS. 1-3) of coccolithophore or siliceous diatom algae) may then be transported (FIG. 4) to sea-ports and widely dispersed (with micronutrients) at sea in stage-2 of our invention system to seed accelerated (much larger) ocean algal blooms of 14 GtC/yr, thereby imparting a substantially negative carbon footprint to stage-1 CCS coal-fired, CCS gas-fired, and/or combination CCS coal-and-gas-fired power-plants (FIG. 1, items 10), using whole-earth carbon accounting. When combined with the up to 3 GtC/yr of land-harvested invention bioreactor (18, 65) seed (20), the FIGS. 4, 5 stage-2, 14 GtC/yr amplified ocean algal blooming will bring the total (land and sea) “fair-weather” algal blooming rate to 17 GtC/yr, with that much CO₂ being captured as the combined algae bloom in the FIGS. 1-3 and 10-15 stage-1 invention bioreactors (18, 65, 90) and at sea (FIGS. 4, 5). The large negative carbon footprint arises in that up to 14 GtC/yr of CO₂ capture by the FIGS. 4, 5 stage-2 amplified ocean algal blooming was seeded by a fraction of the 1-3 GtC/yr of stage-1 land harvested seed algae (20) produced, in part (FIG. 1 and FIG. 5 (82)), from the stage-1 CO₂ captured from the CCS coal-fired and/or CCS gas-fired power-plants (10). Triggered with stage-1 invention seed (1-3 GtC/yr) under invention-optimized conditions, nature will provide stage-2 ocean amplification and do the heavy lifting (14 GtC/yr) of extra CO₂ capture indicated in FIGS. 4, 5. That much is attributable to the Ser. No. 18/999,195 portion (10-20 (FIG. 1) and 8, 65-79 (FIG. 4)) of the invention.

In the CIP portion of FIG. 1 marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

Further yet, FIG. 2 illustrates another embodiment of the Type #1 CIP invention stage-1 which is an Ser. No. 13/999,195 embodiment for making hydrogen (H₂) transportation fuel and a CIP invention spinoff for inland DMS production (2) and release (3) for rain-cloud (4) seeding, as well as the production of soil spreads for moisture retention. FIG. 2 relates to prior-art natural-gas reformation conversion (33-37) of methane (30, CH₄) to H₂ (37), suitable for fueling hydrogen-powered vehicles (automobiles (38), vans, buses, trucks, planes, trains, boats, ships, etc.), in which an optimized combination natural-gas reformation process for hydrogen production (37) involves invention capture (39) of process byproduct CO₂ as SCF-CO₂ (40) or liquid CO₂ in a second Type #1 stage-1 Ser. No. 13/999,195 invention embodiment (30-40) and imparts a substantial 1400% negative carbon footprint to natural-gas reformation hydrogen production by transferring the captured second Type #1 embodiment stage-1 natural-gas reformation process byproduct CO₂ to at least one (or multiple) invention bioreactors (18) where the reformation process byproduct CO₂ is rapidly converted by bioreactor (18) accelerated photosynthesis and/or coccolithogenesis (calcification) to the desired form of high-density marine seed algae (20) at a rate contributing substantially to the stage-1 land-harvest (20)—up to 3 GtC/yr total, the substantially (e.g., 1400% in a non-limiting example) negative carbon footprint being imparted to the natural-gas production of hydrogen (37) by the up to 3 GtC/yr of the stage-2 bioreactor seed algae being transported to sea-ports (FIG. 4) and widely dispersed (with micronutrients) at sea (FIG. 4) to seed the stage-2 accelerated ocean algal blooms of 14 GtC/yr (17 GtC/yr total land and sea CO₂ capture). The 1400% negative carbon footprint (whole-earth carbon accounting) arises in that up to 14 GtC/yr of CO₂ capture by the stage-2 amplified ocean algal blooming (FIG. 4) was seeded by a fraction of the 1-3 GtC/yr of land-harvested seed algae (FIG. 5, item 82) produced (in part) from the stage-1 natural-gas reformation process byproduct CO₂ (40). That much is attributable to the Ser. No. 18/999,195 portion (13-40 (FIG. 2) and 8, 65-79 (FIG. 4)) of the invention.

In the CIP portion of FIG. 2 marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

Further yet, the Ser. No. 13/999,195 multi-stage system relates to cement production in which an optimized Type #1 stage-1 invention captures cement production byproduct CO₂ as SCF-CO₂ or liquid CO₂ in a third embodiment (not shown) and imparts a negative carbon footprint to the cement production by transferring captured cement production byproduct CO₂ to the multiple invention bioreactors (18) where it is rapidly converted by the bioreactor accelerated photosynthesis and/or coccolithogenesis to the desired form of marine seed algae at a rate contributing substantially to the stage-1 land-harvest (up to 3 GtC/yr total), the substantially negative carbon footprint being imparted to the cement production by the up to 3 GtC/yr of the stage-1 invention bioreactor seed algae being transported to sea-ports (FIG. 4) and widely dispersed (with micronutrients) at sea to seed the FIG. 4 stage-2 accelerated ocean algal blooms of 14 GtC/yr. The negative carbon footprint (whole-earth carbon accounting) arises in that up to 14 GtC/yr of CO₂ capture by the stage-2 amplified ocean algal blooming was seeded by a fraction of the 1-3 GtC/yr stage-1 land harvest seed algae (FIG. 5, item 82) produced (in part) from cement production byproduct CO₂. That much is attributable to the Ser. No. 18/999,195 portion of the cement-production invention.

In the CIP portion of the cement production invention, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

The multi-stage invention system further relates to capture of CO₂ from outdoor air, building flues, incinerators, crematoriums, kilns, blast-furnaces, refineries, factories, cement plants, power plants, natural-gas reformation systems, oil gasification systems and/or coal gasification systems in which additional invention Type #2 stage-1 embodiments are based on sodium hydroxide (NaOH, caustic soda, lye) capture of CO₂ from CO₂-laden gas mixtures as in FIGS. 11-14 or in which Type #3 stage-1 embodiments are based on an alkali bicarbonate or alkali carbonate or alkaline-earth carbonate solution starting point as in FIG. 15, the initial invention Type #2 or Type #3 embodiment stage-1 sodium bicarbonate, carbonate, or other alkali bicarbonate, carbonate, or alkaline earth carbonate solution being transferred to invention enclosed acidification chambers where CO₂ is released or re-released to one or more invention bioreactors (18, 65, 90) where it (CO₂) is rapidly converted by invention-accelerated photosynthesis and/or coccolithogenesis (calcification) to the desired form of high-density marine seed algae at a rate contributing substantially to the stage-1 land-harvest (up to 3 GtC/yr total), and in which a substantially negative carbon footprint is imparted to the outdoor air, building flue, incinerator, crematorium, kiln, blast-furnace, refinery, factory, cement plant, power plant, natural gas reformation system, oil gasification system, or coal gasification system by the up to 3 GtC/yr of the stage-1 invention bioreactor seed algae being transported (FIG. 6) to sea-ports and widely dispersed (with micronutrients) at sea to seed the FIGS. 4, 5 stage-2 accelerated (much larger) ocean algal blooms of 14 GtC/yr. The negative carbon footprint (whole-earth carbon accounting) arises in that up to 14 GtC/yr of CO₂ capture by the stage-2 amplified ocean algal blooming was seeded by a fraction of the 1-3 GtC/yr of the stage-1 land harvest seed algae produced (in part) from the Type #2 or Type #3 additional embodiment invention system stage-1 CO₂ captured from the outdoor air, building flues, incinerators, crematoriums, kilns, blast-furnaces, refineries, factories, cement plants, power plants, natural-gas reformation systems, oil gasification systems, or coal gasification systems. That much is attributable to the Ser. No. 18/999,195 portion of the sodium hydroxide capture (FIGS. 11-14) or alkali bicarbonate and alkaline-earth carbonate solution invention (FIG. 15) starting points.

In the CIP portion of the sodium hydroxide capture or carbonate solution starting point inventions of FIGS. 11-15, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

In Type #2 embodiments of the multi-stage naturally amplified global scale carbon dioxide capture system, FIG. 11 illustrates that carbon dioxide separation and concentration may be achieved by invention reaction of CO₂-laden gas mixtures (120, 122) with sodium hydroxide (NaOH, caustic soda, lye (126-129)) in a thin film reactor (121) which functions as a lye scrubber, so that the CO₂ is captured by the downward flowing lye film (129) as sodium bicarbonate solution (130) which is then drained (130) and the CO₂ re-released by subsequent invention closed-system (139) acidification (131-133) of the bicarbonate solution (130) and injection of the re-released carbon dioxide (138, 140, 142) into the invention stage-1 bioreactors (algae conversion silos (18, 90)) where it feeds algal blooming to produce the stage-1 seed (20) for stage 2 ocean-amplified blooming (FIGS. 4, 5). One preferred embodiment of the FIG. 11 Type #2 land-based algal conversion—lye capture path for CO₂ is illustrated in FIG. 12 which is a home or filling station embodiment of hydrogen production (37) by methane reformation. This preferred embodiment captures CO₂ from the methane reformation process (150) in a thin film reactor (121) exposing the reformation gas mixture (122, 123) to a downward flowing lye film (129), capturing the spent reaction product bicarbonate solution (130), and storing it in a pickup vessel (151) for later transport to a district receiving station (162) which feeds the same acidification (131-133) and closed-system CO₂ re-release chamber (139) and land-based algae conversion silo (18, 90) as before. This embodiment also couples its silo algae output (20) to stage-2 (FIGS. 4, 5) for 15× ocean amplification as before. By this means, the FIGS. 12, 4 multi-stage invention imparts home or filling station hydrogen fueling of transportation with a 1400% negative carbon footprint, using whole earth carbon accounting. As in the case of FIG. 11, the FIG. 12 embodiment (with FIG. 4 ocean amplification) will contribute to amplified CO₂ capture (Ser. No. 13/999,195), but the invention boost to globalization of hydrogen-powered transportation will also lower emissions, contributing strongly to emissions reduction. That much is attributable to the Ser. No. 18/999,195 portion of the FIGS. 11, 12 inventions.

In the CIP portion of the inventions of FIGS. 11, 12, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

Other preferred embodiments of the FIGS. 11 and 12 land-based algal conversion type #2 (lye capture path) invention are illustrated in FIG. 13, which is a lye scrubber for home and building flues. It would work equally well for incinerators and crematoriums (not shown). It is once again based on exposing CO₂-laden flue gases (163, 166) in a rising vortex counter-flow (123) to a downward flowing lye film (129) produced by lye overflowing (128) a standpipe (127) contained within in a thin film reactor (121). If needed, auxiliary cooling air may optionally be mixed in with the hot flue gases (163, 166) prior to tangentially entering the thin film reactor (164, 167). The lye film (129) flowing down the outside of the standpipe (127) absorbs CO₂ from the rising vortex counter-flow of flue gases (123), converting the CO₂ to bicarbonate solution which then drains out of the reactor at 130. Stripped air (124) exits the thin film reactor at 168 and continues in the flue exhaust (170). If needed, flue gases may be pulled through the thin film reactor (121) with an exhaust fan (169) pulling on the stripped air (168) outlet. The bicarbonate collection vessel (151) of FIG. 13 may be considered a district pickup vessel like the pickup vessel (151) in FIG. 12 to be delivered to the district acidification system (131-140) and algae conversion silos (18, 90) of FIG. 12, and the silo output (port 20, as in FIG. 4) may be further amplified by stage-2 operations at sea (FIGS. 4, 5). This system will impart 15× ocean amplification to land-based CO₂ capture from home and building flues, incinerators, and crematoriums, along with a 1400% negative carbon footprint, using whole earth carbon accounting. That amplified CO₂ capture will contribute strongly to capture curve 81 of FIG. 5, but there is also a flue-based emission reduction to be credited, which in turn contributes strongly to emission reduction. That much is attributable to the Ser. No. 18/999,195 portion of the FIGS. 11, 12 inventions.

In the CIP portion of the inventions of FIGS. 11, 12, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

One preferred embodiment of Type #2 land-based algal conversion is illustrated in FIG. 14 which is an outdoor air embodiment of Type #2 invention system CO₂ capture. It features a large scale invention bin (180) which houses a lye fountain through which large amounts of outdoor air are drawn. Air enters the lye fountain bin (180) through perimeter air intakes (182) around the base of the bin. The lye fountain is actually a flowing lye film (187) which absorbs CO₂ from the air to form sodium bicarbonate solution which exits spill-off drain (190), and enters the remainder of the Type #2 stage-1 invention system as in FIG. 11, 12, followed by substantial stage-2 capture amplification at sea (FIGS. 4, 5).

FIG. 14 shows one algae conversion silo (18, 90), but a cluster (not shown) may be envisioned in which each lye fountain bin (180) is surrounded by four algae conversion silos (18, 90) in a non-limiting example. Remediation parks containing, e.g. 48 of these clusters may be envisioned in a non-limiting example of high capacity outdoor air capture. Global proliferation of such remediation parks, perhaps as many as 20,000-200,000 parks in a non-limiting example and coupling of these parks to stage-2 invention ocean amplification (FIGS. 4, 5) will contribute to the Ser. No. 13/999,195 capture goal of 17 GtC/yr fair-weather contingency capture (curve 81—FIG. 5) and 10 GtC/yr impact capture (FIG. 5, item 210).

In FIG. 14, the lye fountain bin (180) houses a large, slow-rotating (e.g. ˜9 rpm in a non-limiting example—overhead motor not shown) air auger (181) which draws CO₂-laden air into the bin at perimeter intakes (182) located around the base of the bin. The auger (181) pushes air spirally up through the bin where it exhausts at the stripped-air exits (183). The air auger (181) drive shaft is hollow in a preferred embodiment. In one preferred non-limiting embodiment, the hollow shaft houses a smaller, higher speed auger (not shown) which draws lye solution from reservoir (184) into the hollow shaft (185) and propels it internally to the top where it spills out onto the upper extent of the large slow-moving air-auger blades (186). The lye solution spreads over the auger blades covering them with a lye film (187) of high surface area which runs down the blades in a film, flowing counter to the rising air column being pushed upward by the blades. Gravity draws the lye film (187) downward over the blades as blade rotation pushes the air upward. This is an efficient, high surface area film reactor in which the rising spiral flow of air interacts with the downward spiral (film) counter-flow (187) of lye solution. The downward flowing lye film (187) absorbs CO₂ from the air as it passes spirally upward through the bin and the lye film may be quantitatively converted to sodium bicarbonate solution which spills off the bottom of the auger blades at 188, hits a sloping false bottom (189) in the bin, and exits via the indicated sodium bicarbonate (NaHCO₃) drain (190). From there, the sodium bicarbonate enters the remainder of the stage-1 invention algal conversion system as in FIGS. 11, 12, followed by substantial stage-2 capture amplification at sea (FIGS. 4, 5). That much is attributable to the Ser. No. 18/999,195 portion of the FIG. 14 invention.

In the CIP portion of the invention of FIG. 14, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

In Type #3 (NaHCO₃ starter) embodiments of the multi-stage naturally amplified global scale carbon dioxide invention capture system, FIG. 15 illustrates that any generic source of carbonate or bicarbonate solution resulting from CO₂ capture may be processed by subsequent invention closed-system acidification of the bicarbonate solution and infusion of the re-released carbon dioxide into the headspace of invention stage-1 bioreactors (algae conversion silos) where it feeds algal blooming to produce the stage-1 seed for stage-2 ocean-amplified blooming (FIGS. 4, 5). That much is attributable to the Ser. No. 18/999,195 portion of the FIG. 15 invention.

In the CIP portion of the inventions of FIG. 15, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

Further yet, the multi-stage invention system relates to capture of CO₂ from outdoor air, building flues, incinerators, crematoriums, kilns, blast-furnaces, refineries, factories, cement plants, power plants, natural-gas reformation systems, oil gasification systems, or coal gasification systems, in which a final group of invention stage-1 embodiments are based on any means of CO₂ capture (including prior-art stage-1 capture means with invention diversion of captured CO₂ to invention stage-1 holding stations or reservoirs or invention stage-1 processing stations) in which the any means of CO₂ capture yields relatively concentrated CO₂ as a gas, liquid, super-critical fluid, carbonate solution, or bicarbonate solution, and in which the final-group invention multi-stage embodiments impart a negative carbon footprint to the outdoor air, building flue, incinerator, crematorium, kilns, blast-furnaces, refineries, factories, cement plants, power plants, natural-gas reformation systems, oil gasification systems, or coal gasification systems by transferring the captured final-group embodiment stage-1 outdoor air, building flue, incinerator, crematorium, kiln, blast-furnace, refinery, factory, cement plant, power plant, natural-gas reformation system, oil gasification system, or coal gasification system, relatively concentrated CO₂ to the multiple invention acidification sections and/or bioreactors (18, 65, 90) of FIGS. 1-3 and FIGS. 10-15 where the transferred CO₂ is rapidly converted by the invention accelerated photosynthesis and/or coccolithogenesis (calcification) to the desired form of high-density marine seed algae at a rate contributing substantially to the (e.g., FIG. 3) stage-1 land-harvest (up to 3 GtC/yr total), and a substantially negative carbon footprint being imparted to the outdoor air, building flues, incinerators, crematoriums, kilns, blast-furnaces, refineries, factories, cement plants, power plants, natural-gas reformation systems, oil gasification systems, or coal gasification systems by the up to 3 GtC/yr of the stage-1 invention bioreactor seed algae being transported to sea-ports (FIG. 4) and widely dispersed (with micronutrients) at sea to seed the stage-2 accelerated (much larger) ocean algal blooms of 14 GtC/yr. The negative carbon footprint (whole-earth carbon accounting) arises in that up to 14 GtC/yr of CO₂ capture by the stage-2 amplified ocean algal blooming was seeded by a fraction of the stage-1 land harvest seed algae produced in part from the final-group embodiment stage-1 CO₂ captured from the outdoor air, building flues, incinerators, crematoriums, kilns, blast-furnaces, refineries, factories, cement plants, power plants, natural-gas reformation systems, oil gasification systems, or coal gasification systems. That much is attributable to the Ser. No. 18/999,195 portion of the FIGS. 1-3 and 10-15 inventions.

In the CIP portion of the inventions of FIGS. 1-3 and 10-15, marine algae produced by bioreactor 18 is introduced (1) into tank (2) which contains a culture of live marine grazers that eat the marine algae. Voracious grazer attack causes the marine algae to release prodigious quantities of DMS, which is volatile and rises in tank (2), to exit at port (3), further rising in the atmosphere and photo-oxidizing to form DMSO which seeds rain-clouds (4). Live ocean grazer harvest may be taken at output 5. Excess algae and grazer harvests (20, 5, and/or detritus (dead) or waste organic material outputs (not shown—see FIG. 10 output 109) from both tanks 18, 2) may be used as organic fertilizer and/or agricultural soil spreads to increase soil moisture retention in semi-arid lands.

Stage-1 land-based CO₂ capture includes arrays of at least one high capacity invention algae bioreactor (FIGS. 1-3 and FIGS. 11, 12, 14, 15, items (18, 65, 90)) to continuously convert relatively concentrated CO₂ from prior-art and/or invention preliminary capture system(s) to high density, fast-sinking, marine algae on land, essentially as fast as the preliminary capture systems capture CO₂. This will require acceleration of photosynthesis and/or coccolithogenesis (calcification) in the at least one high capacity invention algae bioreactor (18, 65, 90).

Referring to FIG. 10 in a nonlimiting example, the acceleration of photosynthesis in the at least one high capacity invention algae bioreactor (90) will be due in part to the high concentration of CO₂ introduced (91, 92) into the stage-1 bioreactor headspace. In comparison to today's ambient CO₂ level of 400 ppm (0.04%), the stage-1 bioreactor (algae conversion silo) headspace will be infused with sufficient CO₂ to maximize algal blooming rates. This could be up to 100% CO₂ in a non-limiting example, but the optimal amount will likely be lower than that, and in any case it will be easily adjustable to optimized intermediate levels (e.g. 1%-50% CO₂ in non-limiting examples) to maximize the algal blooming rate at any selected seed, nutrient, light level, and illumination wavelength at a given bioreactor operating temperature, while minimizing acidification (carbonation) of the pH-buffered algae pool (94). To prevent or substantially offset carbonation by the high concentration of headspace CO₂ acidifying the algae pool (94, dissolving or softening coccolithophore calcareous exoskeletal coccolith plates), the pool will be buffered at approximately pH 8.2 in a non-limiting example. In this non-limiting example, pH buffering at pH 8.2 will achieved by adding a solution mixture of disodium phosphate and monosodium phosphate in a mole ratio of approximately thirteen-to-one, respectively, and in which the phosphate buffering components also double as photosynthesis micronutrients to support algal blooming. If phosphate depleted nutrients are desired to alleviate phosphate supply shortages and/or to further enhance species-selective bloom dominance in stage-2 ocean blooming, then buffer mixtures other than phosphate salts (e.g., a borate buffer system, in a nonlimiting example) would have to be substituted, or alternatively, the algae harvest (105 in FIG. 10, or 20 in FIGS. 3, 4) may be filtered and replaced with phosphate-free nutrient (e.g. ammonium/and or nitrate nutrient), with the phosphate filtrate being returned to bioreactor 90.

Photosynthetic and/or coccolithogenic (calcification) acceleration (accelerated algal blooming) will be due in further part to exceptionally high seed levels of the coccolithophore or siliceous diatom algae introduced into the invention bioreactor algae pool (94), the seed levels for constant blooming in the invention bioreactor being unusually high—up to 15% solids (by weight) in a non-limiting example, and this will radically accelerate blooming by continuously operating the bioreactor exceptionally high on the (upward-bending) nonlinear growth curve. Normally, this solids level would exceed optical opacity limits and photosynthesis could not proceed, owing to lack of light penetration, however a novel invention optical thinning effect (see below) will circumvent prior-art opacity limits.

In FIG. 10, unusually high seed levels in the algae pool (94) will be enabled by an invention optical thinning effect produced by the vertical rotary auger (95) which lifts algae suspension continuously out of the pool and slings it off the edges of the auger blades continuously throughout most of the height of the bioreactor, creating an inter-twined helical sheet fountain of algae suspension. The sheets of algae suspension slinging continuously off the exposed (non-submerged) edges of the auger blade (95) will be thin fountain sheets and will produce an optical thinning effect which allows overhead light (96) penetration to a degree far exceeding that of the concentrated algae pool (94) below. Light penetration through the optically thinned fountain sheets will activate photosynthesis in the seed algae, activating it as it falls back into the pool or hits the side wall of the reactor and runs down into the pool, where the auger lifts it and slings it in sheets, over and over again. With the optically-thinned fountain sheets, exposed surface area of the seed suspension is exceptionally high and light penetration into (and through) the thin fountain sheets will be exceptionally good, driving prodigious algal bloom rates continuously and permitting much higher % solids levels to develop, well beyond that otherwise permitted by the opacity of the pool (94) below. This will allow much higher seed levels and also much higher harvest bloom levels than could otherwise be achieved in a pool reactor (94) alone. 15% seed levels will become feasible in this invention. That is very high on the nonlinear growth curve and it will drive prodigious blooming as a result. Mechanical shear from the auger blades will prevent colonization from occurring and it will keep the algae suspension free-flowing (non-agglomerated), despite the high solids level (15% in a non-limiting example) in the suspension and despite prodigious bloom rates.

A second smaller transfer auger (not shown) will be turned on and operated to continuously remove algae suspension from the bioreactor as fast as it blooms (in excess of 15% solids). In one non-limiting embodiment, the funnel shaped silo floor would enable excess bloom removal at outlet 99. The concept here is that high seed levels (15% solids) drive very high bloom rates, but outlet 99 removal of excess bloom from the bioreactor occurs as fast as it develops, leaving a constant seed level of 15% solids behind in the reactor. This is a continuous reactor which doesn't require reseeding, once the solids level reaches 15% and the transfer auger (not shown) is turned on to keep it from going higher by continuously removing excess bloom at 99. As excess bloom is removed from the bioreactor (99), water, buffer, and nutrient are continuously replenished (21), but no new algae seed is required—enough seed remains behind from the bloom, if the transfer auger removal rate (99) is balanced exactly at the bloom level and it isn't turned on until the bloom level first reaches 15%. The transfer auger then removes excess bloom continuously (as fast as it develops), without diminishing the 15% solids level, which then becomes the continuous seed level.

The transfer auger removes 15% algae suspension to an adjacent separation tank (100). The separation tank (100) is relatively large diameter to cause a significant reduction in flow velocity at the same flow rate as 101. This velocity reduction is important, because it suddenly offers the tiny algae (e.g. 2 μm in diameter and having flagella for motility in a nonlimiting E. huxleyi example) an opportunity to swim against the current, if they so desire. What is needed next is a reason for the algae to swim against the current so that they will concentrate in the upper end of the separation tank. That impetus is provided by tank (100) and its main downward flow path being dark and essentially devoid of both CO₂ and nutrient, whereas an attractant light beam (beacon 106, 107) is positioned within the mouth of a harvest exit tee (105) located near the upper extent of tank (100). With the main separation tank volume (100) and path (101→102) being essentially devoid of light, and with the flow velocity significantly reduced at large tank diameter, the algae may swim against downward current (101→102)—swimming upward instead toward the attractant beacon (107) and illuminator globe (106) supplied at the mouth of the harvest exit tee (105). The exit tee and harvest exit path (105→20) are smaller in diameter again and, even though the exit path (105→20) flow rate is low, this diameter reduction raises flow velocity (relative to path 101→102) enough that any algae which appear at the mouth of the exit tee (106, 105) will be sucked into harvest exit flow path (105). Marine algae may be continuously harvested as ocean seed at the harvest output of the silo (20). The bioreactor is continuous, self-concentrating, and will promote prodigious algal blooming at output (20). About 85% of the algal bloom will continuously exit via the harvest path (105) in a nonlimiting example, with about 15% recirculating via path (102-104). Any dead algae will sink and may be periodically removed at (109).

In an alternate embodiment, heavier-than-water algae from the bioreactor may proceed to an adjacent settling tank after blooming, in which the settling tank replaces the aforementioned separation tank; and in which settling tank conditions are maintained that do not encourage algae to swim against a current, and in which the heavier-than-water algae instead sink toward a funnel shaped harvest exit port at the bottom of the settling tank, and in which optional recirculation of clarified liquid near the top of the settling tank is provided back to the main bioreactor, with top-water clarification occurring as the algae sink to the funnel shaped bottom, and in which a concentrating effect is achieved via sedimentation of the sinking algae prior to their exit at the harvest exit port.

In both embodiments, a pH buffer (e.g., phosphate buffer, in a nonlimiting example) added (21) to the algae pool (94), buffers the pool against acidification (carbonation) from high level headspace CO₂. Buffering the pH at nominally 8.2 will maximize coccolithophore algae blooming and prevent softening or acidic dissolution of the coccolithophore exoskeleton (CaCO₃). As algae is continuously harvested (20) as a concentrated suspension, replenishment sea water or salt water, nutrient, and pH buffer are provided at the replenishment inputs (21) to the silo algae pool (94).

Oxygen produced during photosynthesis is continuously removed by an oxygen removal system (119, 110-116) based on at least one oxygen-permeable membrane (116), which is tubular in the nonlimiting FIG. 8 embodiment, and a far-side exhaust sweep gas (113), such as nitrogen (112) in a non-limiting example. A tubular membrane (116) and far-side annular sweep gas space (113) are depicted in this non-limiting example. Only one oxygen removal system (119) is depicted, but multiple units (of 119) mounted on the same silo would also be within the scope of the invention. In this oxygen removal system (119), a fraction of the silo headspace gas would be drawn by fan (not shown) into the removal system at 110 and down through the removal system center (115). Oxygen in the mixture would selectively permeate membranes (116) into a nitrogen sweep gas (113) introduced at 112. The nitrogen sweep gas (113) would remove all of the permeating oxygen and exhaust it at 113A. CO₂ in the mixture would continue down the center (115) and wouldn't permeate the tubular membrane. It would simply rejoin the silo headspace at 111, just above pool 94.

This stage-1 invention bioreactor system (90) may be considered a pseudo-anaerobic bioreactor since oxygen is removed (119) as fast as it is produced by photosynthesis. Algal blooming will therefore proceed under pseudo-anaerobic conditions which will enhance bloom rates, because oxygen otherwise acts as a photosynthetic inhibitor (above a certain point), and its continuous removal (119) will accelerate blooming.

If sufficient numbers of these FIG. 8 stage-1 algae bioreactors are globally proliferated for processing concentrated CO₂ in the invention embodiments of FIGS. 1-3 and FIGS. 11, 12, 14 and 15, the collective harvest rate of high-density, marine seed algae shipping to sea-ports for transfer to invention stage-2 (FIG. 4, operations-at-sea) can reach 3 GtC/yr.

Stage-2 of the multistage capture system involves FIG. 4, operations-at-sea. The stage-2 invention concept is to use stage-1 land-harvested high-density, fast-sinking marine algae (70, 72) (e.g., coccolithophore or siliceous diatom algae in two non-limiting examples) to selectively seed stage-2 (71), 15× amplified blooms of the same algae at sea, yielding 14 GtC/yr ocean blooms, and capturing that much atmospheric CO₂ (at sea) in the process. If stage-1 (70) captures 3 GtC/yr of CO₂ in all of its various FIG. 1-3 and FIG. 11-15 embodiments and the stage-1 bioreactors (18, 65, 90) convert that to high-density, marine algae (e.g., coccolithophore or siliceous diatoms in two non-limiting examples), and that is widely dispersed in invention stage-2 across 70% of Earth's oceans (FIG. 4), 2 GtC/yr of the land-harvested seed will satiate ocean grazer (e.g. copepods and krill) appetites leaving 1 GtC/yr uneaten to seed stage-2 15× amplified ocean blooming to yield 14 GtC/yr of ocean bloom, capturing 14 GtC/yr of atmospheric CO₂ as it blooms, then the total annual capture rate (land and sea) will be 17 GtC/yr CO₂ (FIG. 5) which satisfies the original combination invention capture targets (Ser. No. 12/999,195).

To accomplish all of that, FIG. 4 illustrates that up to 3 GtC/yr of high-density salt-water algae may be transported from land-based stage-1 bioreactors in specially designed stasis-supporting cargo containers (73) by flat-bed truck, rail, and barge to seaports where the containers would be loaded onto ocean-going freighters for wide distribution to floating repositories (74) in the open sea. In one nonlimiting example, the floating repositories could be a multi-purpose adaptation of an oil/gas company deep-water floating SPAR platform. From the floating repositories, the containers would be loaded onto fleets of smaller seed boats (75) which fan out from the repositories and dispense the seed (and micro-nutrient) directly from the containers into alternating “seed lanes” stretching across 70% of the oceans (76).

The invention cargo containers (73) would be stasis-supporting. In a non-limiting example, they would have a power source, built-in chillers to lower temperature to a stasis-inducing level in hot climates (or heaters in cold climates), enough nutrient (and just enough light) to keep the seed alive in stasis, and a slowly churning auger to prevent the seed from colonizing (agglomerating). The containers may be transferred by crane from flat-bed trucks to inland docks, from inland docks to flat-rail cars or barges, from rail-cars or barges to seaport docks, from seaport docks to ocean freighter decks and holds, from ocean freighter decks and holds to floating repository decks, and from floating repository decks to individual seed boat decks. Each of the aforementioned transfers can easily be made by large fork lifts, dock cranes, or deck cranes and the containers will maintain stasis-support at all stages of shipment and transfer, until the seed is dispensed into the ocean sea-lanes for enhanced stage-2 blooming.

Dispensing of seed and nutrient into sea-lanes from the seed boats will be at a measured rate while the boat is moving. In a non-limiting example, seed levels would be at least 20 mg/m³ in alternating sea lanes which are nominally 60 feet wide and 10 meters deep, which would be higher than the average natural algae levels occurring across most of the oceans south of Spain, Japan, and Seattle. This will give our high-density fast sinking seed algae a competitive advantage (among natural algae species) regarding nutrient, and ocean blooming will be dominated by the desired high-density, fast-sinking marine algae of stage-1 silo harvests (20, 72—FIGS. 4, 5), which is being seeded into the ocean in stage-2.

In one embodiment of stage-2 operations-at-sea, alternating sea lanes will be temporarily deaerated to a depth of 10 meters (in a non-limiting example) by bubbling N₂ behind the seed boat as the seed and nutrient are dispensed. This will temporarily displace dissolved oxygen (but not dissolved CO₂ (normal level maintained by the excess bicarbonate content of the sea)) to a depth of 10 meters (only) and a pseudo-anaerobic condition will be temporarily created in each localized sea-lane being seeded. The pseudo-anaerobic condition may accelerate blooming, especially if the algae seed are nitrogen-fixing. Adjacent lanes will be seeded two weeks out of phase with one another, so that the pseudo-anaerobic condition is both transient and localized (beneficial, rather than harmful).

Micro-nutrient will be dispensed in metered doses to support only about a 2 week bloom in each sea-lane. With the high seed level (e.g., at least 20 mg/m³) inherent with invention stage-2 seeding “algae+micro-nutrient” (in contrast to prior-art systems which dose “micro-nutrient-alone” and start their bloom from a much lower point (e.g., 0.1 mg/m³)), prodigious invention stage-2 bloom rates will occur, reaching the light penetration limit (˜400 mg/m³ in a nonlimiting example) within about 2 weeks in alternating lanes.

Grazers may eat up to ⅔ of the seed before it blooms, but that is the reported limit of their appetites at this seed level, so ⅓ should remain to bloom to the light penetration limit within 2 weeks. At this point the metered micro-nutrient doses are calculated to run out and the bloom will die. The important point is that the invention bloom is dominated by high-density algae which will lose motility (post mortem), sink, and easily clear the photic zone in time for next month's reseeding. Thus, the invention stage-2 operations-at-sea will enable 12 large ocean blooms per year, instead of just one or two blooms which is the limit of prior art systems which dose nutrient-only, start at a much lower point on the growth curve, are subject to getting eaten out (before blooming) by grazers, and even if prior-art systems could get past the grazers (which they can't), they'd bloom up buoyant strains of algae that don't sink (post mortem) or clear the photic zone at the end of a bloom cycle. A persistent floating light-block would prevent a second bloom from occurring with prior-art ocean fertilization, which will generally bloom buoyant strains of algae rather than (preferred) high-density, fast-sinking strains. Prior-art ocean fertilization systems (dosing micro-nutrient-only) would, under the most favorable of conditions (where grazers don't interfere—but not much chance of that happening) yield 1 or 2 blooms/year, capturing about 1½-3 GtC/yr CO₂ at best.

(Note: Even natural ocean blooming during the ice-ages would have been limited by grazers and the light penetration limits imposed by buoyant natural strains, but stage-2 invention ocean blooming won't be subject to these limits.)

In contrast, the multi-stage invention system which starts higher on the nonlinear ocean algae growth curve (by seeding algae+micro-nutrient), pre-satiates grazer appetites (2 GtC/yr) so there will remain 1 GtC/yr of (net) uneaten seed remaining to bloom (after grazer feasting), and which selectively blooms only the high-density, fast-sinking strains of coccolithophore or siliceous diatom algae (seed selectively pre-grown in stage-1 bioreactors) at sea will capture a total of 17. GtC/yr to meet the curve 81 target of FIG. 5, while unsuccessful prior-art ocean fertilization attempts continue to languish at the mercy of grazers, slow bloom rates, and persistent floating light blocks which will limit their capture capacity to a maximum of about 1.5 3 GtC/yr, and often much less than that as grazers devour what little natural seed they have (e.g., PolarStern, 2009). Note that 1.5-3 GtC/yr blooming is substantially less than current and projected global emissions of 11-12 GtC/yr, so “nutrient-only” fertilization cannot offset emissions or avert 450 ppm CO₂ tipping points, or meet the targets of Ser. No. 13/999,195 and of FIG. 5.

The above-listed invention system enhancements are anticipated to accelerate stage-2 ocean blooming significantly beyond the ice-age blooming rates. We project acceleration will be enough to enable 12 blooms/yr and meet the performance required by curve 81 of FIG. 5 which illustrates that the “fair weather” contingency capture capacity of 17 GtC/yr can be met by invention projections. The average annual net impact capture of 10 GtC/yr is illustrated by the projected 210 dashed line indication in FIG. 5 invention projections. This description (so far) has been for the multiple batch bloom embodiment of the invention in which individually seeded blooms are allowed to consume all available nutrient and die each month, sinking rapidly (post mortem) and clearing the photic zone in preparation for the next month's reseeding.

In one embodiment of an invention stage-2 ocean capture process, aerator boats will bubble compressed air or oxygen to within 5 meters of the sea floor in coastal waters to reaerate the lanes at the end of each monthly bloom cycle and prevent proximal post-bloom anoxia (which would otherwise greatly harm coastal marine life and raise legal objections with prior-art ocean fertilization attempts). Anoxia is typically a coastal water phenomenon which isn't prevalent in the open sea, where most of our stage-2 seeding will be done. In the open sea, re-aeration shouldn't be necessary, species-selective bloom dominance and use of heavier-than-water stage-1 algae seed will enable rapid sinking each month, sinking the dead algae quickly below the deep ocean thermocline and all the way to the cold deep sea floor, before anoxia has any chance of developing. Low deep ocean floor temperatures approaching zero degrees centrigrade and heavy coccolith plates should further delay the onset of bacterial action that could otherwise induce post-bloom anoxia. Delay may occur until sedimentation burial eliminates any further chance of developing anoxia. The localized, transient nature of invention system induced algal blooming and marine life feeding on the dead algae on the way down or at the sea floor may further suppress anoxic development.

If the 17 GtC/yr total multi-stage CO₂ contingency capture rate and 10 GtC/yr impact capture (FIG. 5, curves 81 and 210, respectively) are collectively achieved by the FIGS. 1-15 invention embodiments and the required invention-system-enhanced emissions cap and reduction curve (Ser. No. 13/999,195) is concurrently achieved, then the final atmospheric accumulation impact will successfully avoid the impending, near-term 450 ppm CO₂ tipping points and subsequently restore the pre-industrial level of 280 ppm CO₂ by 2075. That will eliminate ocean acidification and set the stage for subsequent warming reversal (following a thermal lag delay), which are the Ser. No. 13/999,195 goals of this multi-stage, multi-faceted invention system, addressed by FIGS. 4, 5.

The CIP two-stage invention goal which builds on the Ser. No. 13/999,195 goals is addressed beginning with FIG. 6. FIG. 6, stage-2 is the same as FIG. 4, so far as ocean seeding with algae proceeds through steps 72-75 and step 8. However, FIG. 6 differs from FIG. 4 in that once the EHUX bloom of step 8 has peaked (bloomed to maturity and captured a maximal amount of CO2), selected FIG. 6 blooms at this peak maturity stage which happen to occur along the windward shores of drought-stressed, semi-arid lands during an agricultural growing season, would next be subjected to the introduction of live marine grazers (zooplankton, krill, etc.) from output 5 of inland grazer tank 2. The grazers would be transported to sea and only introduced at the peak of EHUX blooming. Indicated EHUX seeding (8) would therefore precede grazer introduction (9) by a delay period equaling the maturation cycle of EHUX blooming. (For example, about a week later.) Voracious grazer attack at the peak of EHUX blooming would cause the EHUX to release prodigious amounts of DMS (211) which would rise in the atmosphere, photo-oxidize to DMSO, and that would seed rain-clouds (212) which would be driven inland from the ocean by on-shore winds. Inland rain would result to the benefit of agriculture in the drought stressed lands. In this embodiment of the invention process, the primary DMS production (211) occurs at sea and the seeded rain-clouds are swept inland by onshore winds.

In another CIP embodiment (FIG. 7), rain-cloud seeding along the windward shores of drought stress lands (226) may be done by producing the DMS inland (remotely) within grazer tank (2), collecting and concentrating it with condenser (6), harvesting it at port (7) and transporting its concentrate to a ship (213) sailing along the windward shore. In this embodiment, it is not necessary to seed algae into the ocean (76). DMS release (214) occurs directly from the moving ship. The DMS rises, photo-oxidizes to DMSO, and seeds rain-clouds (212) as before. The pair of symbols (swirls with an arrow (225)) represent the onshore wind. FIG. 8 shows the onshore wind (225) pushing the rain cloud (212) over the drought stressed-land (226) which is thereby blessed with much needed rain (227).

In addition to the invention bioreactors contributing significantly to climate restoration and ocean revitalization, other applications will include high capacity algal production for silage, animal feed, feed supplements, fertilizer, biofuels, agricultural runoff control, food for fish and seafood farming involving fish or mollusks which directly feed on algae, and bottom-rung food for fish farming involving predator fish (as seafood) such as compano and cobia which feed on lower marine life (e.g, brine shrimp). In the latter case, invention high capacity algal production will feed the brine shrimp in adjacent tanks, raising shrimp for secondary feeding to predator fish.

In these other applications, the algae silos (18, 65, 90) would be used seed species optimized for silage, animal feed (or supplement), fertilizer, biofuel, agricultural runoff control, or food for fish and seafood farming and the bioreactor output (20) would be directed to those applications which end with stage-1 without sending algae for stage-2 (FIG. 4). If desired the bioreactor output (20) may be additionally filtered and/or dried to remove the suspension water and excess nutrients before transferring algae to the land-based feed applications.

Using invention bioreactors along inland lake shores and rivers, invention fresh-water algal production can further aid in revitalization of inland lakes and rivers by removal of nitrogen and phosphorus compounds added by agricultural runoff. This would be accomplished by diverting the bioreactor output (20) directly into the lake or river. In this case, it would be desirable for the bioreactor algae to be a high density, fast sinking variety of fresh water algae. The algae bloom need not be supplemented with nutrient as it is dosed into the lake or river. As the algae bloom proceeds in lakes and rivers, it will consume nutrient provided by agricultural runoff, and in doing so, it will clear the river of these agricultural pollutants. As the algae blooms die and settle to the lake or river bottom, some periodic dredging may be required to keep the main channels open and an aerator boat may need to patrol up and down the rivers and on the lakes to restore dissolved oxygen levels to prevent post-bloom anoxia as algae blooms die and sink. With re-aeration, inland freshwater algae blooms will be beneficial as they will feed the lake and river food chain and increase fresh-water fish populations which will also flourish (and be healthier for fresh-water fishermen to catch and eat) as agricultural runoff chemicals are removed.

Lake and river bacteria levels will also drop sharply as another benefit of this program. This will improve the health of fish, water birds, and essentially all creatures and humans living in or along the lakes and rivers. This includes impacting water-borne disease, the eradication or minimization of which will benefit 3^{rd} world countries.

Clearing major rivers of agricultural runoff and bacteria will improve public health and will further stop coastal water harmful algae blooms (HAB's) such as the notorious “red tide” in Florida, which are otherwise fed from agricultural runoff at major river delta outflows. This will be accomplished by the invention high density fresh water algae having cleared the rivers of agricultural phosphorus and nitrogen compounds upstream from the delta outflow. The coastal water HAB's will simply die as their food supply will have been cut off upstream in the rivers which normally supply them with agricultural runoff. By clearing up the agricultural runoff, downstream HAB's in the gulf won't survive. By these invention means, lakes, rivers, and coastal waters will be revitalized. Even the tourism industry around lakes, rivers, and coastal waters will benefit as a result of better fishing everywhere with larger populations of bigger, healthier fish which are safer to eat as a result of growing in the cleaner, less polluted water.

The specification figures and description are of non-limiting examples and the invention systems and processes may be envisioned beyond the scope of specific embodiments, settings, and regions described herein, and the scope of the invention must therefore be considered to be limited only by the claims. While the invention system and processes have been described in terms of preferred embodiments, those skilled in the art will recognize that the invention can be practiced with modification within the spirit and scope of the appended claims.

1. A combination system for production of algae and secondary production of dimethylsulfide (DMS), a natural cloud-seeding agent, the system comprising: a CO₂ source; and a first algae-producing bioreactor supplied with concentrated CO₂ from the CO₂ source; and a second DMS-producing bioreactor supplied with algae produced by the first bioreactor; in which the first bioreactor is configured to encourage accelerated growth and reproduction of algae as well as to enable development of a more concentrated final algal bloom; in which optical opacity limits on seed level and bloom concentration are circumvented by an optical thinning effect which enables greater light penetration into more concentrated algae suspensions; wherein the greater light penetration enables higher level initial seeding or inoculation of the bioreactor bloom space; wherein the higher level of initial seed accelerates blooming as a result of starting higher on an upward-bending nonlinear algal growth curve; and in which a normally inaccessible upper section of the nonlinear algal growth curve is conventionally inaccessible owing to optical opacity of concentrated algal suspensions; and in which the normally inaccessible upper section of the nonlinear growth curve is rendered accessible by the optical thinning effect which enables light penetration into optically thinned suspensions of concentrated algae; and in which the second bioreactor contains a culture of grazers that eat the algae supplied by the first bioreactor; in which grazer feeding on the algae causes the algae to release DMS.

2. The system of claim 1, wherein the optical thinning effect in the first bioreactor is produced by slinging an algae suspension as thin watery sheets off the perimeter edges of a rotating auger blade which lifts algae suspension out of a pool, elevates the lifted suspension, and slings it outward by centrifugal force to form optically thin watery sheets, and wherein optical thinness of the slinging sheets enables improved optical penetration by rays from a light source shining through the slinging sheets.

3. The system of claim 1, in which the algae suspension from the first bioreactor proceeds to a flow-through separation tank after blooming, wherein the flow velocity of algae suspension through the separation tank is reduced, at constant flow rate, by means of enlarged tank diameter, and wherein the reduced flow velocity is low enough to permit algae that have flagella or other motility means to swim effectively against the flow current when presented with an upstream or side-stream attractant, and wherein the direction of algal swimming is toward the attractant, and wherein algal swimming toward the attractant produces a concentrating effect on the algal suspension, and wherein the concentration of algae proximal to the attractant is made higher by the concentrating effect than the concentration of algae at points located progressively downstream from the attractant and still within the main flow of the flow-through separation tank.

4. The system of claim 3, wherein the separation tank contains a main flow exit port and a secondary exit port which is designated as a harvest exit tee, wherein the attractant is located at a position proximal to the mouth of the harvest exit tee, and wherein the mouth of the harvest exit tee is sufficiently narrow to raise the harvest exit flow velocity to exceed the capacity for algae to swim against the harvest exit current, wherein algae swimming toward the attractant from the main separation tank are sucked into the harvest exit tee upon reaching the attractant, wherein the harvest exit tee outflow leads to an algal harvest output port of the first bioreactor, wherein the concentration of algae harvested at the harvest output port is higher than the concentration of algae entering the separation tank, and wherein the main flow of the flow through exit tank at points downstream of the attractant and having bypassed the harvest exit tee contains a reduced concentration of algae, relative to the concentration of algae entering the separation tank, and wherein the main flow of the flow through exit tank having bypassed the harvest exit tee exits the separation tank through the main flow exit port, and wherein flow exiting the main flow exit port is recirculated to the original bioreactor, and wherein algae produced at the algal harvest output port of the first bioreactor are introduced into the second bioreactor.

5. The system of claim 4, in which the attractant within the first bioreactor is one or more attractants selected from among a group of attractants consisting of a light source, a nutrient source, a carbon dioxide source, an attractive water temperature, and an attractive water pH, and wherein the rest of the separation tank is dark and relatively devoid of the chosen attractant or combination of attractants.

6. A system for production of algae and secondary production of dimethylsulfide (DMS), a natural cloud-seeding agent, the system comprising: a hydrocarbon cracking reactor configured to generate a stream of concentrated CO₂ byproduct; and a first bioreactor configured to produce heavier-than-water algae, the first bioreactor supplied, at least in part, with CO₂ from the stream of concentrated CO₂ byproduct; and a second DMS-producing bioreactor supplied with algae produced by the first bioreactor; in which the hydrocarbon cracking reactor produces H₂ as its main product; and in which the second bioreactor contains a culture of grazers that eat the algae supplied by the first bioreactor; in which grazer feeding on the algae causes the algae to release DMS.

7. The system of claim 6, wherein the hydrocarbon cracking reactor is a two-stage steam reactor operating with steam stages at two different temperatures, optimized for cracking methane as the principal component of natural-gas.

8. The system of claim 1 wherein the CO₂ source is a CC (carbon-capture) clean-coal-fired power plant, the CC power plant producing electricity as a public utility and concentrated CO₂ byproduct as the CO₂ source in the form of a supercritical fluid (SCF-CO₂).

9. The system of claim 8, wherein the SCF-CO₂ is decompressed to concentrated CO₂ gas and introduced into the first bioreactor.

10. The system of claim 1 wherein the CO₂ source is a CC (carbon-capture) gas-fired power plant, the CC power plant producing electricity as public utility and concentrated CO₂ byproduct as the CO₂ source in the form of a supercritical fluid (SCF-CO₂).

11. The system of claim 10, wherein the SCF-CO₂ is decompressed to concentrated CO₂ gas and introduced into the first bioreactor.

12. A process of ocean-amplified CO₂ capture and amplified release of dimethylsulfide (DMS, a natural cloud seeding agent) at sea, wherein algae plus nutrient are seeded into the ocean instead of nutrient-alone; the process comprising: land-based capture of concentrated CO₂ from a land-based CO₂ source; land-based conversion of captured CO₂ to heavier-than-water marine algae in at least one bioreactor configured to encourage the rapid growth and reproduction of the heavier-than-water marine algae as ocean seed; transport of the heavier-than-water marine algae as ocean seed to seaports for ocean distribution and dispersal with added nutrients in order to seed ocean-amplified blooming (further growth and rapid reproduction at sea—essentially secondary blooming on a vast ocean scale); attack on the secondary ocean algal blooms by ocean grazers such as zooplankton and krill (as nonlimiting examples) who eat the secondarily bloomed algae—causing the algae to release DMS at sea; wherein the ocean-amplified algal blooming occurs essentially selectively for the heavier-than-water species of marine algae by virtue of the heavier-than-water marine algae being distributed, dispersed, and seeded into the ocean water at higher levels than existing natural buoyant ocean algae, the higher levels selectively accelerating ocean blooming rates of the heavier-than-water marine algae by virtue of seeding the ocean with marine algae seed harvested from the at least one land-based bioreactor, wherein ocean seeding occurs higher than normal on a nonlinear algal growth curve and produces a species-selective dominance of the ocean algal bloom, wherein the higher that the ocean blooming starts on the growth curve, the faster it proceeds, if sufficient nutrient is present or provided, and wherein the ocean grazers are selected from among a group of ocean grazers consisting of ocean grazers naturally occurring in the ocean and a culture of ocean grazers produced by inland bioreactors, in which the ocean grazers produced by the inland bioreactors are transported for release at the ocean algal bloom site.

13. The process of claim 12 in which the species-selective ocean algal bloom dominance is further enhanced by nutrient selection, and in which nutrient selection for E. huxleyi coccolithophorid marine algae blooming includes nutrients which are deficient in phosphate, wherein phosphate deficiency, while other nutrients are concurrently provided in abundance, promotes prodigious E. huxleyi growth at sea, essentially to the exclusion of blooming by other species of marine algae, including buoyant algae, in the seeded ocean area.

14. The process of claim 12, wherein transport to seaport of the heavier-than-water marine algae seed, and/or transport to seaport of the ocean grazer culture produced by inland bioreactors, occurs by flat-bed truck, flat rail car, or barge; wherein the flat-bed truck, flat rail car, or barge carry the marine algae seed, and/or the ocean grazer culture produced by inland bioreactors, in stasis-supporting cargo containers which are transferrable by crane or other lifting means from one flat-bed transportation means to another, and wherein the cargo containers are designed to maintain conditions in support of a healthy stasis condition for the heavier-than-water marine algae seed and/or the ocean grazer culture produced by inland bioreactors.

15. The process of claim 14, wherein the stasis-supporting cargo containers may be loaded onto ocean freighters docked at seaports, the ocean freighters then distributing the stasis-supporting cargo containers to floating seed and/or ocean grazer culture repositories at sea; wherefrom the stasis-supporting cargo containers may be transferred to dispersal boats which fan out from the floating seed and/or ocean grazer culture repositories to disperse and dispense the heavier-than-water marine algae seed (plus nutrients) and/or ocean grazer cultures produced by the inland bioreactors into the ocean for ocean-amplified algal blooming to proceed, along with ocean-amplified atmospheric CO₂ capture as the heavier-than-water marine algae bloom prodigiously at sea, and for a fraction of the ocean-amplified marine algae bloom to release large amounts of DMS as the algae are eaten by the ocean grazers, and wherein a preferred embodiment of the invention involves delaying ocean-introduction of the ocean grazer cultures produced by the inland bioreactors until the ocean-amplified marine algal bloom has appreciably matured and already captured substantial amounts of atmospheric CO₂ in the process of blooming.

16. The process of claim 15, wherein the nutrient doses are metered to support heavier-than-water ocean-amplified algal blooming up to the light penetration (algal opacity) limit and then run out.

17. The process of claim 16, wherein the ocean-amplified bloom dies a death selected from among a group of death categories consisting of death by starvation after the metered micro-nutrient doses run out or death by being eaten by ocean grazers; wherein death by being eaten by ocean grazers causes algal release of DMS, and wherein the dead heavier-than-water amplified bloom loses motility and residual (uneaten) dead algae sink rapidly, clearing the ocean photic zone before the end of each month and enabling restored light penetration into the photic zone to support another amplified bloom following a next month's seeding.

18. The process of claim 17 in which algal blooming and DMS release proceed with up to 12 batch algal blooms/year being seeded and achieved, with each ocean-amplified batch algal bloom approaching the light penetration (algal opacity) limit before it is eaten by grazers or dies of starvation and sinks, and in which accumulated amplified ocean blooming yields up to 14 GtC/yr of heavier-than-water algae (correspondingly capturing 14 GtC/yr of atmospheric CO₂) globally for each 1-3 GtC/yr of seeding with land-based heavier-than-water algae seed produced by the land-based bioreactors, wherein the predominant heavier-than-water ocean algal bloom species are determined by the species of land-based bioreactor seed algae harvested from the bioreactor, and wherein the bioreactor seed algae are dominated by initially preseeding the bioreactor with a purified culture of the desired marine algae species, and wherein the desired marine algae species are selected from a group consisting of coccolithophore (e.g., E. huxleyi) and siliceous diatoms.

19. The process of claim 17, wherein the seeding of amplified ocean blooming and DMS release are restricted to the vast open ocean that is further out from shore, well beyond the realm of coastal waters and beyond the shallow coastal-shelf sea floor, out in the open seas where much deeper water prevails, wherein species-selective bloom dominance and rapid sinking quickly carries the uneaten fraction of dead heavier-than-water algae below the ocean thermocline of the open seas and all the way to the deep-sea floor, wherein deep ocean temperatures at the deep-sea floor are quite low—near to zero degrees centigrade, and wherein low deep-sea temperatures preserve the uneaten fraction of dead algae and slow and/or suppress the onset of secondary bacterial action, algal decay, eutrophication, and post-bloom anoxia which would otherwise deplete ocean-dissolved oxygen, and wherein the slowing or suppression of bacterial action at low temperature at the deep-sea floor delays the onset of eutrophication and post bloom anoxia to an extent enabling ocean sedimentation, often referred to as marine “snow”, to essentially bury the dead algae before significant post-bloom anoxia or eutrophication can develop.

20. The process of claim 18, wherein approximately 1 GtC/yr of seed algae triggers amplified ocean blooming of up to 14 GtC/yr of heavier-than-water algae and correspondingly elevated DMS release; but wherein approximately another 2 GtC/yr of seed algae are needed to satiate marine grazer appetites (among naturally occurring grazers), producing early DMS release, so that the satiated naturally occurring grazers leave the approximately 1 GtC/yr of seed uneaten so that it remains to trigger the amplified ocean blooming of the up to 14 GtC/yr of heavier-than-water algae and corresponding photosynthetic and/or coccolithogenic (calcification) capture of up to 14 GtC/yr of atmospheric CO₂, and in which ocean seeding with approximately 3 GtC/yr of algal seed produced by land-based bioreactors provides both the 2 GtC/yr of algae to satiate the grazer appetites, producing an early DMS release, and the remaining 1 GtC/yr of uneaten seed that remain to trigger the amplified ocean blooming of the up to 14 GtC/yr of heavier-than-water algae, optionally followed by later DMS release upon delayed introduction of the bioreactor-produced grazer cultures.
